(19) United States
(12) Patent Application Publication
(10) Pub. No.: US 2024/0300063 A1
(43) Pub. Date: Sep. 12, 2024

(54) DETECTION SYSTEMS FOR AIM-ENABLED POWER TOOLS

(71) Applicant: SawStop Holding LLC, Tualatin, OR (US)

(72) Inventors: Keith P. Hebert, Lake Oswego, OR (US); Louis R. Slamka, Vancouver, WA (US); Stephen F. Gass, West Linn, OR (US)

(73) Assignee: SawStop Holding LLC, Tualatin, OR (US)

(21) Appl. No.: 18/546,481

(22) PCT Filed: Feb. 18, 2022
(86) PCT No.: PCT/US2022/016964

§ 371 Date: Aug. 15, 2023

Related U.S. Application Data
(60) Provisional application No. 63/150,817, filed on Feb. 18, 2021.

(51) Int. Cl. B23Q 11/00; B23Q 11/06; B27G 19/00; B27G 21/00

(52) U.S. Cl. CPC B23Q 11/0082; B23Q 11/06; B27G 19/00; B27G 21/00

(57) ABSTRACT

Power tools with conductive couplings used with active injury mitigation technology are disclosed. Systems and methods to detect degradation or failure of a conductive coupling in an AIM-enabled power tool are disclosed. Systems and methods to detect impedance of a conductive coupling in an AIM-enabled power tool are disclosed, along with systems and methods to disable such power tool in the event that the detected impedance falls outside predetermined thresholds.

### CROSS REFERENCE TO RELATED APPLICATION

This application is a continuation of International Application No. PCT/US2022/016964, filed Feb. 18, 2022, which claims the benefit of and priority from U.S. Provisional Patent Application Ser. No. 63/150,817, filed Feb. 18, 2021.

### COPYRIGHT NOTICE

A portion of the disclosure of this patent document contains material which is subject to copyright protection. The copyright owner has no objection to the facsimile reproduction by anyone of the patent document or the patent disclosure, as it appears in the patent application file or records of a national patent office, but otherwise reserves all copyright rights whatsoever.

### FIELD

The present disclosure relates to power tools which are equipped with Active Injury Mitigation technology (also referred to herein as AIM technology), and more particularly, to conductive couplings used in power tools equipped with AIM technology. Conductive couplings provide a mechanism through which an electrical signal can be coupled or imparted to a cutting tool, and then monitored for changes indicative of human contact with the cutting tool.

### BACKGROUND

A power tool such as a table saw, hand-held circular saw, track saw, miter saw, upcut saw, radial arm saw, router, jointer, or band saw is used to cut a workpiece, such as a piece of wood, to a desired size or shape. A table saw includes a work surface or table and a circular blade extending up through the table. A person uses a table saw by placing a workpiece on the table and feeding it into contact with the spinning blade to cut the workpiece to a desired size. A hand-held circular saw includes a circular blade, motor, and handle. A person uses a hand-held circular saw by grasping the handle and moving the spinning blade into contact with a workpiece. A track saw is similar to a hand-held circular saw and includes a track to guide the movement of the saw as the blade cuts the workpiece. A miter saw includes a circular blade on a moveable support arm. A person uses a miter saw by placing a workpiece under the blade and then moving the blade into contact with the workpiece to make a cut, typically by pivoting the blade and support arm down. An upcut saw includes a work surface or table and a circular saw blade mounted on a movable arm below the table. A person uses an upcut saw by placing a workpiece on the table and then actuating a switch which raises the spinning blade up through a slot in the table to cut the workpiece. A radial arm saw includes a worksurface or table and a circular blade mounted to slide along a support arm positioned above the table. A person uses a radial arm saw by placing a workpiece on the table and moving the spinning blade along the arm to cut the workpiece. A router includes a spindle that rotates at high speed and a collet attached to the spindle, where the collet can hold a wide variety of differently shaped cutter heads or router bits. A person uses a router by mounting a selected router bit to the collet and then moving the spinning router bit into contact with a workpiece to shape the workpiece. A jointer includes one or more worksurfaces and a rotating, cylindrical cutter head. A person uses a jointer by sliding a workpiece along a worksurface past the cutter head to remove material from the workpiece. A band saw includes a work surface and an adjacent band blade driven around two or more rollers or wheels. A person uses a band saw by placing a workpiece on the work surface and moving the workpiece into contact with the band blade.

Power tools such as these are some of the most basic and versatile machines used in woodworking and construction. For example, they are used in making furniture and cabinetry, in the installation of hardwood flooring, in cutting plywood panels for roofing and walls, in cutting material for countertops, in making pallets and crates, and for many other projects and tasks.

Power tools such as table saws, hand-held circular saws, track saws, miter saws, upcut saws, radial arm saws, routers, jointers, and band saws come in various sizes and configurations. For example, table saws come in sizes ranging from large, stationary, industrial table saws, to small, lightweight, portable table saws. Larger table saws are sometimes called cabinet saws, mid-sized table saws are sometimes called contractor saws or hybrid saws, and smaller table saws are sometimes called portable, jobsite, or benchtop table saws. The larger table saws include induction motors and cast-iron parts, and typically weigh well over 100 pounds. The smaller, portable table saws are often small and light enough to be transported in the back of a pickup truck, and they often have stands with wheels so they can be moved around a jobsite or workspace. The smaller table saws have universal motors and weigh less than 100 pounds. For example, jobsite saws weigh approximately 60 to 80 pounds, and the smallest benchtop saws weigh approximately 40 to 45 pounds. Hand-held circular saws, track saws, miter saws, routers, jointers, radial arm saws, upcut saws and band saws also come in various sizes and configurations, and they can be equipped with different features.

The names “table saws,” “hand-held circular saws,” “track saws,” “miter saws,” “upcut saws,” “radial arm saws,” “routers,” “jointers,” and “band saws” are general categories that can overlap. For example, a track saw is a type of hand-held circular saw and can be referred to as a hand-held circular saw. Miter saws and band saws have tables or work surfaces on which a workpiece is placed to make a cut, and in that regard are similar to a table saw. Nevertheless, the designations “table saws,” “hand-held circular saws,” “track saws,” “miter saws,” “upcut saws,” “radial arm saws,” “routers,” “jointers,” and “band saws” are generally understood by persons of ordinary skill in the art of woodworking and construction to identify different categories or types of power tools.

Power tools with moving blades, such as those identified above, present potential dangers or hazards because of the cutting tool(s). Numerous accidents occur where a person using a power tool accidentally comes into contact with a moving blade or cutter. To address this issue, power tools can be equipped with active injury mitigation technology. Active injury mitigation technology detects a dangerous condition, such as accidental contact with the moving cutting tool by a person, and then performs some action to mitigate injury, such as stopping and/or retracting the cutting tool within milliseconds. Generally, an embodiment of active injury mitigation technology includes at least a detection system (also referred to herein as a detection module) to detect the dangerous condition and a reaction system (also referred to herein as a reaction mechanism) to perform the action to mitigate injury. The terms “detection system” and “reaction system” and similar variants, are used to identify known categories of structural components, and therefore, identify structure rather than function, just as the terms “actuator” and “sensor” identify known categories of structural components. For example, the term “detection system” is known to describe structural elements such as electronic circuitry to generate, monitor, and analyze an electrical signal. The term “reaction system” is known to describe structural elements such as brake mechanisms and retraction mechanisms. U.S. Pat. No. 9,724,840, titled “Safety Systems for Power Equipment,” describes active injury mitigation technology and various implementations and embodiments of active injury mitigation technology in power saws. The entire disclosure of U.S. Pat. No. 9,724,840 is incorporated herein by reference.

In a power tool having a moving blade and equipped with an embodiment of active injury mitigation technology, the blade can be used as a sensor to detect contact between a human and the blade. For example, U.S. Pat. No. 7,284,467, titled “Apparatus and Method for Detecting Dangerous Conditions In Power Equipment,” which is incorporated herein by reference, discloses systems that impart an electrical signal to the blade, and monitor the signal for changes indicative of human contact.

One way in which an electrical signal can be imparted to the blade is through a capacitive coupling, and U.S. Pat. No. 7,284,467 describes embodiments of capacitive couplings. For example, conductive plates can be positioned in close proximity to the blade to capacitively couple the blade to an electronic circuit, or conductive surfaces can be positioned in close proximity to the arbor or drive shaft of the blade to create a capacitive coupling with the arbor, which is conductively coupled to the blade. In these capacitive couplings there is no physical contact between the conductive elements (also called conductive plates) that form the capacitive couplings.

Another way to impart an electrical signal to the blade is through a conductive coupling. A conductive coupling may be referred to as a direct coupling because the electrical signal is transferred by means of direct, physical contact between conductors. Various examples of conductive couplings for power tools which incorporate AIM technology (also referred to herein as AIM-enabled power tools) have been described in WIPO International Patent Application Publication No. WO 2017/210091 A1, published Dec. 7, 2017, and titled “Detection Systems For Power Tools With Active Injury Mitigation Technology,” the entire disclosure of which is herein incorporated by reference.

This specification describes structures and methods relevant to conductive couplings in AIM-enabled power tools.

### BRIEF DESCRIPTION OF THE DRAWINGS

FIG. 1 is a schematic block diagram of an AIM-enabled power tool.

FIG. 2 is a schematic diagram of an embodiment of an AIM-enabled power tool in the context of a power tool having a circular blade.

FIG. 3 shows a graph of experimentally measured data illustrating peak-to-peak voltage amplitude changes in an AC signal on a spinning saw blade when a person contacts the moving teeth.

FIG. 4 shows a flowchart of an exemplary method of detecting contact.

FIG. 5 shows a schematic view of an exemplary reaction mechanism.

FIG. 6A shows a schematic of a portion of an exemplary control circuit.

FIG. 6B shows another portion of the schematic of the exemplary control circuit of FIG. 6A.

FIG. 6C shows another portion of the schematic of the exemplary control circuit of FIG. 6A.

FIG. 6D shows another portion of the schematic of the exemplary control circuit of FIG. 6A.

FIG. 6E shows another portion of the schematic of the exemplary control circuit of FIG. 6A.

FIG. 6F shows another portion of the schematic of the exemplary control circuit of FIG. 6A.

FIG. 6G shows another portion of the schematic of the exemplary control circuit of FIG. 6A.

FIG. 7 shows a perspective view of an AIM-enabled table saw.

FIG. 8 shows a right side view of the internal mechanism of the table saw of FIG. 6.

FIG. 9 shows a left side view of the internal mechanism of the table saw of FIG. 7.

FIG. 10 shows a closeup perspective view of the cartridge bracket from the table saw of FIG. 7.

FIG. 11 shows a perspective view of the brake cartridge from the table saw of FIG. 7.

FIG. 12 shows a partial cross-sectional view of the arbor block from the table saw of FIG. 7.

FIG. 13 shows a close-up cross-sectional view of a portion of the arbor block of FIG. 12.

FIG. 14 shows a schematic side view of an AIM-enabled power tool with a circular blade and a reaction mechanism including a spring configured to retract the blade.

FIG. 15 shows a schematic side view of an AIM-enabled power tool with a circular blade and a reaction mechanism including an explosive component configured to retract the blade.

FIG. 16 shows a schematic, partially interior view of an AIM-enabled band saw.

FIG. 17 shows a closeup view of the reaction mechanism of the band saw of FIG. 16.

FIG. 18 shows a schematic view of an AIM-enabled hand-held circular saw.

FIG. 19 shows a schematic view of an AIM-enabled miter saw.

FIG. 20 shows a schematic, partially interior view of an AIM-enabled upcut saw.

FIG. 21 shows a schematic view of reaction mechanism in the form of a pneumatic cylinder.

FIG. 22 shows a schematic, partial view of an AIM-enabled jointer.

FIG. 23 shows a schematic, partial cross-section and partial cut-away view of an AIM-enabled router.

FIG. 24 shows a closeup partial schematic view of the reaction mechanism of the router of FIG. 23.

FIG. 25 shows a perspective view of an alternative AIM-enabled table saw.

FIG. 26 shows a perspective view of the internal mechanism of the table saw of FIG. 25.

FIG. 27 shows a side view of a portion of the control circuit and the blade of the table saw of FIG. 25.

FIG. 28 shows an exploded view of the conductive coupling to the arbor of the table saw of FIG. 25.

FIG. 29 shows a closeup, cross-sectional view of the conductive coupling and arbor of the table saw of FIG. 25.

FIG. 30 shows a schematic of a circuit representing a conductive coupling between the control circuit and the blade of the table saw of FIG. 25.

FIG. 31 shows a schematic of another circuit representing a conductive coupling between the control circuit and the blade of the table saw of FIG. 25.

FIG. 32 shows a brake cartridge with an electrode comprising a portion of the control circuit of the table saw of FIG. 25.

FIG. 33 shows a portion of the control circuit of the table saw of FIG. 25.

FIG. 34 shows another portion of the control circuit of the table saw of FIG. 25.

FIG. 35 shows a graph of experimental data depicting a reconstructed and filtered signal detected on the blade of the table saw of FIG. 25.

FIG. 36 shows a graph of experimental data depicting the phase difference between a generated signal and the signal detected on the blade of the table saw of FIG. 25.

FIG. 37 shows a flowchart of an exemplary method of evaluating the impedance of a conductive coupling on an AIM-enabled power tool.

### STATEMENTS CONCERNING THE DISCLOSURE

The present disclosure describes various exemplary embodiments of power tools, components, circuits, and processes. The embodiments as disclosed and illustrated herein are not to be considered in a limiting sense as numerous variations are possible. Rather, the various exemplary embodiments depicted in the drawings and described in detail below are intended to illustrate specific examples and implementations in a variety of different contexts. It will be understood by those of skill in the art that many different variations, modifications, alternatives, and equivalents of these particular exemplary embodiments are possible. Therefore, the drawings and detailed description are not intended to limit the scope of the claims to the forms, arrangements, components, and/or configurations depicted and described therein. Instead, the claims are intended to cover all such variations, modifications, alternatives, and equivalents which are described and suggested within the scope and spirit of the disclosure as it would be understood by those of skill in the art.

While references to “exemplary embodiment”, “alternative embodiments”, “other embodiments”, and etc., may appear throughout the disclosure, repeated occurrences of such references are not intended necessarily to refer to the same embodiment(s). Rather, such references should be understood in the context in which they are provided and with reference to the figures and components with which they are associated within the narrative of the disclosure. Furthermore, reference to certain embodiments is not intended to exclude other embodiments since particular components, elements, circuits, structures, assemblies, processes, and methods described herein may be combined and/or modified in any manner that is suitable and consistent with the disclosure.

This disclosure, including the accompanying claims, may refer to structural elements as being “configured to,” or “adapted to,” perform one or more tasks, operations, or functions. Such elements may be referred to as “components,” “circuits,” “assemblies,” “mechanisms,” and etc. It should be understood that when such an element is described as being “configured to” or “adapted to” perform such a task or etc., this phrasing is intended to refer to a physical object or structure such as an electronic component (e.g., resistor, capacitor, cable, processor, etc.), or a mechanical component (e.g., arm, bracket, shaft, mount, housing, etc.), or a plurality of such components interconnected or combined into a circuit, mechanism or assembly. Furthermore, the phrasing “configured to” or “adapted to” perform a particular task or etc., is intended to indicate that the structural component or combination of components is arranged, positioned, selected, programmed, connected, combined and/or designed to perform the particular function stated. Thus, for example, the phrase “a processor component configured to receive an input from a user-input component” means a physical processor with one or more input nodes which may be connected either directly, or indirectly through additional circuit components, to the output of a physical switch, button, knob or similar component which is operable by a person to produce electrical signals. And further that the input node(s) of the processor are capable of receiving signals of the type which the user-input component produces, so that the processor, while executing software instructions stored in memory is capable of recognizing the signal for its intended purpose and executing further instructions in response to the signal as determined by the stored software. Likewise, the phrase “a motor configured to drive the cutting tool” means a motor with sufficient output power to move the cutting tool in a manner and at a speed appropriate for the corresponding power tool to cut or shape workpieces as intended. Therefore, it should be understood that all references herein of some particular element being “configured to” or “adapted to” perform some operation, task, or function refers to a physical object and not to some intangible entity, process, or function.

In addition, the term “configured to” or “adapted to” does not mean “configurable to” or “adaptable to.” Thus, for example, an unprogrammed processor that is devoid of executable software instructions may be configurable to perform a task, but it cannot be considered as “configured to” perform the task. Instead, if a processor is referred to herein as “configured to” perform a task, that means the processor includes the necessary executable software instructions, as well as any necessary processing functionality such as analog-to-digital conversion or etc., to perform the referenced task.

To the extent the phrase “in response to” is used herein, the phrase is intended to describe one more factors that produce an effect. However, the phrase is not intended to eliminate the possibility that additional and/or different factors may affect whether or how the effect is produced. Thus, for example, the phrase “the control circuit is configured to start the motor in response to inputs by the operator” does not mean that the input from the operator is necessarily the only input or condition necessary to start the motor. Instead, the phrase is intended to cover the situation where the motor is started solely in response to input by the operator, as well as the situation where the motor is started only when one or more additional conditions or inputs are present in combination with the input by the operator. Furthermore, the phrase is also not intended to convey that the motor can only be started in response to the input from the operator, as other conditions and/or inputs may also cause the motor to start independent of the input from the operator.

If used herein, the terms “first,” “second,” etc., when used to modify structural elements, are not intended to describe any temporal or spatial order or priority, unless such order or priority is expressly stated. Thus, for example, the terms “first processor” and “second processor” do not, unless otherwise stated, imply that the component referred to as the “first processor” has any priority or control over the component referred to as the “second processor.” Furthermore, the terms are not intended to imply that the two processors are either identical or non-identical unless explicitly described as such. Instead, the terms are solely intended to convey the presence of two, separate physical processors.

In the drawings and description herein, numerous specific details are disclosed for a variety of exemplary embodiments to provide a complete and thorough understanding to those of skill in the art. Nevertheless, those of skill in the art will recognize that many aspects of the present disclosure can be practiced without one or more of the specific details. In some embodiments, well-known and/or readily available components, circuits, structures, assemblies, signals, software instructions, and techniques may have not been shown in detail to avoid unhelpful complexity which might hinder comprehension of the present disclosure in its entirety.

### DETAILED DESCRIPTION

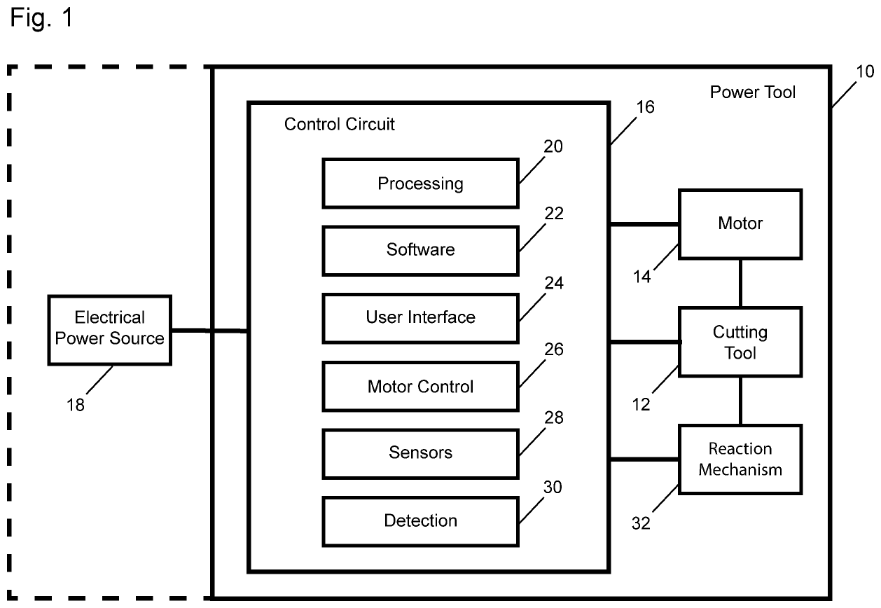

An exemplary AIM-enabled power tool is shown schematically in FIG. 1 and indicated generally at 10. Power tool 10 includes a movable cutting tool 12 and a motor 14 that is coupled to drive the cutting tool. The cutting tool may be any of a variety of well-known cutting tools including a circular saw blade, a band blade, a cutter head, a bit, a chipper, a shaper, a straight blade, a dado set, or etc., which are configured to cut workpieces such as wood, plastic, and etc. Furthermore, the cutting tools may be of various sizes and shapes depending on the intended use. The cutting tools are often configured to rotate or spin about an axis, but other types of movement are also well known such as the travel of a band saw blade around a path defined by a plurality of wheels or spindles, or the linear back and forth motion such as is common on reciprocating saws. The motor may be any of the well-known types of motors for use in power tools such as an induction motor, a universal motor, DC motor, brushless motor, or etc. The motor may be coupled to drive the cutting tool through one or more coupling components that are commonly used to transfer the movement of the motor output shaft to the cutting tool including belts and/or gears. Alternatively, the cutting tool may be mounted directly on the output shaft of the motor, or on a coupling mounted on the motor shaft.

Power tool 10 also includes a control circuit 16 configured to connect to an electrical power source 18. The electrical power source may be an external source such as line power supplied by an electrical cord connected to an electrical outlet, or it may be an internal source such as a battery mounted on, or attached to, the power tool. Furthermore, the power tool may utilize multiple power sources of either type or a combination of both internal and external power sources. For example, some embodiments of power tool 10 may be configured to operate on either internal power or external power as selected by a user or operator of the power tool.

Control circuit 16 includes a combination of interconnected electronic components configured to monitor and/or control one or more functions and/or conditions of power tool 10. A few illustrative examples of such power tool functions and conditions include electrical power supply to the motor, motor speed, motor start-up time, cutting tool rotational speed, ambient and/or motor temperature, cutting tool position, cutting tool size, maintenance intervals, operational times, and etc. However, it will be appreciated that the specific functions and/or conditions that are monitored and/or controlled by any particular embodiment of control circuit 16 will vary depending on the type and features of the corresponding power tool, and that only a single or a few functions and/or conditions may be monitored and/or controlled in some embodiments of power tool 10. For AIM-enabled power tools, the control circuit will typically control and/or monitor one or more functions and conditions of the active injury mitigation technology.

The interconnected electronic components of control circuit 16 may be assembled in a single location within power tool 10, such as on a pc board which may optionally be contained within an electronics housing. Alternatively, the electronic components may be distributed among two or more assemblies or pc boards which are spaced apart within the power tool and interconnected via electronic cables and/or wireless communication connections. In the case of multiple assemblies, some or all the assemblies may be contained within separate housings or enclosures.

Nevertheless, while it is common to enclose electronic components within housings, the form of such enclosures may vary and may even be omitted within the scope of the present disclosure.

It will be appreciated that the particular components, as well as the interconnections and configurations of those components, will vary among different embodiments of power tool 10 and control circuit 16. In the exemplary embodiment of FIG. 1, control circuit 16 includes one or more processing components 20 adapted to execute instructions contained within software module 22. The software is stored on electronic information storage media that is accessible and readable by processing components 20. In some embodiments, the processing component(s) and software may reside in a single physical component such as a programmable digital signal processor with onboard memory. In other embodiments, multiple processing components may be used and/or some or all the software may be stored in separate memory storage modules. In any case, the instructions stored with the software and executable by the processing component(s) determine how the functions and/or conditions of the power tool are monitored and/or controlled by the control circuit. Additionally, it will be appreciated that the software will typically vary depending on the type and features of the power tool.

Control circuit 16 also includes a user interface module 24 which enables an operator of the power tool to monitor and/or control one or more of the power tool functions or conditions. As just a couple of examples, the user interface may include one or more user-input components which allow a user to start and stop the motor, control the speed of the motor, lock the power tool against unauthorized use, and etc. Additionally, user interface 24 may include indicator components to communicate information to the operator such as the status of the power tool, whether the motor is on or off, whether some portion of the control circuit and/or power tool is malfunctioning, and etc.

In response to inputs by the operator via user interface 24, control circuit 16 controls the operation of motor 14 through a motor control module 26. Motor control module 26 may be configured to connect and disconnect electrical power to the motor directly from power source 18, or it may be configured to condition the electrical power prior to connecting it to the motor. In the latter case, the conditioned electrical power may be necessary for nominal operation of motor 14, or it may be used to control some aspect of the operation of the motor such as the nominal speed of the motor or the rate at which the motor spins up from a stopped condition.

In addition to inputs from user interface module 24, exemplary control circuit 16 also receives inputs from one or more sensors 28 configured to sense selected characteristics and conditions of the power tool and/or the operating environment. Examples of such sensors include sensors to detect power tool type, cutting tool size, incoming power levels, battery charge levels, cutting tool motion, motor speed, temperature, cutting tool position, and etc. Such sensors may be electronic, mechanical, or electro-mechanical. The inputs from sensor(s) 28 may determine operation of the power tool depending on the instructions contained within software 22. As just one illustrative example, in response to instructions in the software, processing component 20 may cause motor control 26 to disconnect electrical power to the motor when a malfunction is communicated to the control circuit by a sensor even though the operator has input a signal via the user interface for the motor to be on. Additional examples of such operation by control circuits will be described in more detail below in the context of further exemplary embodiments.

For AIM-enabled power tools such as power tool 10, control circuit 16 also includes a detection module 30 configured to detect one or more dangerous conditions such as contact between a person and the cutting tool when the cutting tool is moving. In that example, the detection module is configured to monitor the cutting tool for indications that a person is in contact with the cutting tool such as by one or more electrical coupling(s) between the detection module and the cutting tool, and/or by inputs from one or more of the sensor components 28. Various embodiments of AIM detection methods and components are well-known to those of skill in the art, a few examples of which will be described in more detail below. In the exemplary embodiment of FIG. 1, detection module 30 is electrically coupled to the cutting tool and is configured to drive an electrical signal onto the cutting tool via the coupling. Detection module 30 is also configured to monitor the electrical signal on the cutting tool via either the same or a different electrical coupling. When a person contacts the cutting tool, the electrical signal on the cutting tool is changed, and this change is detected by the detection module. If the detection module determines that the change in the electrical signal on the cutting tool indicates that a person is in contact with the cutting tool, then the detection module signals the one or more processing components 20 that a dangerous condition has occurred. Alternative embodiments of detection module 30 may be configured to detect other dangerous conditions such as close proximity of a person to the cutting tool when the cutting tool is moving.

It will be understood that some functions of the detection module may be performed wholly or partially by one or more of the processing component(s) 20. Thus, for example, the signal that is driven onto the cutting tool may be partially generated by a processing component. Likewise, the signal on the blade which is monitored by the detection module may be wholly or partially evaluated within a processing component for determination as to whether contact has occurred. Furthermore, one of more of the processing components may perform at least a portion of the functions or operations of the other components and modules discussed above. As just one example, one or more processing components may directly drive indicator components of user interface module 24, such as lights or displays, to communicate information to the operator. Therefore, while the various modules of control circuit 16 are indicated schematically in FIG. 1 as separate components or modules, the physical components of the control circuit may perform multiple functions, either partially or wholly. All such variations and configurations are within the scope of the disclosure.

As shown in FIG. 1, AIM-enabled power tools such as power tool 10 also include a reaction mechanism 32 which is configured to perform some action to mitigate the potential injury to a person in the event of a dangerous condition, such as a person who contacts the cutting tool. As is well-known to those of skill in the art, there are a variety of different actions which a reaction mechanism can take to mitigate injury. The types of actions which are effective to mitigate injury can vary depending on the type of power tool and/or the type or size of the cutting tool. In some embodiments the reaction system stops the motion of the cutting tool. In other embodiments the reaction system retracts the cutting tool by moving the cutting tool away from the person to mitigate injury. Stopping and retracting the cutting tool are two examples of actions which a reaction mechanism can take to mitigate injury which are well-known and found on commercially available AIM-enabled power tools. However, various other actions are possible within the scope of the present disclosure including partially or wholly damaging or covering the cutting tool to degrade or destroy the cutting tool's capability to cut. Furthermore, reaction mechanism 32 may take more than one action to mitigate injury such as both stopping and retracting the cutting tool. Alternatively, power tool 10 may have multiple reaction mechanisms, each configured to take one or more different actions.

In any event, reaction mechanism 32 is configured to take the mitigating action when actuated by control circuit 16. Thus, when a dangerous condition is detected by the control circuit, the control circuit then triggers or actuates the reaction mechanism to take action to mitigate the injury. In the exemplary embodiment of FIG. 1, control circuit 16 is configured to detect accidental contact between a person and cutting tool 12. When such contact is detected, the control circuit triggers reaction mechanism 32 to stop the movement of the cutting tool, thereby stopping the cutting tool from cutting anything in contact with the cutting tool. In addition, control circuit 16 is also configured to disconnect electrical power to motor 14 when the contact is detected, though this action is not necessary to mitigate the injury since the movement of the cutting tool has been independently stopped by the reaction mechanism. Instead, the action by the control circuit of disconnecting electrical power to the motor serves to prevent damage to the motor and/or an overloaded electrical circuit due to a stalled motor.

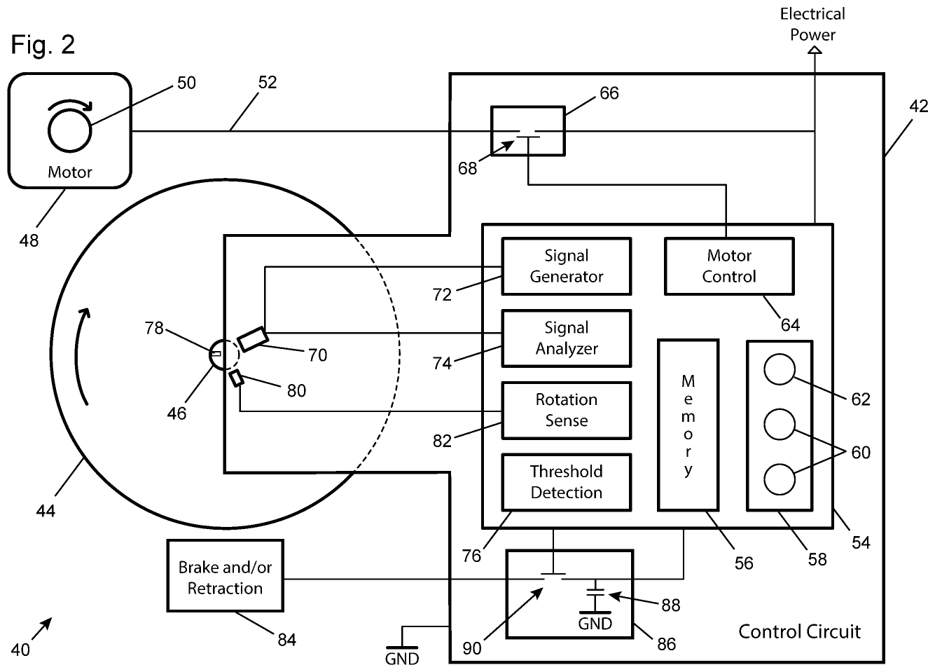

Turning attention now to FIG. 2, an AIM-enabled power tool is shown in which a circular saw blade is used to cut workpieces. Examples of power tools with a circular blade include table saws, hand-held circular saws, track saws and miter saws. The exemplary power tool, shown schematically in FIG. 2 and indicated generally at 40, includes a control circuit 42 which is connected to an external electrical power source through power and ground connections as shown. Power tool 40 includes a circular blade 44 which is mounted on a rotatable arbor 46. Power tool 40 also includes a motor 48 that is coupled to rotate arbor 46 and thereby blade 44.

The output shaft 50 of motor 48 spins as indicated when electrical power is supplied to the motor via a motor power supply cable 52. It will be understood that cable 52 is selected to be suitable for supplying the electrical power required by motor 48 for correct operation in terms of voltage and current, and if the motor is an AC motor, phase and frequency. In the exemplary embodiment, cable 52 supplies both the hot and ground connections required by the motor to operate. In some embodiments the motor may be grounded through an additional and/or separate ground connection.

Output shaft 50 is coupled to drive arbor 46 through a physical coupling (not shown) which includes one or more gears disposed between the output shaft and the arbor. In alternative embodiments, pulleys may be mounted on the output shaft and arbor so that one or more belts may be used to rotate the arbor when the output shaft spins. As a further alternative, the output shaft may be coupled to the arbor through a combination of both gears and belts/pulleys to achieve the desired operation.

Typically, though not necessarily, the rotational speed of the blade which is optimum for cutting selected workpieces will be different than the nominal rotational speed of the motor's output shaft. In such cases, the gears and/or pulleys may be sized to cause a difference in rotational speed between the output shaft and the arbor. As just one illustrative example, it is often desirable for a 10 inch circular blade on a table saw to rotate at a speed of approximately 4,000 rpm. It will be appreciated that this is just a rough approximate speed which is often used when cutting workpieces of wood, and that substantially different speeds may be desirable in some operations and/or with different materials. In any case, the rotational speed of many AC motors will be either substantially higher or lower than 4,000 rpm. For example, typical induction motors running on 60 Hz power may rotate at approximately 3,450 rpm, while a typical universal motor commonly used in table saws may rotate at speeds above 20,000 rpm. Therefore, table saws often include couplings between the motor output shafts and the arbors which increase or decrease the speed of the arbor through differences in gear and/or pulley diameters. Such couplings are well-known and widely used in the art.

Although circular blade 44 is shown schematically in FIG. 2, it will be understood that the blade includes a plurality of cutting edges or teeth (not shown) disposed about the perimetrical edge of the blade. The number of these teeth can vary widely from 20 or less to 200 or more, depending on the intended cutting operation and/or workpiece material. The main body of the blade is typically formed of a metal such as steel, while the teeth are commonly formed of either steel or tungsten carbide bonded to steel. However, other materials are also possible within the scope of the disclosure.

It will be appreciated that the material of the teeth will typically be selected to be harder than the material of the workpieces which the blade is intended to cut. Thus, when the blade is rotating at its nominal operating speed and a workpiece is brought into contact with the perimetrical edge of the blade, each tooth will remove a portion of the workpiece as the tooth passes, thereby cutting the workpiece. Similarly, if a person contacts the perimetrical edge of the blade while it is rotating, the speed and hardness of the moving teeth will cut the person as well.

As with power tool 10 which was described above, the conditions and functions of power tool 40 are monitored and controlled by control circuit 42. The control circuit includes a processing circuit 54 that is electrically coupled to both blade 44 and motor 48. Processing circuit 54 includes one or more processors as well as additional electronic components and circuitry, all of which are interconnected and configured to monitor and control the conditions and functions of power tool 40. Although the processing circuit is schematically represented as a single block, it will be understood that the processing circuit may comprise multiple discrete circuit components which are spaced apart within the power tool and connected through wired and/or wireless connections. Furthermore, the functional modules of processing circuit 54 which will be described below may be performed by a single discrete component, assembly or portion of the processing circuit, or they may be performed, either jointly or redundantly, by separate components, portions and assemblies of the processing circuit.

The functions of processing circuit 54 are determined, at least partially, by software instructions stored within electronic memory module 56. The electronic memory may fully or partially reside on one or more processors, or it may reside on a discrete memory storage component. Alternatively, the memory may be distributed among multiple processors and/or discrete memory storage components. In any event, the memory is accessible by the one or more processors which are configured to read and execute instructions to perform the functions of the processing circuit.

The processing circuit also includes a user interface module 58 which includes one or more user input components 60 as well as one or more indicator components 62. The user input components may be in any one or more of a variety of forms including switches, knobs, buttons, triggers, levers, keyboards, keypads, touchpads, voice-input components or etc. Similarly, the indicator components may be any one or more of a variety of different types including lights, LEDs, displays, speakers or similar human-perceivable indicating components to communicate selected information such as power tool status, error conditions and etc. The inputs from user input components 60 may be received by one or more of the processor components to enable the user or operator to input commands to the processing circuit. Likewise, the outputs to indicator components 62 may be provided or driven by one or more of the processor components to communicate information about the power tool to the operator.

Typically, though not necessarily, user interface module 58, or at least some of the input components 60 and indicator components 62, are disposed in a location on power tool 40 to allow easy interaction and operation for the operator.

Processing circuit 54 also includes motor control module 64 which is configured to output signals to start and stop the motor by connecting and disconnecting electrical power to the motor. In the exemplary embodiment, motor control module 64 controls a motor-rated switch module 66 which is configured to connect and disconnect electrical power to the motor. Motor switch module 66 may be in the form of a magnetic contactor, a relay, a solid-state switch, or any other switching component 68 suitable for conducting electrical power to motor 48. In alternative embodiments, switch module 66 may be comprised of multiple switching components connected in series and/or parallel. In such embodiments the switching components may be controlled by motor control 64 either jointly by a common signal, or independently by different signals in order to minimize the possibility of a switch failing in the closed position, thereby preventing power from being disconnected from the motor. Exemplary embodiments of this latter case are described in more detail in U.S. Pat. No. 10,442,107, titled “Control Systems For Power Tools,” the entire disclosure of which is incorporated herein by reference. In other alternative embodiments, switch module 66 may include additional circuitry configured to control the supply of electrical power to the motor so as to vary the operation of the motor. Examples of these alternative embodiments include switch modules that “soft-start” the motor or control the rotational speed of the motor.

Motor control 64 starts and stops motor 48 in response to inputs from the operator via user interface 58, as well as software instructions contained in memory module 56. Additionally, motor control 64 may include additional components which function to determine when electrical power is supplied to the motor. For example, some embodiments of motor control 64 include circuitry to prevent a software or processor error from starting the motor unless the operator has input a signal via the user interface to start the motor. Such circuitry can also be configured to prevent the motor from suddenly restarting after a power failure even though the operator failed to switch a motor start switch to the OFF position. Thus, such circuitry provides redundant fail-safe operation of the motor to ensure the motor never starts unexpectedly.

Power tool 40 is AIM-enabled and control circuit 42 is configured to detect accidental contact between a person and the blade. Control Circuit 42 detects contact between a person and the blade by driving an electrical signal onto the blade and then monitoring and analyzing the signal on the blade for changes indicative of contact by a person. The control circuit includes an electrical coupling 70 which electrically connects processing circuit 54 to arbor 46, thereby enabling the transmission of electrical signals between the processing circuit and the arbor. At least a portion of arbor 46 is constructed of an electrically conductive material such as steel, so that when blade 44 is mounted to the arbor, the blade and arbor are electrically connected. As a result, electrical signals transmitted to the arbor are also transmitted onto the blade.

It will be understood by those of skill in the art that the arbor and blade have an inherent electrical impedance, such that when the control circuit monitors the electrical signal on the blade and arbor, the monitored signal is impacted by the impedance of the blade and arbor. Furthermore, when a person contacts the blade, the apparent impedance of the arbor and blade changes due to the impedance of the human body which is coupled to the blade by physical contact. This changed impedance results in a further change to the monitored signal. In contrast, when workpieces of wood and other electrically non-conductive materials contact the blade, there is little if any change in the apparent impedance of the blade. As a result, any changes in the monitored signal are typically much smaller. Thus, the control circuit detects when a person contacts the blade by analyzing the monitored signal for changes which are indicative of human contact.

It will be appreciated that electrical coupling 70 may establish a connection between the processing circuit and the arbor that is electrically conductive, electrically capacitive, or some combination of conductive and capacitive. The conductivity and/or capacitance of the coupling is also referred to herein as the electrical impedance of the coupling. One example of a capacitive connection includes concentric brass rings disposed around the perimeter of the arbor. The interior surfaces of the brass rings are spaced apart from the exterior surface of the arbor such that each ring forms one plate of a capacitor while the arbor itself forms the corresponding plate. One example of a conductive coupling includes one or more carbon brushes placed in contact with the arbor. The carbon brushes allow the electrical connection to be maintained even while the arbor rotates. While coupling 70 is described above as coupled to the arbor, alternative embodiments are possible where the processing circuit is coupled to a different component which is electrically connected to the blade, or directly to the blade itself. An example of such a direct coupling includes flat conductive plates placed parallel to, but spaced apart from, the blade. Additional examples and detailed descriptions of such couplings are contained in several of the references incorporated above.

To produce the electrical signal used for detecting contact, processing circuit 54 includes an electrical signal generator 72 configured to generate an electrical signal suitable for distinguishing contact between the blade and a person, from contact between the blade and a workpiece or other material. This generated signal (also referred to herein as the “drive signal”) is coupled onto the arbor via coupling 70. The processing circuit further includes a signal analyzer 74 which is also coupled to the arbor via coupling 70. Thus, the electrical signal that is induced on the arbor is transmitted to the signal analyzer via coupling 70 for analysis. The signal analyzer is configured to analyze or evaluate this signal (also referred to herein as the “sense signal”) for changes indicative of a person contacting the blade.

In the exemplary embodiment, signal generator 72 is configured to generate an AC signal. It has been found that an AC signal is suitable for both capacitive and conductive electrical couplings. Likewise, signal analyzer 74 is configured to receive and analyze various characteristics of AC signals such as amplitude and/or phase. It will be understood by those of skill in the art that there are many different circuits, electronic components, and methods for both generating and analyzing AC signals. One example of an AC signal generator includes employing a digital signal processor with pulse width modulator outputs to drive a resonator circuit, thereby enabling software control of the generated signal. Similarly, an analog-to-digital converter (also referred to herein as an “ADC”) incorporated into one or more processors can be used to convert the sense signal to a digital signal, at which point software filters and analysis can be performed by one or more processors to evaluate changes in the signal. Exemplary embodiments of such signal generators and analyzers will be described in more detail below. Nevertheless, the particular circuits, components and methods are not critical, and all embodiments configured to generate and analyze an electrical signal for contact detection are within the scope of the present disclosure.

In any case, the AC drive signal produced by signal generator 72 is coupled onto arbor 46 via coupling 70. Due to the impedance of the coupling as well as the blade and arbor, the sense signal received at signal analyzer 74 will be different that the drive signal produced by the signal generator. To ensure the sense signal has sufficient amplitude for detection and an acceptable signal-to-noise ratio, signal generator 72 is configured to adjust the drive signal as needed to achieve a targeted sense signal. For example, the amplitude of the drive signal may be an order of magnitude greater than the targeted amplitude of the sense signal.

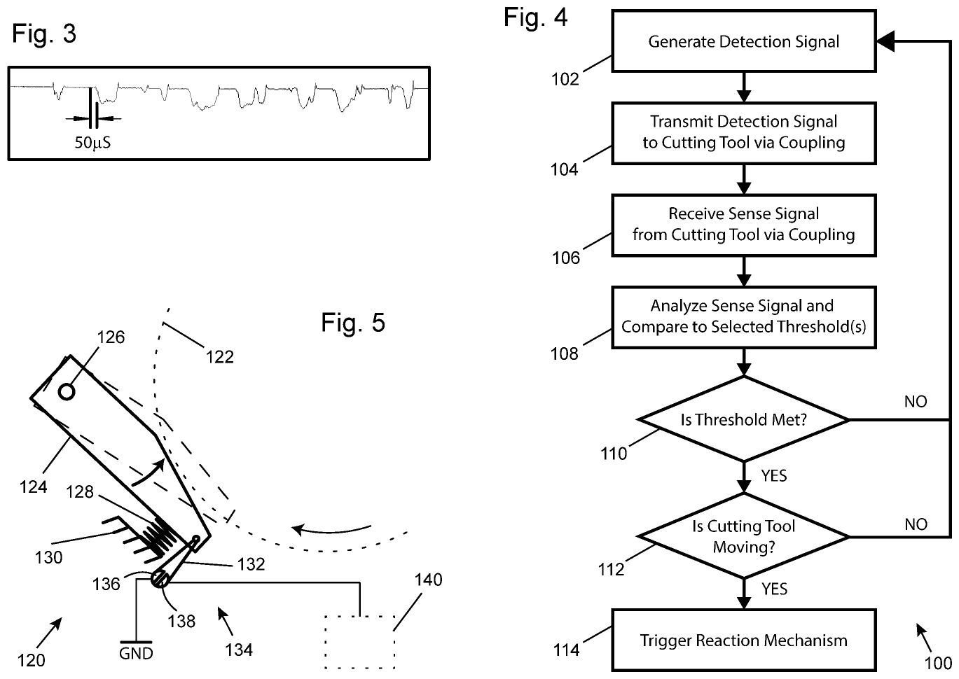

As discussed above, signal analyzer 74 analyzes the sense signal for changes indicative of a person contacting the blade. Such changes can be relative to the drive signal or may be changes to the sense signal over various selected time periods. Indeed, since changes in the sense signal may vary depending on various conditions of the contact, some embodiments of control circuit 42 analyze the sense signal for multiple different changes. Turning attention briefly to FIG. 3, actual data is graphed showing a sense signal captured when a person contacted the teeth of a circular saw blade spinning at approximately 4,000 rpm. The drive signal was an AC signal with a frequency of approximately 500 kHz. The signal was analyzed to determine the peak-to-peak voltage amplitude of the sense signal as a function of time. The figure includes a pair of vertical bars indicating the time scale of the signal. The generally flat upper level seen throughout the graph indicates time periods when there was no contact between the person and the teeth of the blade. Conversely, the generally periodic portions of the graph where the signal dips, indicate periods where a tooth on the blade is moving in contact with the person.

To determine whether a change in the sense signal is indicative of a person contacting the blade, processing circuit 54 includes a threshold detection module 76.

The threshold detection module evaluates the changes in the sense signal reported by the signal analyzer and compares those changes to one or more selected thresholds stored in memory module 56. These thresholds may be selected based on theoretical expectations and/or empirical evidence, or both. It has been experimentally determined that, when a person contacts the cutting tool of some embodiments of AIM-enabled power tool 40, an electrical load of approximately 30 pF is added to the capacitance of the cutting tool, thereby causing a corresponding change in the sense signal. In such cases, a change to the sense signal corresponding to an additional capacitive load on the cutting tool of approximately 30 pF within a given time frame, may be selected as one threshold. In any case, threshold detection module 76 evaluates the one or more changes in the sense signal relative to the corresponding thresholds and determines whether a person has contacted the blade.

The functions of the signal generator, signal analyzer and threshold detection module are typically performed on a continuous or repeated basis to detect contact while the power tool is in use. In some embodiments, the drive signal is continuously generated, while the sense signal is analyzed at discrete time intervals, such as by integrating the continuous sense signal over time and then calculating an average sense signal for analysis. However, it will be appreciated that such time intervals should be relatively short to ensure that detection of contact occurs with minimal delay. Although different time intervals may be selected based on a number of factors including the available processor speed, power tool type, and common accidental contact scenarios, typical time intervals may be in the range of 10-50 usec or, alternatively, less than 10 usec.

If threshold detection module 76 determines that a person has contacted the blade, then the response to such determination will depend on the instructions stored within memory module 56. In some embodiments of power tool 40, any contact between a person and the blade may be dangerous so that action is necessary to mitigate possible injury. However, in many power tools it is common, or at least foreseeable, that an operator will intentionally touch the blade when the motor is off and the blade is stopped. While a best practice by an operator might be to disconnect the power tool from the source of electrical power before touching the blade, an injury will not necessarily occur from touching a stopped blade even though the power tool remains connected to electrical power. Therefore, many AIM-enabled power tools, such as exemplary power tool 40, are configured to only react if contact is detected while the blade or other cutting tool is moving while being driven by the motor, or during the period after the motor has been turned off but before the blade has come to a stop. This period is commonly referred to as coast down.

In order to react only if a person contacts the blade while it is moving, control circuit 42 is configured to determine if the blade is moving by sensing rotation of arbor 46. Detailed descriptions of various circuits, components, and methods for detecting rotation of the arbor can be found in U.S. Pat. No. 8,371,196, titled “Motion Detecting System For Use In A Safety System For Power Equipment,” the entire disclosure of which is incorporated herein by reference. In the exemplary embodiment of FIG. 2, arbor 46 includes a permanent magnet 78 embedded in the side of the arbor. When the arbor rotates, the magnet rotates as well, thereby defining a circular orbit around the axis of the arbor. Control circuit 42 includes a Hall effect sensor 80 positioned near the circular orbit so that, as the magnet passes by the Hall effect sensor once during each rotation of the arbor, the sensor outputs an electrical signal which is transmitted to a rotation sense module 82 within processing circuit 54.

It will be appreciated that while the exemplary embodiment shown in FIG. 2 utilizes a single magnet and a single Hall effect sensor, other configurations are also possible within the scope of the disclosure. For example, two or more Hall effect sensors could be employed and positioned either symmetrically or asymmetrically around the orbit of the magnet. Alternatively, or additionally, two or more magnets could be embedded in the arbor. Furthermore, asymmetrical positioning of two or more sensors and/or two or more magnets would allow the rotation sense module to determine not only rotational speed, but also rotational direction and even position. This configuration may be advantageous in applications (e.g., reciprocating saws) where the cutting tool can be driven in two or more directions, especially if the injury mitigating action to be taken when a dangerous condition is detected will vary depending on the direction the cutting tool is moving.

In any case, rotation sense module 82 is connected to Hall effect sensor 80 so that when magnet 78 passes by the sensor, the signal produced at the output of the sensor (also referred to herein as a “rotation pulse”) is received by the rotation sense module. The rotation sense module is configured to calculate the rotational speed of the blade based on the time intervals between rotation pulses. In some embodiments, rotation sense module 76 is also configured to calculate rotational acceleration or deceleration. In such embodiments, the rotation sense module can predict when the blade will come to a stop based on current speed and deceleration. Additionally, calculation of acceleration and deceleration may enable the rotation sense module to monitor motor startup speed, blade loading, kickback, motor malfunction, and etc.

While exemplary control circuit 42 determines if blade 44 is moving by sensing rotation of arbor 46, it will be appreciated that many alternative embodiments are possible within the scope of the present disclosure. As just one example, the control circuit may be configured to sense movement of the cutting tool itself, rather than the arbor. As a second example, since the cutting tool is driven by the motor, the control circuit may be configured to sense motor movement. In addition to sensing movement of the motor by the mechanisms described above and in the incorporated references, movement of the motor can also be sensed by sensing the power supplied to the motor, and then sensing the back emf on the motor power supply cable once power to the motor is disconnected.

Since control circuit 42 is configured to detect when the blade is moving, the control circuit is capable of determining whether contact between a person and the blade is potentially dangerous or not. Thus, if the control circuit detects the contact when the blade is stopped, no mitigating action is necessary. In some embodiments, the control circuit may be configured to take mitigating action only when the speed of the blade is calculated to be over a selected threshold speed that could cause injury (also referred to herein as a “dangerous speed”). For purposes of illustration, the control circuit might be configured to take mitigating action only if contact is detected when the blade is moving faster than 1 rpm, or 10 rpm, or 20 rpm, etc. For those embodiments where any movement of the blade is considered dangerous, then the threshold is essentially set at 0 rpm so that the control circuit will take mitigating action if contact is detected unless the blade is actually stopped or motionless. Regardless of what blade speed threshold is selected, if the threshold detection module detects contact when the rotation sense module determines the blade is moving at a speed above the threshold, then the control circuit is configured to trigger one or more actions to mitigate injury.

As shown in FIG. 2, power tool 40 includes a reaction mechanism 84 configured to stop and/or retract the blade. Although reaction mechanism 84 is depicted schematically in FIG. 2 near the perimeter of the blade, the reaction mechanism may act on either the blade or the arbor, or both. Alternatively, the reaction mechanism may act upon a different component such as a structural member that supports the arbor and blade. Examples of various reaction mechanism have been described in detail in some of the incorporated references herein. Additionally, several exemplary reaction mechanisms in the context of various different types of power tools will also be described in more detail below.

In any event, the reaction mechanism is typically positioned within power tool 40 to act as quickly as possible so that any injury to the person is minimized. Although the reaction mechanism is positioned so as to react when a dangerous condition is detected by the control circuit, the reaction mechanism does not react until triggered by the control circuit. Thus, control circuit 42 includes a trigger circuit 86 electrically coupled to the reaction mechanism. The particular configuration of trigger circuit 86, including the form or type of the triggering signal transmitted by the trigger circuit, will vary depending on the reaction mechanism. The triggering signal may be digital or analog, or multiple signals may be employed including digital and/or analog combinations. In the exemplary embodiment, the reaction mechanism is configured to be triggered by an input of electrical charge. Trigger circuit 86 includes an electrical capacitor 88 which is connected to processing circuit 54. The processing circuit is configured to charge capacitor 88 to a predetermined charge level sufficient to trigger reaction mechanism 84. The processing circuit maintains the charge of capacitor 88 at the predetermined level during operation of the power tool.

To discharge capacitor 88, trigger circuit includes a switch 90 connecting the capacitor to the reaction mechanism. Switch 90 is controlled by threshold detection module 76 so that, during normal operation, switch 90 is held in an open condition to prevent discharge of the charge stored in capacitor 88 into reaction mechanism 84. However, if the threshold detection module determines that contact between a person and the blade has occurred while the blade is moving at a dangerous speed, then the threshold detection module causes switch 90 to close, thereby discharging the charge stored in capacitor 88 into the reaction mechanism. Simultaneously or subsequently, motor control module 64 controls motor switch module 66 to disconnect electrical power to motor 48. In addition, user interface module 58 may be configured to display a warning or error condition via one or more of the indicator components.

Turning attention briefly to FIG. 4, a flowchart depicting one exemplary method for detecting dangerous contact between a person and a cutting tool is shown indicated generally at 100. Method 100 includes the step of generating a detection signal as indicated at 102. The detection signal may be an AC signal generated as described above, or it may be some other signal or combination of signals suitable for detecting contact between a person and a cutting tool. The detection signal is then transmitted to the cutting tool via an electrical coupling at step 104. As discussed above, the electrical coupling may connect a signal generator directly to the cutting tool, or the coupling may connect to some other component, such as an arbor, which is electrically connected to the cutting tool. In any event, once the detection signal has been transmitted to the cutting tool, the resulting signal on the cutting tool is received from the cutting tool via an electrical coupling as shown at step 106. The coupling of step 106 may be the same as, or different from, the electrical coupling of step 104 over which the drive signal is transmitted. The received signal is also referred to as the sense signal as it is the signal sensed on the cutting tool. The sense signal is then analyzed, at step 108, for one or more indications of contact between a person and the cutting tool, including by comparing changes in the sense signal to one or more selected thresholds indicative of such contact. The result of the analysis at step 108 then determines the outcome of step 110. If the threshold(s) are not met, indicating no contact is detected, the method restarts again at step 102. Conversely, if a threshold is met the method continues to step 112 where the control circuit determines if the cutting tool is moving, such as by sensing movement of the arbor as described above. If the cutting tool is not moving, the detected contact is considered as not being a dangerous condition. In such case no further action is necessary and the method restarts at step 102. On the other hand, if the cutting tool is moving, the contact is considered a dangerous condition so that the method then proceeds to step 114 in which one or more reaction mechanisms are triggered to mitigate injury to the person contacting the cutting tool.

It will be appreciated that alternative embodiments of method 100 may be performed by control circuit 42 that include additional steps before and/or after the step of triggering a reaction mechanism, including additional steps before step 102. Furthermore, some or all of the steps described above may be performed as two or more sub-steps to achieve an equivalent function or outcome. All such alternatives are within the scope of the present disclosure.

Method 100 is performed by exemplary control circuit 42 through one or more processors in processing circuit 54 executing software instructions stored within memory module 56, and utilizing additional components and circuitry interconnected with the processor(s) within the control circuit. In addition, some or all of the other various functions and processes of control circuit 42 and processing circuit 54 which have been described above may be performed by one or more processors executing the stored software instructions. Allowing processor control of at least some of the power tool functions enables at least partial control of the power tool by the software instructions that are stored in memory storage module 56. It will be appreciated that integrating software control into power tools enables the construction of power tools with added safety and operational features.

For example, the software executed by the processor(s) of a processing circuit may include self-check routines to ensure the power tool is safe to operate before enabling the motor to be started. The self-checks may be of the processing circuit itself, some other component or module of the control circuit, or component of the power tool external to the control circuit. As just one example, AIM-enabled power tools may be configured to test whether the sense signal is being properly received when the drive signal is initiated. As another example, a trigger circuit with a capacitor could be tested by sensing the time needed to charge and/or discharge the capacitor either fully or partially. As a further example, the control circuit may include a sensor to measure ambient temperature, which enables the control circuit to disable operation of the power tool if the ambient temperature is outside the operational range of the control circuit and/or power tool components. A further example, which will be described in more detail below, includes testing electrical coupling 70 to detect any potential deterioration of the coupling's ability to transmit the drive and/or sense signals.

It will be appreciated that the exemplary embodiments depicted in FIGS. 1-3 and described above may be implemented in a variety of different power tools and utilizing a multitude of different components, assemblies, circuits, combinations, connections, and techniques. For purposes of illustration, a few variations of such components, assemblies, circuits, combinations, connections, techniques, and power tools are described in more detail below.

Turning attention now to FIG. 5, one particular embodiment of a reaction mechanism is shown and indicated generally at 120. Reaction mechanism 120 is configured to stop the movement of a rotatable cutting tool having a generally circular perimeter such as a circular saw blade, shown in dotted lines at 122. Reaction mechanism 120 includes a brake component 124 mounted on a pivot member 126 such as a pin or shaft. Brake component 124 (also referred to herein as a brake pawl) is positioned outside the perimeter of the blade so that at least a portion of the brake pawl contacts the perimeter or edge of the blade when the brake pawl pivots in a counter-clockwise direction as depicted in FIG. 5. Blade 122 includes a plurality of cutting teeth (not shown) disposed around the perimeter of the blade. Thus, if brake pawl 124 is pivoted into contact with the blade, the teeth of the blade will engage at least a portion of the brake pawl.

Brake pawl 124 is preferably constructed of a material that is somewhat softer than the material(s) of which the blade and teeth are constructed so that the teeth can at least partially cut into the brake pawl. Alternatively, just a portion of the brake pawl may be constructed of a softer material. Since many saw blades are constructed of steel and include teeth of steel and/or tungsten carbide, suitable materials for the brake pawl might include softer metals such as aluminum, or plastic materials such as ABS or polycarbonate. However, there are many other brake pawl materials possible within the scope of the disclosure including various types of rubber, wood, and etc.

As depicted in FIG. 5, blade 122 rotates in a clockwise direction. As a result, the harder material of the blade and teeth are able to cut, grip and/or dig into the softer material of the brake pawl when the brake is pivoted into the moving blade, thereby pulling the brake pawl in a further counter-clockwise direction into the blade. However, the size, shape, and material of the brake pawl, in addition to the location of the pivot axis, are all preferably selected to stop the rotation of the blade before the blade cuts completely through the brake pawl or causes the brake pawl to rotate so much that the blade teeth pull out of the brake pawl. Since the teeth of the blade can only pull the pawl a relatively short distance, this causes the blade to bind up or self-lock against the brake pawl. For example, the position of the brake pawl shown in dashed lines in FIG. 5 is representative of a typical distance of travel for an exemplary aluminum pawl to stop a steel blade with 40-80 tungsten carbide teeth. From this view it will be appreciated that the rotation of the blade after the teeth begin cutting into the pawl is typically a fraction of a revolution.

In some exemplary embodiments of brake pawl 124, the shape and features of the brake pawl, in combination with the material of the brake pawl, allow the brake pawl to partially deform or crumple as the teeth of the blade are digging into the brake pawl. This helps to reduce the shock and force generated during stopping the blade, thereby lessening the stress on surrounding and supporting structures of the power tool including the arbor on which the blade is mounted.

To allow unimpeded rotation of the blade during normal operation, brake pawl 124 is positioned near the edge of the blade but not in actual contact with the blade. Therefore, brake mechanism 120 also includes a force-generating component such as compression spring 128 which is positioned to urge or move the brake pawl into contact with the blade. Spring 128 can also be thought of as a stored-energy component. In the exemplary embodiment, spring 128 is positioned against the brake pawl opposite the blade and is compressed between the brake pawl and a support structure or base component 130. During normal operation, the brake pawl is held away from the blade and the spring is held in compression by a restraining member in the form of a fusible link or fuse wire 132. The fuse wire is looped between a stationary electrode assembly 134 and either the brake pawl, or some component or mechanism that holds the brake pawl. In some embodiments, the fuse wire may be formed in multiple loops to increase the amount of spring force the wire is able to restrain. Alternatively, the wire can be looped over one or more links, levers, or other mechanisms to add mechanical advantage so that the fuse wire can restrain higher loads. In any event, the wire is held is tension by the force pressing against the brake pawl which the wire prevents from moving.

Exemplary electrode assembly 134 includes two electrode terminals 136 and 138. At least one loop of fuse wire 132 passes over both electrode terminals. Electrode terminal 136 is connected to electrical ground. If electrode terminal 138 is connected to a source of electric current or charge, then the charge or current will be conducted from electrode terminal 138 to electrode terminal 136 via fuse wire 132 provided the fuse wire is constructed of an electrically conductive material. In the exemplary embodiment, the fuse wire is constructed of stainless steel wire having a diameter of approximately 0.010 inches. As a result, by connecting electrode terminal 138 to a suitable source of electric current, such as a trigger circuit 140, a sufficient amount of current may be conducted via the fuse wire so as to cause the fuse wire to fuse or melt. Therefore, a control circuit, such as the exemplary control circuit of FIG. 2, which is configured to detect dangerous contact between a person and blade 122 can trigger reaction mechanism 120 to mitigate any injury by stopping the rotation of the blade.

It will be appreciated that various modifications to exemplary reaction mechanism 120 are possible within the scope of the disclosure. For example, force-generating component 128 may be a different type or combination of springs including torsion springs, extensions springs, leaf springs, and etc. Alternatively, elements configured to generate force or store energy other than a spring can be used such as one or more explosive devices, compressed gas, opposing magnets, solenoids, and etc. In any case, the force-generating component selected is preferably configured to pivot the brake pawl into contact with the blade as quickly as possible to ensure the blade stops as quickly as possible to minimize injury. In some exemplary embodiments, a compression spring configured to generate approximately 140-150 lbs. of force has been found to be capable to moving a brake pawl, which is configured to stop a 10 inch diameter saw blade, up to 0.125 inches within about 1 millisecond or less. Such reaction mechanisms often enable the blade to be stopped in less than 10 milliseconds and even less than 5 milliseconds depending on the size and weight of the blade, and the nature and geometry of the teeth.

In addition to alternative versions of the force-generating component, alternatives to other components of brake mechanism 120 are also possible. As just one example, restraining mechanism 132 may some other mechanism than a fuse wire, such as an electromagnet which can be shut off through a suitable trigger circuit. Furthermore, the size and shape of brake pawl 124 can be modified from the embodiment shown in FIG. 5, or the brake pawl can be moved into contact with the blade through a different type of motion such as sliding, etc. Thus, it will be understood that all such variations and modifications to the selection, combination, arrangement, and operation of the components of reaction mechanism 120 which are consistent with quickly stopping the motion of a cutting tool are with the scope of the present disclosure.

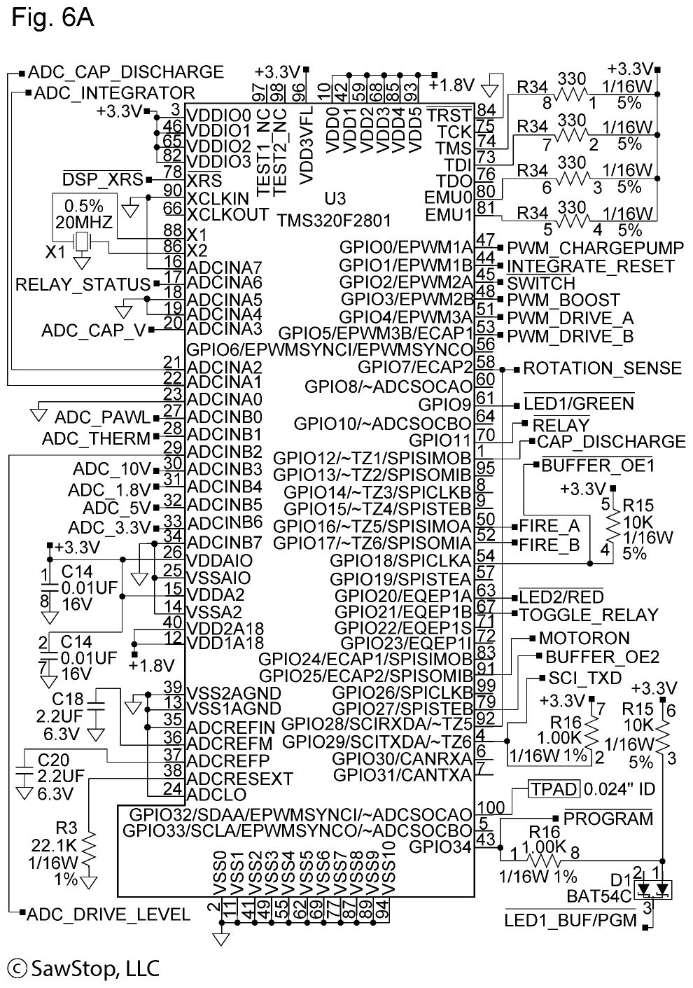

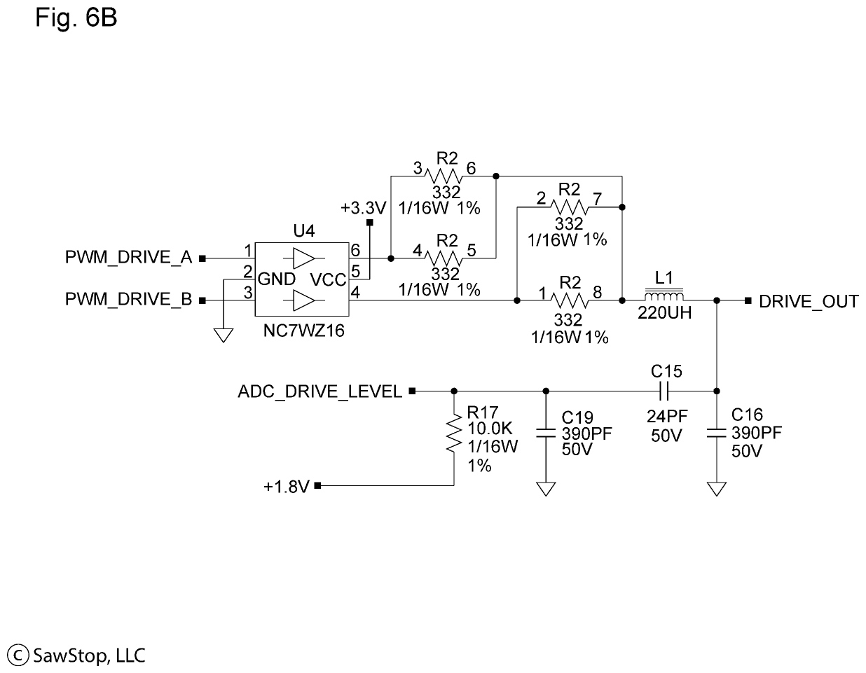

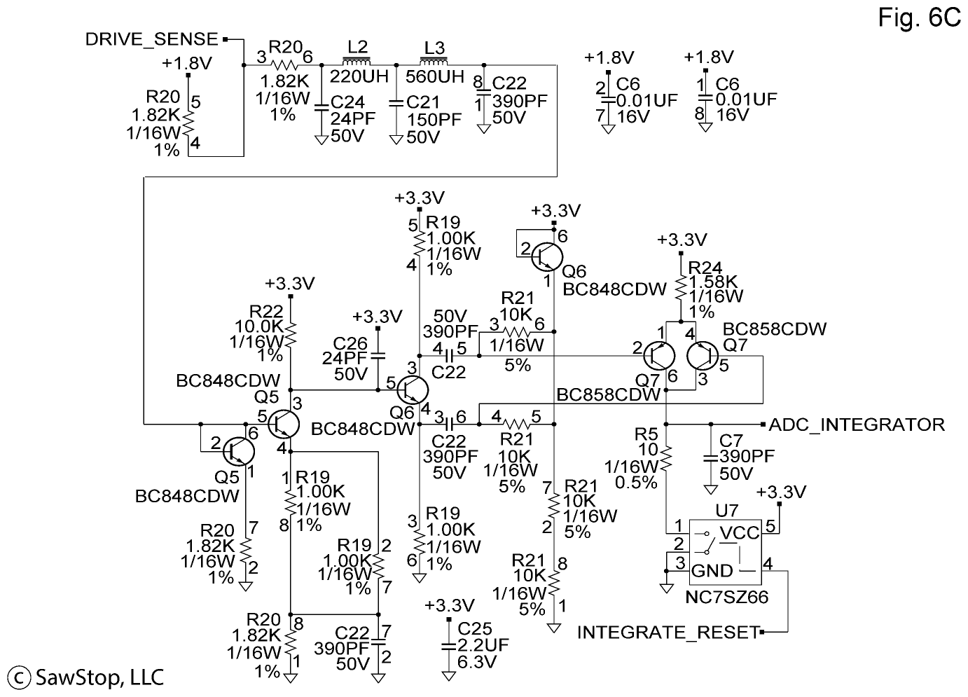

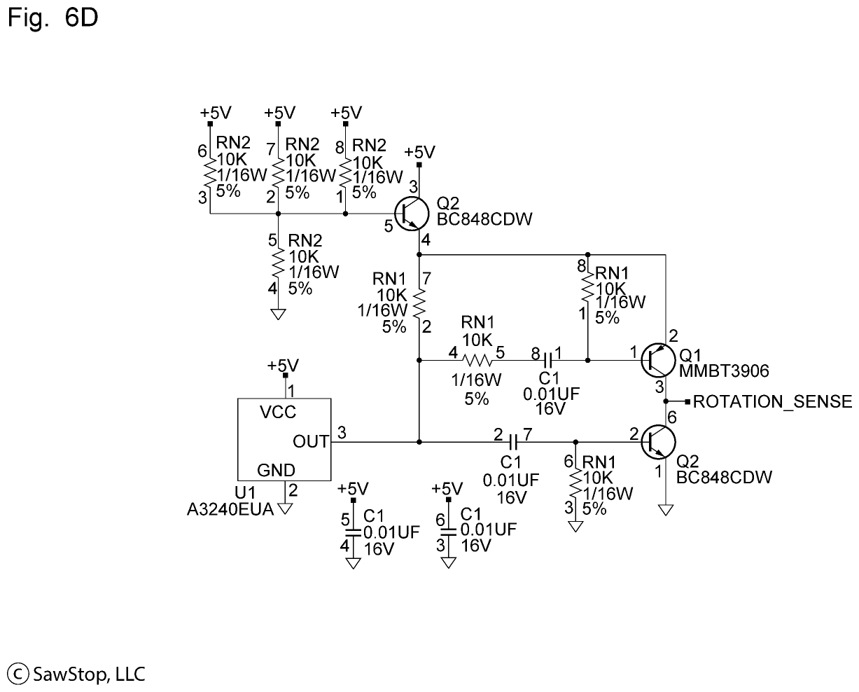

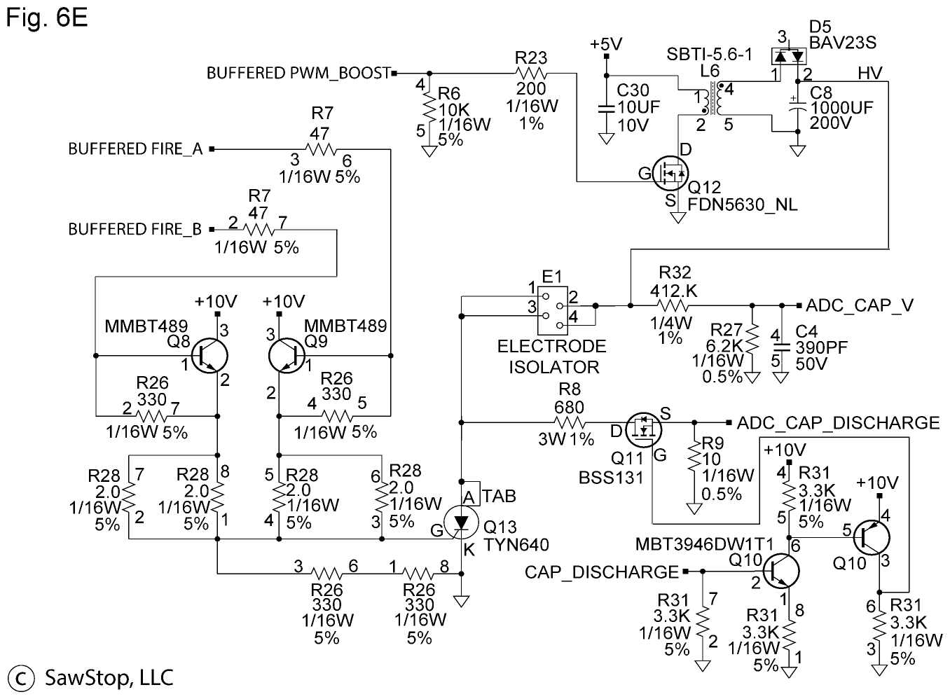

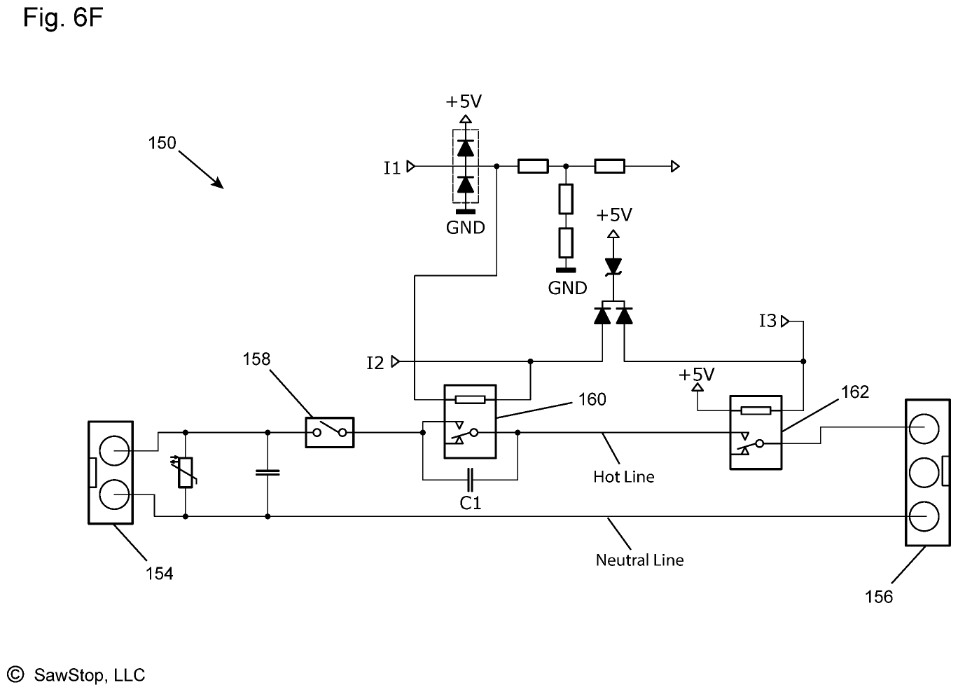

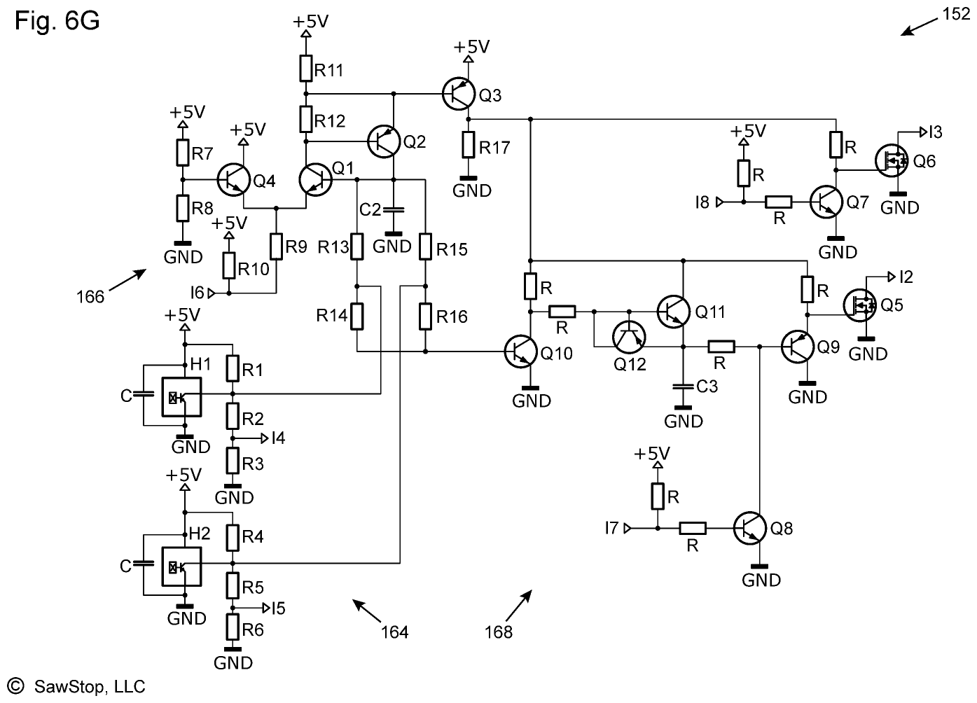

Turning attention now to FIGS. 6A-6G, sections of one exemplary control circuit are shown for an AIM-enabled power tool with a circular saw blade and a reaction mechanism including a brake to stop the blade. FIG. 6A shows a digital signal processor (also referred to herein as a DSP or microcontroller) configured to perform one or more functions of the exemplary control circuit. The DSP includes a multi-channel, internal, analog-to-digital converter (ADC) input, internal pulse-width modulator (PWM) outputs, event capture inputs, serial port and programmable general purpose input/outputs (GPIO), as well as clock, phase lock loop, timing, watch dog timer, RAM, ROM and flash memory functions. The pull-up resistors R15(pin4,5), R15(pin3,6) and R16(pin2,7) on the DSP's programmable IO (input/output) pins GPIO18, GPIO29, and GPIO34 keep the voltage high on those pins during power-up. This configures the DSP to boot from flash upon power-up. However, GPIO34 can be forced low to put the DSP in programming mode as can be done by an external source.

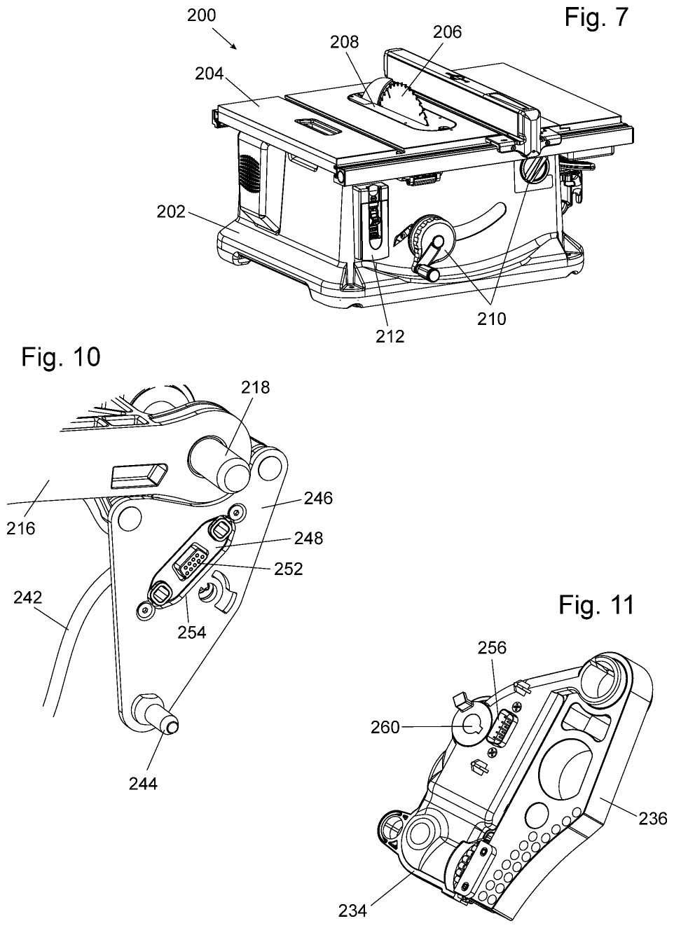

The cycle time of the DSP is selected as 10 nanoseconds, defined by the 20 MHz ceramic resonator X1 connected to the DSP as shown in FIG. 7, along with an internal phase lock loop x10/2 within the chip which provides for 100 MHz operating frequency. Although a ceramic resonator is not typically as accurate as a crystal, it is far more mechanically robust against vibration or other shock, such as might be found in power tools or occur during sonic welding, for instance. As a second alternative, it is also possible to use a solid-state oscillator, which is typically the least accurate, but provides the best possible mechanical durability.

FIG. 6B shows a circuit for a sinusoidal 500 kHz driver derived from a purely digital controller. The objective of this circuit is to generate a stimulus under software control which is used to drive a coupling electrode to impart a signal onto a blade. In other words, the circuit of FIG. 6B, under the control of the DSP of FIG. 6A, generates the drive signal which is then coupled to a blade via an electrical coupling. The software in the DSP controls the phase relationship between a complementary pair of hardware pulse width modulators (PWMs), and allows for a wide range of signal amplitudes of the resulting sinusoid. The sine wave signal is adjustable over a range of approximately 0Vp-p to 20Vp-p (5 to 20 volts peak-to-peak typical) to compensate for the effects of blade loading, etc. It is also preferable that the software is capable of turning off the driver completely, as well as providing for compensation for nonlinearity in the response of the driver circuit. A suitable adjustable voltage resolution is about 1/8% of full scale, although other values could be used. In addition, it is desirable that the DSP be configured to measure and monitor the output voltage of the driver with an accuracy of a few percent.

The basic approach used in the driver is to generate two 500 kHz square wave sources of variable duty cycle and/or phase and to drive a resonator with the combined waveform in order to create a sine wave output of variable amplitude. Note that a 1Vp-p square wave is composed of multiple Fourier components, among them is a fundamental sine wave component of about 1.3Vp-p. The use of the 2nd order resonant filter composed primarily of L1 and C16 provides attenuation of the higher order harmonics as well as resonant selectivity of the fundamental tone.

In order to modulate the amplitude of the sinusoid, software provides for precise phase shift control on the hardware PWM outputs Drive A and Drive B. In this exemplary embodiment, the signals on Drive A and Drive B are fixed 500 kHz frequency 50% duty cycle square waves. The phase difference between these outputs, along with summing resistors network R2, alter the effective waveform feeding the tuned resonant circuit. An additional and necessary function of the network R2 is to dampen the LC response of the filter. The end result is that through phase control of the hardware PWMs, the DSP is able to regulate the amplitude of the output analog sinusoid at the node DRIVE_OUT.

Integrated circuit U4 acts to buffer the output of the DSP, and provides low impedance drive to the circuit to allow for stiff output regulation under various blade and circuit loading conditions. In addition, since this buffer is powered from a regulated 3.3V, the circuit is insensitive to fluctuations in the unregulated 5V input as when, for example, a relay, charger, or other high current circuit disturbs the 5V line.

The resonator is formed by L1 and C19, C15, C16, and any reactance loading at the DRIVE_OUT node. Economics motivate the use of a 5% tolerance on the inductor and capacitors, with additional uncertainty due to temperature. In addition, the capacitance looking out the DRIVE_OUT port can vary between a nominal level when the blade is not loaded to a higher level when sawing wet wood, and it is desired to have this variability affect the amplitude of the signal at DRIVE_OUT by only a few percent. These factors, combined with the desire to generate the voltage range of 5 to 20Vp-p at DRIVE_OUT, led to the use of a Q of around 5 to 7 in the resonator. This Q is set by the resistors R2(pin3,6), R2(pin4,5), R2(pin2,7) and R2(pin1,8) combined with the typical loss in the inductor. The actual timing of the resonator is not critical to the operation of the system, as it can be compensated for in many ways. However, provisions have been included to monitor the actual drive level through sampling the drive waveform with the onboard ADC of the microprocessor. This provides for redundancy to ensure the drive output is within regulation.

FIG. 6C shows a filtering and integrator circuit that may be used, in combination with the DSP, to receive and analyze the sense signal. The circuit is configured to periodically measure the amplitude of the signal detected on the blade via an electrical coupling. The response of the filter is tuned to match the stimulus frequency of interest, in this case 500 kHz. The integrating interval is performed under software control, in this case every 6 microseconds. This circuit is preferably designed to maximize immunity to spurious signals at other frequencies, as well as to provide relative immunity to electrostatic discharge from events such as the charging of the arbor/blade from a rubber drive belt or cutting of non-conductive materials. However, it should be understood that this function could be accomplished many different ways including with a peak amplitude detector, a power detector, or direct sampling of the signal with an A/D converter to measure the amplitude of the signal. Also, although the measurement in the present circuit is carried out at discrete time intervals, it should be understood that such a measurement could be carried out continuously, or the rate could be varied under software control.

The topology of the circuit is to amplify and full wave rectify the signal at the node marked DRIVE_SENSE, which through wiring is connected to an electrode coupled to the arbor. Filtering is used in this circuit to minimize interference by spurious signals. A network of components surrounding L2 and L3 form a band pass filter centered on the expected frequency of the sensed signal, typically about 500 kHz. C22 and C26 provide extra frequency domain response filtering. The end result of all these elements is reduced opportunity for noise to get into the circuit and disturb the desired measurement. After filtering and gain stages, Q6(pins 3,5,4) acts as a phase splitter to split the measurement signal into two components 180 degrees out of phase. These outputs are level shifted by Q6(pins6,2,1), C22(pins3,6), C22(pins4,5), R21(pins3,6), R21(pins4,5), R21(pins7,2) and R21 (pins8,10) such that the two sine waves oscillate 180 degrees out of phase at the same bias voltage. Transistor pair Q7 then converts the negative swinging peaks appearing at their bases into a current proportional to their amplitude that is steered into integrating capacitor C7. The net effect is a full wave rectified current flowing through Q7 and into C7. The result is a ramp waveform across C7 with peak amplitude proportional to the amplitude of the 500 kHz signal detected at the input node DRIVE_SENSE. It should be understood that there are a number of other circuits that could provide this full wave rectifying and integrating functionality, including level detectors, rms meters, etc.

The voltage at the integrator capacitor C7 is sampled by the microcontroller ADC at the end of the measurement period and then reset to 0V to start a new sampling interval. The microcontroller uses U7 as a low impedance switch to perform this reset. The measurement period of 6 us was chosen to be synchronous with the period of the drive signal (2 us) and to be an integer multiple of the number of cycles of the drive signal to minimize ripple in the measurement.

In addition to the filtering provided by analog elements in the circuit, digital filtering on the signal is implemented through software to further reduce noise and properly discriminate between noise and signal. In particular, the integrator output, sampled and digitized just prior to integrator reset, is stored as a 12 bit unsigned binary number. The control software attempts to regulate the average level to a value of 3500. Perturbations on the blade will cause modulation in this level, which is tracked by the software in order to make decisions on whether a dangerous contact is indicated. A memory location in the microcontroller keeps track of the filtered or “recognized” integrator value. Any sudden changes in this value are limited to a maximum change, maxstep, which reflects an empirically determined maximum rate of change for true contact events (i.e., chosen to approximately match the largest changes expected to be created by human contact), and helps reduce sensitivity to a grounded blade that would occur from contact with metal, etc.

In addition to the above described digital filtering, the DSP also includes software executable by the DSP to implement a type of hysteresis filtering as well as de-glitch filtering to keep noise from affecting the current dV/dt sum calculation. Changes in integrator values are only recognized to the extent they exceed a threshold step, i.e., the filter requires update if the new values are not tracking closely to the filter output. The threshold step can be made dependent on whether the step is a positive or negative change and whether the step is in the same direction or opposite direction as the prior step. Since the dV/dt values are the changes in integrator count from sample to sample, eliminating small variations in the integrator count reduces the effect of noise on the sums that are used to detect contact, by eliminating the effect of many small changes and instead only recognizing relatively large changes such as might be induced by a contact event.

FIG. 6D shows a circuit which may be used to detect arbor rotation and send this information to the DSP. The circuit includes a Hall effect sensor U1 which can detect the presence of the south pole of a magnet when the magnet is perpendicular to the sensor. The Hall effect sensor would be mounted in the saw adjacent the arbor, and the magnet would be embedded within the arbor and oriented such that its south pole lines up perpendicularly with the Hall effect sensor as the south pole passes by the sensor while the arbor is spinning. Once per revolution of the arbor, the Hall effect sensor produces a voltage pulse at its output in response to the proximity of the field. There is some hysteresis built into the device such that the sensor turns on at a different point from which it turns off. This hysteresis helps to provide a clean transition in the output of the sensor during boundary conditions. Any number of alternate methods may be employed to sense arbor rotation, including multiple magnetic senders, optical encoders, etc.

As the blade spins, a series of pulses will be seen on ROTATION_SENSE where the time between the pulses will be proportional to the rotational speed of the blade. The output from this circuit (ROTATION_SENSE) is used by the DSP or microcontroller in the processing circuit to detect when the saw blade is spinning.

Rotational sense pulses on ROTATION_SENSE can be sampled by one of the enhanced capture (ECAP) inputs on the microcontroller. These inputs allow the microcontroller to take accurate measurements of the pulse duration timing of each pulse, as well as determining the repetition rate of the pulses on the line. Measuring the pulse duration allows discrimination of a rotation event from another noise event. By tracking the time between rotation pulses, the microprocessor can determine the speed of the blade and also when the blade is speeding up or slowing down. This information is used to disarm the protection system when there is no longer any rotation of the saw blade or when the blade has slowed sufficiently to not present a hazard to the user.

One situation that requires particular attention is when the blade is coasting down to a stop. While the blade is coasting down, the safety system is preferably active to continue to provide protection against serious injury. But as soon as the blade has stopped spinning, the safety system is preferably not active to allow the user the freedom to contact the blade. Reasons why a user might contact the blade include taking a measurement, removing a piece of wood, or changing the blade. Because a user expects to be able to touch the blade as soon as it appears safe to do so, the safety system should preferably disarm just after, and as close as possible to the time the danger has passed.

The speed of the blade can be approximated by sampling at least two rotational sense pulses. As the blade slows down, however, the time between pulses grows larger and it becomes more difficult to accurately determine the time at which the blade comes to a stop or when the blade has slowed down enough so that it no longer presents a danger to the user. This is because it is not known when the last pulse will occur and when the last pulse does occur it is not known whether another pulse is coming. Since a pulse only occurs once per blade revolution, the blade may still present a danger before it comes to a stop even after the last pulse has occurred.

One method for dealing with this situation would be to detect when the blade is spinning slower than a certain rotational rate and then allow for a fixed amount of time before the safety system is disarmed. This method may work adequately for the most part but would lack precision. An unnecessary activation of the safety system may occur when someone touches the blade after it has stopped but before the safety system disarms, or the safety system may disarm while the blade is still moving fast enough to cause injury. In practice, there is a significant inherent uncertainty as to when the blade will come to a stop. Also, to avoid any chance of the system being deactivated before the blade has come to a stop, the system would need to utilize a fixed time after the last rotational pulse that is long enough to cover the worst case blade deceleration. This relatively long fixed time (on the order of one second) ensures that the safety system will be armed whenever the blade is moving so that injuries will be prevented. However, at the same time, it will cause the system to inevitably be active for some period of time after the blade stops under many normal circumstances. As stated earlier, a user expects to be able to touch the blade as soon as it appears safe to do so and often does contact the blade either by touching the blade directly or by touching the blade with a tool or tape measure while moving on in haste to the next task. As a result, with such a system the user is likely to contact the blade after it has stopped but before the system has recognized the stop and disarmed the safety system, thereby leading to unnecessary activations of the reaction mechanism.

A significant improvement to the method described above can be achieved by using the DSP to process rotational speed data in such a way as to predict when a blade which is coasting down will actually come to a stop. The system employs active blade trajectory tracking algorithms that compute the deceleration of the blade and accurately predict when the blade will stop or is no longer spinning fast enough to cause harm to the user. The DSP then uses this algorithm to switch into an unarmed mode where contact with a stationary blade will not cause the system to activate. The more accurately the blade stop time can be predicted, the less likely the chance of the safety system triggering the reaction mechanism due to someone touching the blade after coast-down but before the safety system has been disarmed, or someone being injured due to premature disarming of the system.

This method utilizes the fact that as the blade slows down, the falling edges of the pulses on ROTATION_SENSE will occur less and less frequently and a plot of the speeds verses time yields a locally linear slope of decline. That is, if one were to plot the speed of the blade on a y-axis versus time on an x-axis, one would obtain an approximately straight line of negative slope that would cross the x-axis at the point of zero speed, which is the point at which the blade will have come to a stop. By computing the speed of the blade at various points in time, the point of intercept with the x-axis can be extrapolated with such accuracy that deviations from the actual stop time are humanly unperceivable or so small as to be insignificant. Without a predictive coast-down routine as employed such as is employed in this exemplary embodiment, there would be a large amount of uncertainty as to when the blade had actually stopped spinning.

Turning attention now to FIG. 6E, an exemplary trigger circuit along with portions of a fuse wire circuit are shown. It should be understood that the fuse wire circuit is a portion of an exemplary reaction mechanism in which the fuse wire is burned to release, for example, a brake to stop the blade, such as has been described above. In this circuit, an onboard boost regulator, controlled by the microcontroller, is used to charge high voltage capacitor C8 to a voltage at which it has sufficient stored energy potential to burn a fuse wire placed across electrode E1. The microcontroller is able to use SCR Q13 to discharge the electrical energy stored in capacitor C8 through the fuse wire. This surge of energy vaporizes the fuse wire across the electrodes, which in turn releases a force generating component or stored energy source such as a spring. In order to melt the fuse wire, the SCR conducts hundreds to thousands of amperes for a few tens of microseconds. To ensure that the SCR turns on fully and quickly it is desired to deliver in excess of 1 ampere of current quickly into the gate. This is done with transistors Q8 and Q9 which are configured as two independent current sources. This redundancy helps to prevent single-point failures. The GPIO outputs from the DSP that control triggering may be connected to Q8 and Q9 through a buffer/line driver component (not shown). The circuitry around Q8/Q9 is configured to prevent the SCR from triggering until the DSP has initialized and has asserted control over the buffer/line drive component. Use of two redundant control lines, buffers and transistors provides complete redundancy on the gate drive circuitry to minimize the chance of failure.

In order to confirm the functionality of the circuit, the DSP is configured to test the circuit upon initialization of the DSP. This test is performed using all the components of the trigger circuit, with the voltage on C8 at a low level, typically around 3V, so that there is insufficient current to overstress the fuse wire but enough current to permit verification that the trigger circuit is functional. High voltage capacitor C8 is charged up to typically around 3V by the action of the boost charger Q12/L6/C30/D5 circuit which is duty cycle controlled by the microcontroller to regulate the voltage on C8. A small amount of leakage current flows to ground through resistors R32 and R27, which are used by the microcontroller to provide feedback of the voltage appearing across C8. Once the capacitor C8 is charged, the SCR is triggered and the discharge waveform of C8 is tested to ensure the circuitry is performing properly.

Since capacitors can degrade over time, the control circuit is also configured to measure the capacitance of C8 to ensure it is functioning as intended. This can be accomplished without interfering with the ability of the capacitor to deliver sufficient current to melt the fuse wire, so it can be performed repeatedly throughout the life of the capacitor even while the circuit is in operation. With the capacitor charged to a target voltage, typically around 180V, a momentary load is applied to the capacitor and the resulting brief and slight change in voltage is monitored and the capacitance can be calculated from this voltage change. If this load is applied for a short period of time, typically 5 milliseconds or less, then there will only be a small percentage change of voltage on the capacitor C8, typically ½ to 1 percent, and so more than ample charge remains available in C8 to melt the fuse wire if called upon to do so. The load is provided by resistors R8/R9 and FET switch Q11, with a provision for measuring the discharge current by measuring the voltage across resistor R9. Complementary transistors pair Q10 as well as R31 are used as a level translator to ensure that FET Q11 has enough gate enhancement to turn on fully and quickly under the control of the microcontroller. The voltage change across C8 resulting from that load causes a corresponding change of voltage across sampling capacitor C4. Sampling both the current through resister R9 and the voltage across C4 provides a way to directly measure the capacitance of C8 and therefore ensure that the energy potential stored in C8 is capable of vaporizing the fuse wire. Various other methods are available for verifying the condition of the energy storage capacitor C8. Alternatively, it is possible to calculate the capacitance of C8 by monitoring the time it takes to charge up, or by monitoring the voltage characteristics with time during the low voltage discharge test. Also, by measuring the current and knowing the resistance in the discharge path it is possible to compute the voltage on C8, independently from divider R32/R27 thereby providing an independent and redundant measure of the capacitor voltage.

The discharge test resistor, R8, is a single 3 W 680 ohm leaded resistor placed in thermal contact with capacitor C8. One way of achieving such a thermal contact is to place R8 adjacent to C8 and apply a thermally conductive compound between them so that heat can be transferred from R8 to C8. Another way is to thermally couple R8 to C8 through traces and copper on the printed circuit board. With the described configuration, it is possible to heat C8 using R8 to bring C8 to a satisfactory operating temperature.

It is possible to configure the DSP to track the temperature of C8 via thermistor R30 and then trigger more frequent discharges through R8 to increase its heat output as necessary to bring C8 to minimum suitable operating temperature. In one implementation of this technique, the DSP tracks the temperature registered by R30. If the temperature is below a low threshold where sufficient energy delivery from C8 to burn the fuse wire cannot be guaranteed, the DSP triggers one or more discharges through R8, sufficient for instance for R8 to dissipate approximately 2 W and thereby rapidly heat C8. At a second threshold temperature, the DSP could trigger discharges through R8 sufficient to generate approximately 1 W of heat dissipation, which is sufficient to raise the temperature of the capacitor 10-20 degrees above the ambient temperature to increase the energy available for delivery to the fuse when the circuit is triggered.

An exemplary computer program that is one implementation of at least some of the processes discussed herein is included in U.S. Pat. No. 8,469,067, issued Jun. 25, 2013, and titled “Detection Systems for Power Equipment.” That program is most specifically written in assembly language to run on a Texas Instruments TMS320F2801PZA digital signal processor or on other similar processors. The entire disclosure of U.S. Pat. No. 8,469,067 is incorporated herein by reference.

Turning attention now to FIGS. 6F and 6G, components and circuitry depicting alternative exemplary portions of a control circuit are shown, including components of a user interface module, a motor control module, and a motor switch module.

Exemplary motor switch module, shown in FIG. 6F and indicated generally at 150, is controlled by the exemplary user interface components and exemplary motor control module, shown in FIG. 6G and indicated generally at 152. It should be understood that in the circuit diagrams depicted in FIGS. 6F and 6G, discrete resistors are represented by rectangular symbols rather than the zigzag symbols of FIGS. 6A-6E. In addition, the triangular symbols associated with labels beginning with an “I” are intended to represent input signals, either from or to, one or more processor components, or from one module to the other, as will be described in more detail below.

Motor switch module 150 is configured to conduct electrical power to a motor (not shown), from an incoming electrical power terminal 154 to an outgoing power terminal 156. Incoming power terminal 154 is typically connected to a source of electrical power such as an electrical outlet through a suitable power cord (not shown). Similarly, outgoing power terminal 156 is typically connected to the power terminals of a motor by a suitable power cord (not shown). Module 150 operates to selectively conduct or transfer electrical power from the power source to the motor depending on various conditions and inputs as will be described.

As shown in FIG. 6F, the neutral line from terminal 154 is directly connected to neutral line of terminal 156. In contrast, the active power or hot line from terminal 154 is connected to the hot line at terminal 156 through a mechanical power switch 158 and two normally OFF or open electrical relays 160 and 162. When switch 158, relay 160, and relay 162 are all closed, a circuit path will be created that allows electrical power to be transferred or conducted from terminal 154 to terminal 156 and thereby to the motor. In contrast, if any one or more of the switch or the relays is open, then electrical current cannot flow through the circuit to transfer power from terminal 154 to terminal 156.

In the exemplary embodiment, switch 158 is in the form of an electrical power switch that is manually operated by the user to supply or remove power to the circuit. When the switch is in the OFF or open position electrical power does not flow or transfer through the switch. When a user moves the switch to the ON or closed position, then electrical power can flow through the switch. Thus, a user has direct physical control over the transfer of electrical power to the motor since no electrical power can transfer to terminal 156 when a user places switch 158 in the OFF position. In some embodiments, switch 158 may also function as a ‘Main Power Switch’ such that it supplies electrical power to multiple or even all sections of the control circuit. In such embodiments, the user connects electrical power to turn ‘ON’ the control circuit by moving the Main Power Switch 158 to the ‘ON’ or closed position. As discussed above, switch 158 may be implemented in any of a variety of well-known forms such as rocker switches, pull-on buttons, knobs, trigger switches, etc. Alternatively, the switch may be any of the well-known electro-mechanical devices configured for selectively conducting electrical power such as magnetic contactor switches, etc.

When switch 158 is closed or in the ‘ON’ position, electrical power is connected to the input of relay 160. The output of relay 160 is connected to the input of relay 162, and the output of relay 162 is connected to the hot line of terminal 156. A capacitor C1, configured for arc-suppression, is connected across relay 160 to reduce electrical arcing when the relay opens or closes. Capacitor C1 is not sized or otherwise configured to transfer electrical power to relay 160. Thus, electrical power can only be conducted or transferred to terminal 156 when both relay 160 and relay 162 are closed.

In the exemplary embodiment of FIGS. 6F and 6G, both relay 160 and 162 are controlled, either directly or indirectly, by signals from one or more processors in the control circuit operating under software command. Relay 160 is configured as a Make/Break relay whose magnetic coil is actuated or controlled by two processor-controlled input signals which are indicated at 11 and 12. Input signal 11 is controlled by a first software-controlled processor while input signal 12 is controlled by a second software-controlled processor. As a result, both processors must agree on whether the relay should be closed to conduct electrical power. If either processor does not send the correct signal to close the relay, then the relay will either remain open or it will transition to open if currently closed. It will be appreciated that while the exemplary embodiment includes two independent processors to control relay 160, the relay can alternatively be controlled by a single processor, such as shown in FIG. 6A, or more than two processors.

Relay 162 is configured as a Fail Safe relay and is controlled by a single processor input signal which is indicated at 13. Alternatively, relay 162 could be controlled by two or more processors which are the same as, or different from, the processors controlling relay 160. The purpose of Fail Safe relay 162 is to provide a backup or redundant means for the processor to disconnect electrical power from the motor in the event that Make/Break relay 160 fails in a closed state. It is well known that the power contacts of relays can weld closed, for example due to electrical arcing, so that the relay is essentially always ON. In the event of such a failure of relay 160, the processor(s) would be unable to turn off the motor by signaling relay 160 to open. Therefore, relay 162 is provided as a redundant component to disconnect electrical power to terminal 156 and thereby stop the motor.

In the exemplary embodiment, relays 160 and 162 are operated so as to maximize the lifetime of the relays and to minimize the chances of welded contacts. Relay 162 is always closed first and opened last so that electrical current is typically not flowing when relay 162 opens and closes. This eliminates any electrical arcing on the contacts of relay 162. In contrast, relay 160 is always opened first and closed last which means that relay 160 is the relay which is actually switching electrical power on and off to the motor. Thus, any electrical arcing that occurs while turning the motor on and off will be isolated to relay 160. In some embodiments, the processors which control the operation of relay 160 may be configured to time the closing and opening of relay 160 so as to minimize arcing. This is accomplished by opening or closing relay 160 when the incoming AC power is at or near zero volts. In other words, the processors are configured to detect the zero-crossing point of the power and to open or close relay 160 at or near the zero-crossing point. In any event, if relay 160 does not open when the processor(s) send the signal to open, then electrical power will still be disconnected from the motor when relay 162 opens subsequently. The control of the Make/Break relay and the Fail Safe relay, including zero-crossing detection is described in more detail in U.S. Pat. No. 10,442,107, issued Oct. 15, 2019, the entire disclosure of which is incorporated herein by reference.

Focusing attention now on FIG. 6G, components of the exemplary user interface module and the motor control module are shown which are configured for receiving signals from a user input component and producing output signals for controlling relays 160 and 162 of FIG. 6F. In summary, the circuitry indicated at 152 includes three circuit subsections indicated generally at 164, 166 and 168. Subsection 164 includes circuitry configured to receive signals from a user input component, while subsection 166 includes circuitry configured to operate as a latch to prevent accidental restart of the motor after loss of electrical power to the power tool, such as caused by a power outage. Subsection 168 includes circuitry to produce outputs that are connected as the processor-controlled input signals to relays 160 and 162 shown in FIG. 6F. Each subsection is described in more detail below. It will be appreciated that the components and circuit configuration of FIG. 6G are just one exemplary embodiment for controlling the motor of a power tool and that many alternative assemblies of components and circuit configurations are possible within the scope of the present disclosure.

Circuit subsection 164 includes two Hall effect sensors H1 and H2 which are configured to detect the magnetic fields of two magnets when the magnets are in proximity to the hall effect sensors. In one exemplary embodiment, the user input component includes two magnets which change position when the user moves the input component between ON and OFF or Start and Stop positions. Thus, Hall effect sensors H1 and H2 are arranged to detect whether the input component is in the ON or OFF position based on the proximity of the magnets. When the input component is in the OFF position, the magnets are remote from the Hall effect sensors and the output of each sensor is set to a tri-state or high-impedance output. In contrast, when the input component is in the ON position the magnets are near the Hall effect sensors and therefore the output of each sensor is tied to ground. The exemplary embodiment uses dual magnets for redundancy and safety. Thus, as will be discussed, the mis-location of a single magnet or the failure of a single Hall effect sensor will not cause an unexpected start of the motor. Nevertheless, it will be understood that alternative embodiments may employ different numbers and combinations of magnets and sensors. It will also be appreciated that different sensors and circuitry may be employed to detect the position of the user input component, such as microswitches, inductive proximity switches, reed switches, angular sensors, etc.

The outputs of Hall effect sensors H1 and H2 are connected to voltage dividers formed by resistor network R1, R2, R3 and resistor network R4, R5, R6, respectively. The circuit nodes formed by R1-R2 and R4-R5 are connected as inputs to subsections 166 and 168. The circuit nodes formed by R2-R3 and R5-R6 are connected as inputs, indicated at 14 and 15, to one or more processors to signal the position of the user input component to the processors. The resistors in the resistor networks are configured so that, when the user input component is in the OFF position and thus the output of the hall effect sensors is high impedance, the voltage at nodes R1-R2 and R4-R5 is approximately 4-5V and the voltage at nodes R2-R3 and R5-R6 is approximately 2-3V or some other non-zero positive voltage suitable for input to the processors. In contrast, when the user input component is in the ON position and thus the output of the hall effect sensors is ground, the voltage at nodes R1-R2 and R4-R5 and also at nodes R2-R3 and R5-R6 is at or near ground. Thus subsection 164 is configured to sense the position of the user input component and signal that position to both subsections 166 and 168, as well as the one or more processors at inputs 14 and 15.

Circuit subsection 166 includes two transistors Q1 and Q2 connected as a thyristor type latch, the output of which drives transistor Q3 which acts as a switch to produce an input signal to energize subsection 168. Transistor Q4, along with the voltage divider network of R7 and R8, functions as a voltage comparator with the input to Q1. Processor input 16, along with resistors R9 and R10 provide software control to either enable the latch or to reset it. When input 16 is set to either tristate or high voltage, the base/emitter junctions of both Q1 and Q4 will be reversed or unbiased and both transistors will be off. Thus, the processor is able to reset the latch by turning off Q1. Alternatively, when 16 is set to ground, either Q1 or Q4 will begin conducting current depending on the relative voltages at the base of each transistor. Thus, the processor enables the latch by setting 16 to ground. However, while the processor is configured to enable, disable and reset the latch through 16, it does not cause the latch to operate in the latched condition since the processor does not affect the base voltage of either Q1 or Q4. Instead, the voltage at the base of Q4 is set by the system voltage and resistor network R7-R8, while the voltage at the base of Q1 is controlled by the outputs of hall effect sensors H1 and H2, as will be described below.

When 16 is set to ground and the voltage at the base of Q1 is lower than the voltage at the base of Q4, then current will flow through Q4 but not Q1. However, once the voltage at the base of Q1 rises above the voltage at the base of Q4, then Q1 will begin to conduct current through the voltage divider formed by resistors R11 and R12. When current flows through Q1, the base/emitter junction of Q2 will become forward biased and Q2 will also turn on and begin to conduct current. Since the collector of Q2 is connected to the base of Q1, the current flow through Q2 will continue to supply current to the base of Q1, latching the transistor pair Q1 and Q2 in the “on” state. When both Q1 and Q2 are conducting current, the current feedback path between Q1 and Q2 operates to keep the transistors operating in the “on” state. In this operating situation, the two transistors are considered to be latched or operating in a latched condition. The electrical latch formed by Q1 and Q2 will continue to operate in the latched condition until power is removed from the circuit or until the processor resets the latch by setting 16 to tristate or high. When 16 is set to tristate or high, current will stop flowing through Q1 which will cause Q2 to turn off, thereby resetting the latch or causing it to operate in the unlatched condition. The latch will not transition from unlatched to latched operation until some signal causes the voltage at the base of Q1 to raise above the voltage at the base of Q4. As shown in FIG. 6G, Hall effect sensors H1 and H2 are connected to provide such a signal.

The Hall effect sensors, which detect the position of the user input component, are connected to the base of Q1 through the dual resistor networks formed by R13, R14 and R15, R16. When the user input component is in the OFF position and the output of the Hall effect sensors is set to tristate, then the voltages at nodes R1-R2 and R4-R5 exceed the threshold set by the divider network R7-R8. The resistor networks R13, R14 and R15 and R16 are configured to charge capacitor C2 and cause the voltage at the base of Q1 to be higher than the voltage at the base of Q4. In the exemplary embodiment, capacitor C2 is configured to cause a slight delay in raising the voltage at the base of Q1. This ensures sufficient time for the Hall effect sensors to begin operating nominally when electrical power is initially applied to the control circuit.

If processor input 16 is set to ground when the user input component is in the OFF position, then 16 will enable the latch and Q1 will turn on once C2 charges to a voltage above the voltage at the base of Q4. Once Q1 turns on and begins to conduct current, Q2 will turn on and both Q1 and Q2 will latch as described above. Furthermore, once Q2 begins to conduct current, the collector of Q2 will maintain the voltage at the base of Q1 regardless of the outputs of the hall effect sensors. Thus, when the processor enables the latch and the user input component is set to OFF, the latch will begin operating in the latched condition and subsequent changes in the user input component or hall effect sensors will not directly affect operation of the latch.

In contrast, if the processor enables the latch when the user input component is in the ON position, then the hall effect sensors will detect the magnets and the outputs of the sensors will be set to ground. This causes the base of Q1 to be at ground thereby preventing it from turning on. As a result, the latch will operate in the unlatched condition. The latch will remain operating in the unlatched condition until the user input component is moved to the OFF position, at which point the voltage at the base of Q1 will rise and cause the latch to transition to the latched condition.

Thus, it will be seen that the operating condition and output of the latch will be determined by the combination and timing of the processor input signal 16 and the signals received from the user input component. The latch will not operate in the latched condition until both the processor enables the latch and the user input component is set to OFF. Only after these two events occur can the latch transition to the latched condition. Furthermore, the latch cannot transition to the latched condition solely under software command. While a software command by the processor can enable the latch at 16, the latch will transition from unlatched to latched only as a result of purely hardware inputs from the hall effect sensors. It will be appreciated that both Hall effect sensors must agree that the user input component is in the OFF position. If the output of either Hall effect sensor is at ground, indicating the proximity of a magnet and thereby signaling the user input component is in the ON position, then the base of Q1 will be held below the voltage at the base of Q4 and thereby prevent Q1 from turning on. As discussed above, a single magnet and sensor could alternatively be used if redundant sensors are not desired. Alternatively, dual sensors could be used to detect the position of a single magnet, in which case both sensors would have to agree before the latch could transition to latched operation.

The output of the latch is provided by transistor Q3 and is one of the inputs to control circuit subsection 168. When the latch is operating in the unlatched condition, current does not flow through either Q1 or Q2. As a result, the base of Q3 is essentially at 5V and base/emitter junction is not forward biased. In which case, current does not flow through Q3 so the voltage at the collector of Q3 is pulled to ground through resistor R17. Thus, when the latch is operating in the unlatched condition, the output of subsection 166 is a low or ground signal to subsection 168. In contrast, when the latch is operating in a latched condition, the voltage at the base of Q3 is pulled down and the base/emitter junction of Q3 becomes forward biased and Q3 turns on. Once Q3 is conducting current, the voltage at the collector of Q3 is pulled up. Thus, when the latch is operating in the latched condition, the output of subsection is a high signal of approximately 5V to subsection 168.

Focusing now on subsection 168 it will be seen that the output of subsection 168 is provided by the drain terminals of FET transistors Q5 and Q6, indicated at 12 and 13, respectively. When the gate inputs of either Q5 or Q6 is low or near ground, then the corresponding drain will be tristate or open circuit. In contrast, when the gate inputs of either Q5 or Q6 is high or above a turn-on threshold, then the corresponding transistor will begin to conduct and the drain will be pulled to ground. Referring briefly back to FIG. 6F, it will be seen that 12 and 13 are connected to the control coils of relays 160 and 162, respectively. In particular, 12 provides one of the signals to relay 160 needed to turn on the relay and allow current to flow. The other signal is provided by the processor input 11. Thus, both 11 and 12 must agree (i.e., signal high and low values, respectively) for the relay to turn on. In contrast, 13 provides sole control over relay 162 since the other coil terminal of the relay is tied to 5V. Thus, when 13 is low, the relay will close or turn on to allow current to flow. As discussed above, in the exemplary embodiment depicted in FIGS. 6F, relay 160 serves as the Make/Break relay while relay 162 serves as the Fail Safe relay. Therefore, 12 is considered the Make/Break relay enable signal while 13 is considered the Fail Safe relay control signal.

Focusing attention back on FIG. 6G, it will be seen that additional safety redundancy is provided by processor controlled signals. Specifically, transistor Q5 is also controlled by processor signal 17 and transistor Q6 is also controlled by processor signal 18. Turning first to transistor Q6, it will be seen that the gate terminal of Q6 can be pulled low by transistor Q7. When 18 is low or ground, then the base junction of Q7 is also low and Q7 does not turn on. As a result, Q6 will turn on if it is enabled by the high output of the latch. However, if 18 is high then the base junction of Q7 will be forward biased and the transistor will pull the gate of Q6 to ground. This will be true regardless of the output from the latch. Thus, when Q6 is enabled by the latch, processor signal 18 turns on Q6 when 18 is low and turns off Q6 when 18 is high. It will be appreciated that the output of the latch and 18 must agree for Q6 to turn on and, thereby, turn on Fail Safe relay 162. In other words, the operation of Fail Safe relay 162 is controlled both by processor signal 18 and the latch. And as discussed above, the latch is controlled in turn by processor signal 16 and signals from the user input component as detected by Hall effect sensors H1 and H2.

In summary, Fail Safe relay 162 can only turn or (or remain on) when the latch has first been enabled by 16 and then latched by positioning of the user input component to the OFF position. When this occurs, transistor Q6 is enabled, at which point processor signal 18 must turn on Q6 to pull 13 low and turn on relay 162. In the exemplary embodiment, the processor is configured to receive input signals 14 and 15, and to control signal 18 so as to only turn on Q6 when the user input component is in the ON position. Based on the description above, it will be understood that when power is first applied or restored to the control circuit, the user input component must first be placed in the OFF position so that the latch, once enabled, can transition to the latched condition. Once the latch is operating in the latched condition, Q6 is enabled. At this point, the user input component can be moved to the ON position and the processor signal 18 can turn on Q6, thereby turning on Fail Safe relay 162.

Turning now to Q5, it will be understood that the output from the latch operates to enable Q5 just as with Q6. Thus, the latch must be operating in the latched condition so as to provide enablement or enhancement voltage to the gate of Q5 before any control signal can cause Q5 to turn on. Similar to transistor Q6, transistor Q5 is under independent control of both hardware and software such that both or all signals must agree to turn on Q5. The software or processor signal is provided by 17, which operates similarly to processor signal 18. When 17 is low, the base junction of transistor Q8 will also be low and Q8 will not turn on. In this situation, Q8 will not affect the operation of Q9. However, when 17 is high or tristate, the base junction of transistor Q8 will be forward biased and Q8 will turn on. When Q8 is turned on and conducting current, the base junction of Q9 is forward biased and Q9 will turn on to pull the gate of Q5 to ground. Thus, when processor input 17 is high or tristate Q5 is turned off and the Make/Break relay is off.

As mentioned above, Q5 is controlled by hardware as well as the software which determines processor signal 17. The hardware control is provided by the user input component through hall effect sensors H1 and H2. The base junction of transistor Q10 is connected to the outputs of H1 and H2 through resistors R14 and R16, respectively. When the user input component is in the ON position and both H1 and H2 sense the magnets of the user input component, then the outputs of H1 and H2 are at ground and the base junction of Q10 is also at ground. Thus, Q10 will be off and Q11 will turn on to charge capacitor C3 to a positive voltage sufficient to turn off Q9 and allow Q5 to turn on. In contrast, if either H1 or H2 detects that the user input component is in the OFF position, then the output of that hall effect sensor will tristate and the 5V supply will turn on Q10 through resistor networks R1-R14 and/or R4-R16. If Q10 is on due to a detected OFF position of the user input by either hall effect sensor, the combined operation of Q10, Q12 and Q9 will prevent Q5 from turning on and thus prevent the Make/Break relay from closing. Additionally, once Q10 begins to conduct, any residual charge on C3 will cause Q12 to turn on and discharge C3 to turn on Q9 and further pull down the gate voltage of Q5. Thus, it will be seen that the hall effect sensors are configured to turn off Q5, and thereby the Make/Break relay 160, independent of any software control or command at processor signal 17.

In summary, when considering the Make/Break relay signal 12 from subsection 168, it will be seen that three conditions must be met to send a signal 12 that will enable the Make/Break relay to turn on. The first condition is that the latch must be operating in the latched condition so that the output from subsection 104 is a positive voltage that can enable the gate of Q5. The second condition is that processor signal 17 must be at ground or low to turn off Q8. The final condition is that both Hall effect sensors must detect the user input component to be in the ON position so that Q10 is turned off. If any of the three conditions just described are not met, then Q5 will be off and 12 will not enable the Make/Break relay. It will be further appreciated that this configuration of the circuitry indicated at 152 provides safe and redundant control over the motor since both the processor signals and the hardware signals must agree to start the motor. And since the hardware signals of the latch and hall effect sensors are enabled independently of any software command or control, a fault or defect in the software or processor will not cause the motor to start unexpectedly. Furthermore, if electrical power is unexpectedly removed from the control circuit and then restored, the hardware signals of the latch will not enable Q5 and Q6, and therefore will prevent relays 160 and 162 from turning on even if the user input component is in the ON position and the processor(s) are signaling to turn on the motor.

While the exemplary components and circuits shown in FIGS. 6F and 6G are one exemplary embodiment, it will be appreciated by those of skill in the art that similar safe and redundant control of the power tool motor can be implemented with a wide variety of alternative circuit components and configurations, and the present disclosure is not limited to the exemplary embodiment but includes all such alternatives. Additionally, examples of motor control circuitry and user input components configured to achieve these fail-safe features are described in additional detail in U.S. Provisional Patent Application Ser. No. 63/051,402, filed Jul. 14, 2020 and titled “Control Systems For Power Tools,” the entire disclosure of which is incorporated herein by reference.

Turning attention now to FIG. 7, an exemplary AIM-enabled table saw is shown in the context of a transportable jobsite saw, indicated generally at 200. Exemplary table saw 200 includes a support structure 202 in the form of a plastic housing, and a worksurface 204 in the form of a table constructed of die cast aluminum which is mounted to the housing. While most table saws include a worksurface mounted to a support structure, the construction of those components can vary depending on the type of table saw and its intended purpose. For example, a stationary table saw such as a cabinet saw may include a support structure in the form of a fully enclosed cabinet constructed of sheet metal which is configured to rest on the ground and have a height sufficient to place the table at a comfortable working height for a standing adult. Such a cabinet is typically relatively heavy and configured to support hundreds of pounds. Similarly, the table of a stationary table saw may be constructed of cast iron, granite, or some other material that is relatively heavy, stable, and durable. In contrast, a small compact table saw, sometimes intended to be carried by a single person, may include a relatively lightweight support structure that is constructed of an open framework of tubes or brackets with plastic shields or shrouds. Other types of table saws that are commonly known in the industry include benchtop saws, contractor saws, hybrid table saws, sliding table saws, and etc. Thus, while the exemplary table saw shown in FIG. 7 is in the form of a relatively small and transportable table saw that is commonly referred to in the industry as a jobsite saw, it will be understood that there are a wide variety of different types of table saws with different sizes, configurations, and features, and all such alternatives are within the scope of the present disclosure.

Table saw 200 includes a circular saw blade 206 supported by the support structure and aligned with a slot formed in a removable portion of the table known as the table insert 208. The table saw also includes one or more blade positioning controls 210 which are operable by a user or operator to adjust the elevation and/or tilt of the blade relative to the table. Table saw 200 also includes a user interface module 212 including a housing mounted to support structure 202. The interface module and housing, which are also referred to herein as a “switch box,” form a portion of a control circuit such as has been described above. The user interface module includes user input components including switches, and indicator components including LEDs, configured to enable an operator to monitor and control at least some of the functions and conditions of the table saw, including signaling the control circuit to start and stop the motor. The exemplary switch box, including the internal mechanical components, electronic components, circuits, and assemblies is described in more detail in U.S. Pat. No. 10,442,107, titled “Control Systems For Power Tools,” which has been incorporated herein above.

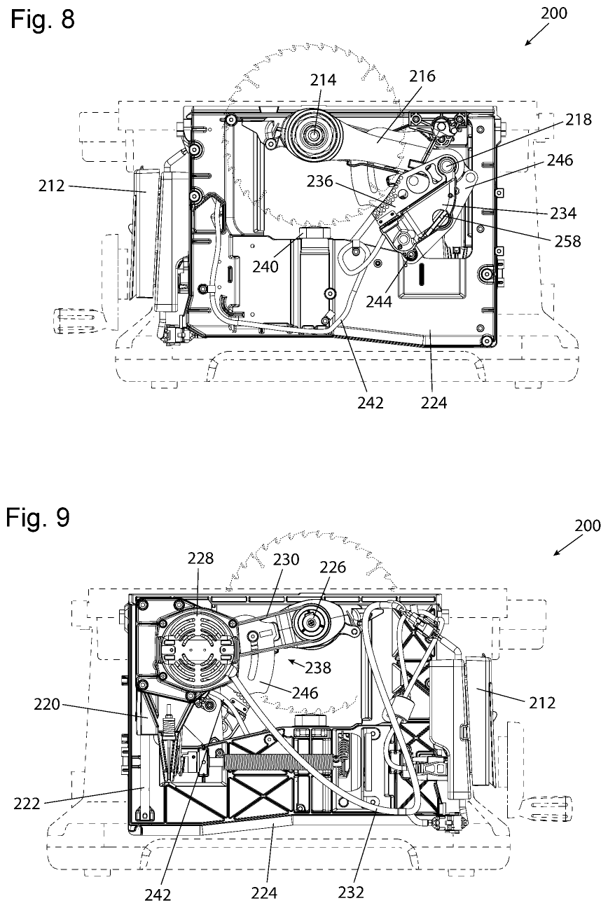

Turning attention now to FIGS. 8-9, the internal components of table saw 200 can be seen with the external components outlined in dash lines for context. The blade is mounted on an arbor 214 which is supported by a pivotable support arm 216 referred to herein as an arbor block. The arbor block is pivotally mounted on a pin 218 which is held in a carriage 220 which is configured to slide along an elevation shaft 222. The elevation shaft is mounted to a trunnion 224 mounted to tilt relative to the table. Both the tilt of trunnion 224 and the height of carriage 220 can be adjusted by an operator using blade positioning controls 210. It will be understood that when the trunnion is tilted and/or the elevation carriage is raised or lowered, the arbor block and blade are also tilted and/or raised and lowered relative the table.

A pulley 226 is mounted to the end of the arbor opposite the blade. A motor 228 is mounted to the elevation carriage near the pivot point of the arbor block. Although not shown, another pulley is mounted to the output shaft of the motor. The motor is coupled to drive the arbor by a belt 230 that passes over both pulleys. When the motor spins, the rotation of the motor is transmitted via the belt and pulleys to the arbor, and therefore the blade. When viewing the saw from the direction shown in FIG. 9, the pulleys, arbor and blade all spin in a clockwise direction.

Table saw 200 includes a control circuit which is distributed among several circuits and assemblies which are connected to communicate by electrical cables. As mentioned above, one portion of the control circuit is formed by switch box 212 which is connected to supply electrical power to the motor through a motor supply cable 232. In addition to the switch box, a portion of the control circuit is contained within a housing 234 which is also referred to herein as a brake cartridge. The brake cartridge contains portions of the control circuit as well as the reaction mechanism, which includes a brake pawl 236 configured to stop the rotation of the blade when the pawl contacts the blade. The brake cartridge includes a fuse wire assembly and a compression spring similar to the embodiment depicted in FIG. 5 and described above. The fuse wire is looped multiple times over the long end of a lever pin which pivots about a fulcrum formed in a support plate. The short end of the lever pin holds a link connected to the brake pawl. The multiple loops, and the offset placement of the lever pin on the fulcrum combine to provide sufficient mechanical advantage for the wire to restrain the force of the spring. The brake pawl is configured to pivot around pin 218, so that when the fuse wire is melted, the lever pin is released and the spring pushes the brake pawl into the teeth of the blade. Additional details and examples of brake cartridges can be found in U.S. Pat. No. 7,845,258 titled “Brake Cartridges for Power Equipment,” the entire disclosure of which is incorporated herein by reference. If the brake pawl stops the blade while the blade is spinning at a relatively high speed (which may be substantially less than the nominal operational speed), the sudden change in the rotational speed of the blade will cause a downward force on the arbor, and thus the arbor block. A latch mechanism, also referred to herein as a retraction mechanism and indicated generally at 238, is mounted to the trunnion and holds the arbor block during normal operation in the position shown in FIGS. 8-9. However, if the blade is suddenly stopped from a relatively high speed, the downward force on the arbor block will cause the retraction mechanism to release the arbor block allowing the arbor block to pivot downward about pin 218 until it hits a cushioning member, or bumper 240. Thus, when the reaction mechanism is triggered, it will react to cause the blade to stop moving and, depending on the momentum of the blade, retract completely below the blade.

Brake cartridge 234 contains various portions of the control circuit including the drive signal generator, the sense signal analyzer, the threshold detection module, the trigger circuit, and etc. The functions of these modules are performed by a programmable DSP along with additional circuitry connected to the DSP. The DSP contains software instructions stored within nonvolatile memory on the DSP, which control the functions described above. In addition, the DSP communicates with a second programmable processor which is housed in the switch box along with additional circuitry connected thereto. A communications cable 242, configured to transmit digital and/or analog signals, connects the brake cartridge to the switch box, and enables communication between these two portions of the control circuit. Some functions of the control circuit are performed by one or other of the processors, while other functions are performed by the two processors operating cooperatively.

In the exemplary embodiment, brake pawl 236 is formed of soft aluminum and includes several holes of various sizes and shapes through its profile. The holes serve dual purposes. First, the holes reduce the weight of the brake pawl allowing it to move more quickly into contact with the blade under the force of the spring. Second, the holes, along with the softness of the aluminum, allow the brake pawl to compress or crumple under the force of the blade, thereby reducing the impact force sustained by the various mechanical components of the saw. In addition, the brake pawl is sized to correspond to the size of the blade, as different sizes of brake pawls may be beneficial for different sizes of blades. In any event, since the brake pawl is deformed when the reaction mechanism is triggered, brake cartridge 234 is configured to be removable by an operator so that it can be replaced with a new brake cartridge.

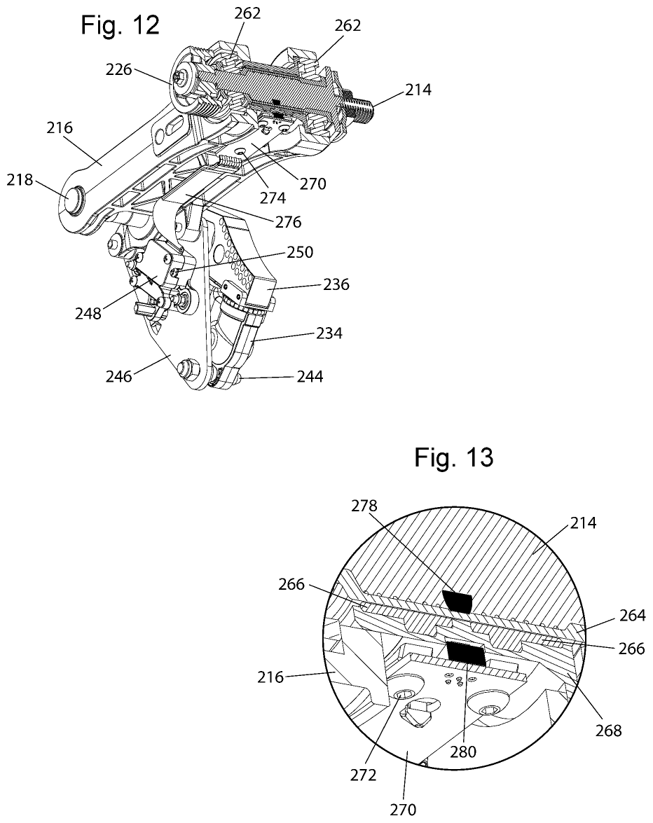

Brake cartridge 234 is mounted in table saw 200 on pivot pin 218 and a second or positioning pin 244. The cartridge is slid onto the pins until it rests against a bracket 246, also referred to herein as a cartridge bracket. Referring now to FIGS. 10-12 along with FIGS. 8-9, a housing 248 is mounted to the cartridge bracket on the opposite side from the brake cartridge. Although omitted from FIG. 12 for clarity, cartridge cable 242 runs from the switch box into housing 248 via a cable opening that is indicated at 250 in FIG. 12. The end of the cartridge cable that passes through opening 250 is terminated by a small pc board (not shown) contained in housing 248. The wires of the cable are electrically connected, via the pc board, to an electrical connector 252 mounted on the pc board. The electrical connector may be any suitable connector such as a d-sub connector, or etc. The small pc board in housing 248, on which connector 252 is mounted, is also referred to herein as the “d-sub board.”

Connector 252 is positioned in the housing so as to protrude from the housing into an opening 254 in cartridge bracket 246. A mating connector 256 in the side of the brake cartridge engages and connects to connector 252 when the side of the brake cartridge is in contact with the cartridge bracket as shown in FIG. 12. Thus, the brake cartridge and switch box are communicably connected by cartridge cable 242 and the d-sub board when the brake cartridge is installed on pins 218 and 244, and is resting against cartridge bracket 246. A cartridge key 258 may be installed by the operator so as to pass through an opening 260 in the cartridge, and when rotated, engage a portion of the cartridge bracket and/or housing 248 to secure or lock the cartridge in place. This prevents the brake cartridge from accidentally moving off the connector during operation, thereby disconnecting the brake cartridge and the switch box.

Focusing now on FIGS. 12-13, an exemplary electrical coupling between the control circuit and the arbor of table saw 200 is shown. Arbor 214 is rotatably held by arbor block 216 through two bearings 262 mounted in the arbor block. Although the arbor is constructed of steel, it is at least partially surrounded by an electrically non-conductive layer or sheath 264. In the exemplary embodiment, the sheath is formed on the arbor by over-molding a material such as bulk molding compound (also referred to as “BMC”), glass-filled polyetherimide (also referred to herein as “PEI”), or some other moldable compound which is electrically non-conductive. Thus, the arbor is electrically insulated from the bearings and the arbor block, which may be electrically grounded. In alternative embodiments, the insulation may be provided differently, such as by interposing a non-conductive material between the outer surfaces of the bearings and the arbor block. In any case, disposed around the middle of the arbor are two generally cylindrical electrodes 266 constructed of an electrically conductive material such as brass. These electrodes are spaced along the axis of the arbor and held within an electrically non-conductive sheath 268, also referred to herein as an “electrode shell.” The electrode shell is held by the arbor block so that the axes of the electrodes are approximately colinear with the axis of the arbor. The inner diameter of the electrodes is just slightly larger than the outer diameter of the over-mold layer 264 on the arbor so that there is a small gap between the insides of the electrodes and the outside of the over-mold layer. As a result, the arbor and over-mold layer can rotate in the arbor block without contacting the electrodes.

It will be appreciated that each electrode 266, when placed around arbor 214, creates a cylindrical capacitor where the electrode forms one plate of the capacitor and the arbor forms the other plate. Thus, each electrode is capacitively coupled to the arbor so that an AC signal driven on a first one of the electrodes will induce a corresponding AC signal on the arbor, and therefore the blade. Likewise, an AC signal on the arbor will induce a corresponding AC signal on the second one of the electrodes. Therefore, the first electrode may be considered a “drive electrode,” while the second electrode may be considered a “sense electrode.” While the exemplary electrodes are substantially identical, alternative embodiments may use electrodes with different sizes and/or shapes.

The electrodes are attached to conductive pads (not shown) on a pc board 270 by one or more screws 272, while the pc board is mounted to the arbor block by one or more screws 274. PC board 270 is also referred to as an “arbor board” or “arbor block board.” A ribbon cable 276 extends from housing 248 to pc board 270, though other types of cable may also be used. PC board 270 electrically connects electrodes 266 to cable 276, which is connected to d-sub connector 252 by the d-sub board in housing 248. Thus, it should be understood that the control circuit portion(s) within brake cartridge 234 and/or switch box 212 are electrically connected to electrodes 266. Thus, a capacitive electrical coupling is established between the control circuit and the arbor, and therefore the blade. As discussed above, the brake cartridge contains both the signal generator and signal analyzer modules of the control circuit. As a result, the control circuit portion contained in the brake cartridge is configured to detect accidental contact between a person and the blade by driving a detection signal onto the arbor and blade via the drive electrode, and then sensing the signal on the blade via the sense electrode. The control circuit then analyzes the sensed signal for changes indicative of a person contacting the blade.

The control circuit is also configured to determine whether the blade is moving by sensing rotation of the arbor. As best seen in FIG. 13, arbor 214 includes a permanent magnet 278 embedded in the arbor so that one surface of the magnet is approximately flush with the outer surface of the arbor. Thus, the magnet will travel in a circle or orbit around the axis of the arbor when the arbor rotates. A Hall effect sensor 280 is mounted on arbor board 270 and positioned just beyond the orbit of the magnet, so that the Hall effect sensor will detect the magnetic field of the magnet as it passes the sensor once during every revolution of the arbor.

The control circuit is connected to the Hall effect sensor by cable 276, as well as the connectors and pc boards on the arbor block and within housing 248. Thus, the control circuit is configured to receive output signals from the Hall effect sensor. The control circuit includes a rotation sense module configured to receive the signals from the Hall effect sensor and to determine when the blade is moving. As a result, the control circuit of table saw 200 is configured to trigger the reaction mechanism only if contact is detected while the blade is moving. Additional details of the exemplary table saw and control circuit shown in FIGS. 7-13 can be found in U.S. Pat. No. 10,092,968 titled “Table Saws” and U.S. Pat. No. 10,442,107 titled “Control Systems for Power Tools,” the entire disclosures of which are incorporated herein by reference.

It should be understood from the drawings depicted in FIGS. 7-13 and the description above, that the exemplary control circuit of table saw 200 is comprised of multiple components, assemblies, and circuits which are distributed in various locations around the power tool, and is interconnected to communicate and cooperate through electrical communications cables and connectors to monitor and control at least some of the functions and conditions of the power tool. While the particular components and circuits of the control circuit may be similar to those described and depicted above in reference to one or more of FIGS. 6A-6G, modifications and alternatives are also possible depending on the features and functions of the power tool. In addition, the control circuit may alternatively be distributed over fewer or more assemblies than shown in FIGS. 7-13.

As can also be seen, some of the components and assemblies of the control circuit are contained within housings, while other components and assemblies are not contained within a separate housing apart from table saw housing 202. Nevertheless, it will be appreciated that different combinations of housings or the omission of separate housings is also possible. In addition, while one assembly of the control circuit was described as contained within a removable housing (i.e., the brake cartridge), it should be understood that other assemblies of the control circuit can also be contained in removable housings, or all of the components of the control circuit may alternatively be mounted so as to make removal difficult or impossible without damage. Further, while the control circuit of exemplary power tool has been described as comprising two processor components along with additional components and circuitry, either a single processor or more than two processors could alternatively be used.

In addition to the many possible modifications to the control circuit of table saw 200 which are possible, the control circuit of table saw 200 may be implemented in alternative versions of power tool 200, or in different types of power tools. Furthermore, alternative reaction mechanisms may be used in the context of table saws such as table saw 200. Thus, it should be understood that any one or more of such alternatives and modifications may be implemented and/or combined in an AIM-enabled power tool within the scope of the disclosure.

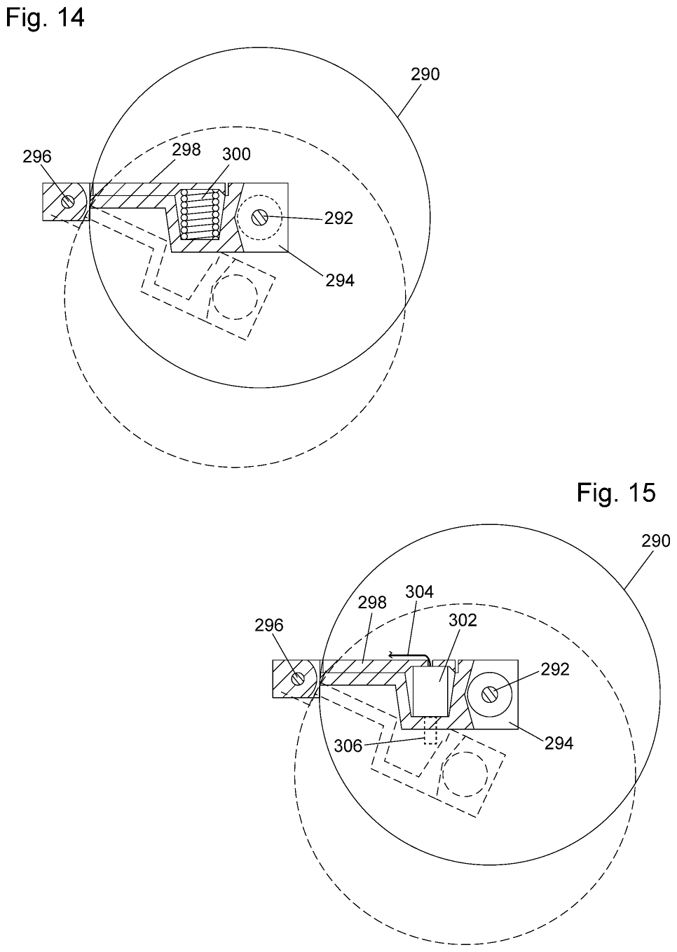

Turning attention now to FIGS. 14-15, two such alternative reaction mechanisms are shown which react to a dangerous condition by retracting the cutting tool away from its normal operating position. Focusing first on the exemplary embodiment shown in FIG. 14, a circular blade 290 is mounted on a rotatable arbor 292, which may be driven by a motor as described above. The arbor is held within an arbor block 294 that is pivotable about a pivot pin 296. A non-pivoting bracket 298 is disposed above the arbor block and mounted to a movable carriage (not shown) such as described above to allow an operator to raise, lower, and/or tilt the arbor block and blade. As a result, bracket 298 also raises, lowers, and/or tilts with the arbor block, thereby maintaining its position relative to the arbor block during normal operation. A force generating component in the form of at least one spring 300 is disposed between the bracket and the arbor block. The expansion of spring 300 is restrained by a restraining member or mechanism such as a fuse wire as described above.

When the control circuit detects contact between a person and blade 290 when the blade is moving, the trigger circuit of the control circuit melts the fuse wire which was restraining the spring. Since bracket 298 is configured so that it does not pivot, the stored energy of the compressed spring(s) is released by pushing down on the arbor block (as seen in the orientation of FIG. 14), thereby causing the arbor block to drop and retract the blade (as shown in dashed lines).

Preferably, the spring(s) are selected to generate sufficient force to move the arbor block quickly enough to mitigate serious injury. In some embodiments, the spring is selected to cause the arbor block to reach a maximum downward speed that is higher than the range of expected approach speeds at which a person might contact the blade. Furthermore, the spring is selected to cause the arbor block to reach this maximum downward speed within a few milliseconds after contact is detected.

Likewise, the fuse wire is selected and/or routed to have sufficient strength to restrain the spring until the fuse wire is melted. It should be understood that the blade, although still spinning, will stop cutting the person within just a few milliseconds, thereby mitigating any injury. Alternatively, a second reaction mechanism in the form of a brake may be triggered by the control circuit so that the blade both stops and retracts.

As mentioned above, reaction mechanisms with force generating components other than springs are also possible. As just one example, an alternative to the reaction mechanism of FIG. 14 is shown in FIG. 15. Similar to the embodiment of FIG. 14, the exemplary embodiment of FIG. 15 includes blade 290 mounted on rotatable arbor 292, which is held by an arbor block 294 that is pivotable around pin 296. A bracket 298 is positioned above the arbor block and is configured to not pivot with the arbor block. However, in place of one or more springs, the force generating component includes one or more pyrotechnic force generating components such as explosive piston actuator 302. Pyrotechnic actuators are well known and used in a wide variety of applications. Such actuators are available in many different configurations and force generating characteristics, including actuators that are triggered by electrical signals. Therefore, while one exemplary pyrotechnic actuator is depicted in FIG. 15, it should be understood that many different alternatives are possible, including multiple actuators, within the scope of the disclosure.

The base of exemplary actuator 302 is mounted to bracket 298 by any suitable mechanism such as a press-fit, one or more fasteners, or etc. A signal cable 304 extends from the actuator through an opening in the bracket. Signal cable 304 is connected to a trigger circuit (not shown) which is configured to supply the trigger signal required by the particular actuator. A piston 306 is normally recessed at least partially within the main body of the actuator. Upon triggering, the piston is forced downward (as viewed in the orientation of FIG. 15) against the arbor block, thereby causing the arbor block to drop and retract the blade (as shown in dashed lines). It should be noted that since the actuator does not generate any force until triggered, a restraining mechanism such as a fuse wire is not needed, though other mechanisms such as retraction mechanism 238 (shown in FIG. 9) may be used to hold the arbor block adjacent bracket 298 until the actuator is triggered.

As with the embodiment of FIG. 14 which employed a spring to retract the blade, the exemplary actuator of FIG. 15 is preferably selected, or combined with additional actuators, to produce sufficient force to cause the blade to retract with sufficient speed so as to mitigate injury. For example, the actuator may be selected to ensure that, within a few milliseconds, the arbor block and blade reach a maximum downward speed that exceeds the highest expected speed at which a portion of a person's body will approach the blade. This ensures the blade will stop cutting the person within just a few milliseconds after contact between the person and the blade is detected.

While pyrotechnic actuator 302 has been described in the context of a reaction mechanism configured to retract the blade, alternative uses of a pyrotechnic actuator in reaction mechanisms are possible within the scope of this disclosure. For example, a pyrotechnic actuator may be used to move a brake pawl into contact with the blade. Thus, a pyrotechnic actuator may replace the spring shown in the embodiment depicted in FIG. 5. Alternatively, since pyrotechnic actuators may have different force-generating characteristics (e.g., magnitude of force, ramp rate of force, duration of force, etc.) than springs or other force generating components, a pyrotechnic actuator may also be used in combination with one or more different types of force generating components in applications where a more complex force profile is desirable to achieve maximum, reliable performance. Therefore, it should be understood that all such alternatives and combinations are within the scope of the present disclosure. Furthermore, although additional exemplary power tools and reaction mechanisms may be described below with one or more springs as the force generating component, a suitable pyrotechnic actuator may be used in place of, or in combination with, such springs.

While exemplary AIM-enabled power tools in the form of table saws have been described above in some detail, other types of power tools may also be enabled with AIM technology using control circuits and reaction mechanisms such as described above. For some of these other power tools, the configurations of the control circuits and reaction mechanisms described above may be applied with relatively minimal modifications. For other power tools, alternatives and modifications to the control circuits and reaction mechanisms may be desirable to monitor and control the conditions and features of the power tool, as well as to mitigate injury from the power tool. To illustrate the diversity of AIM-enabled power tools, a few examples are discussed below.

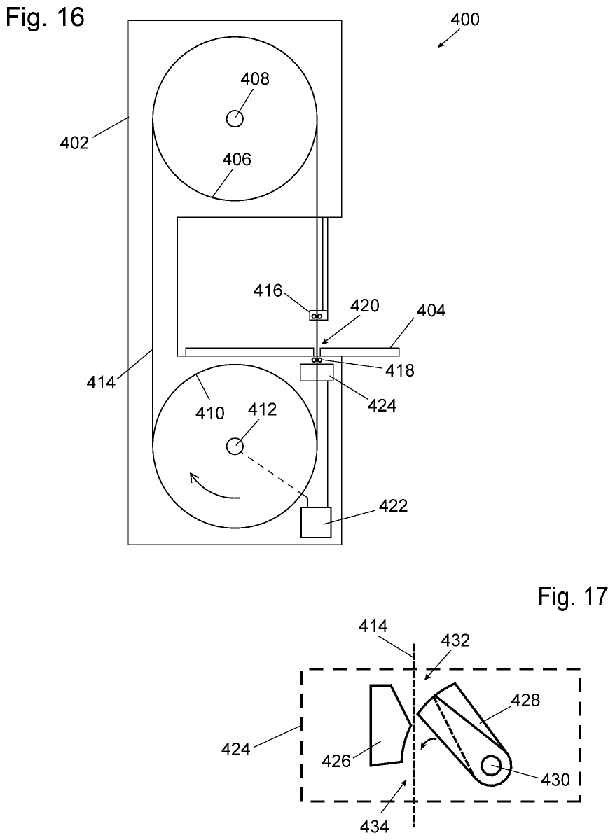

Turning attention to FIGS. 16-17, an AIM-enabled power tool in the context of a band saw is shown, indicated generally at 400. Exemplary band saw 400 includes a support structure in the form of a housing or cabinet 402 which may be constructed of one or more materials including metals or plastics, and which may incorporate one or more doors to allow an operator to access the interior of the cabinet. It should be understood that since FIG. 16 is a partially interior view, the front surface of cabinet 402 is removed to show the interior mechanisms of band saw 400. The height of cabinet 402 may vary depending on the size of the workpieces to be cut. Furthermore, some smaller band saws are designed to be placed on a benchtop, while larger band saws are designed to sit directly on the floor. Alternatively, the support structure may include a stand or base to support the cabinet above the floor.

Cabinet 402 supports a worksurface or table 404 upon which an operator can slide workpieces. In some embodiments, table 404 can tilt in at least one direction to allow workpieces to be tilted relative to the support structure. Band saw 400 includes an upper wheel 406 mounted on an upper arbor 408, and a lower wheel 410 mounted on a lower arbor 412. Both arbor 408 and arbor 412 are rotatably supported by the cabinet through bearings or similar mechanisms. A motor (not shown) is coupled to drive lower arbor 412 and, thereby, rotate the lower wheel in the direction shown by the arrow in FIG. 16. Alternatively, the motor may be coupled to drive the upper arbor or both arbors. Typically, band saws are powered by external power sources such as electrical line power, but other types of power sources are also possible, including internal sources such as batteries.

A cutting tool in the form of a band blade 414, with cutting teeth formed in one edge, runs over wheels 406 and 410. Thus, when the motor rotates the lower wheel, the band blade is driven in a clockwise loop (as seen in FIG. 16) around the lower wheel and up over the upper wheel, causing the upper wheel to also rotate. A pair of blade guides 416 and 418 guide the blade through a slot 420 in table 404. An operator can use band saw 400 to cut a workpiece by placing the workpiece on table 404 and sliding it into contact with the toothed edge of blade 414 as it moves around the wheels and through slot 420.

Exemplary band saw 400 also includes a control circuit 422 configured to monitor and/or control one or more conditions and/or functions of the band saw. The control circuit includes a user interface (not shown) which is configured to enable the operator to monitor and/or control some conditions and/or functions of the band saw such as starting and stopping the motor. While control circuit 422 is depicted in FIG. 16 as a single assembly, it should be appreciated that the various components and modules of the control circuit may be contained in multiple assemblies distributed over various locations in band saw 400.

Control circuit 422 is configured to detect if a person contacts the blade while the blade is moving, and if such contact is detected, to trigger a reaction mechanism 424 to mitigate injury. The control circuit includes an electrical coupling to lower arbor 412, configured to transmit drive and sense signals to and from the arbor. The lower arbor is electrically isolated from the cabinet by an insulating layer over-molded on the arbor. The lower wheel is constructed of an electrically conductive material such as metal so that signals coupled onto the lower arbor are coupled to the blade by the lower wheel. In some embodiments, the lower wheel may include a layer of material around its outer diameter to increase friction between the wheel and the blade. This layer of material, which is sometimes referred to as a “tire,” may be electrically insulating, conductive, or partially conductive. However, even where the tire is electrically insulating, it is sufficiently thin so that the blade will be at least capacitively coupled to the wheel. In any event, exemplary control circuit 422 is electrically coupled to blade 414. The blade may be electrically insulated from upper wheel 406, or the upper wheel may be electrically insulated from the cabinet, or the upper wheel may be constructed of electrically insulating material. In addition, blade guides 416 and 418 are configured to maintain the electrical insulation of the blade from the cabinet and table, such as by insulating mounts between the blade guides and the support structure.

It should be understood that alternative couplings between control circuit 422 and blade 414 are also possible within the scope of this disclosure. For example, the control circuit may be coupled to upper arbor 408 instead of, or in addition to, lower arbor 412. As a further alternative, the control circuit may be coupled directly to blade 414, such as by capacitive plates positioned parallel to, and closely-spaced from the blade. Regardless of the particular coupling and insulation mechanisms employed, the control circuit is coupled to drive a detection signal onto the blade and to sense the signal on the blade for changes indicative of contact between a person and the blade.

Control circuit 422 is also configured to determine if the blade is moving. As discussed above and in the incorporated references, various mechanisms may be used to determine blade movement within the scope of the disclosure. In the exemplary embodiment of FIG. 16, the control circuit includes a Hall effect sensor (not shown) positioned to sense a magnet (not shown) embedded in the arbor. The configuration and arrangement of the Hall effect sensor and magnet is similar to that of the exemplary embodiments described above. Nevertheless, alternative arrangements are also possible, including multiple magnets and/or multiple sensors. Furthermore, the magnet(s) and sensor(s) may be placed in the upper arbor or in one or more of the wheels. In any event, if control circuit 422 detects contact between a person and the blade when the control circuit determines the blade is moving at a speed higher than a selected threshold, the control circuit is configured to trigger reaction mechanism 424.

Various reaction mechanisms configured for use on band saws have been described in U.S. Pat. No. 9,927,796 titled “Band Saw With Improved Safety System,” the entire disclosure of which is incorporated herein by reference. Any of these reaction mechanisms, including modifications thereto, may be employed to mitigate injury in the event of dangerous contact between a person and the blade of a band saw. In the exemplary embodiment of FIG. 16, reaction mechanism 424 is configured to mitigate injury by cutting and stopping blade 414. As shown schematically in FIG. 17, reaction mechanism 424 includes a first cutting component 426 and a second cutting component 428. The first cutting component is fixedly supported on one side of the blade, while the second cutting component is pivotably mounted on a pin 430 on the opposite side of the blade. The cutting components are supported so as to be closely spaced from the blade during normal operation. In alternative embodiments, both cutting components may pivot.

While the force generating component and restraining mechanism are omitted from FIG. 17 for clarity, it should be understood that the reaction mechanism includes one or more suitable restraining mechanisms and force generating components such as have been described above. For example, a spring may be positioned to pivot second cutting component 428 in a counter-clockwise direction (as viewed in FIG. 17) when the control circuit triggers the reaction mechanism by melting a fuse wire configured to restrain the cutting component and/or spring. Alternatively, other mechanisms, such as have been described herein, may be employed for either one or both of the force generating component and the restraining mechanism.

Once the control circuit triggers the reaction mechanism, second cutting component 428 is pivoted into contact with the side of blade 414, which is moving downward as viewed in FIG. 17. As the leading edge of the second cutting component pivots into the blade, the blade is moved over into contact with first cutting component 426 so that the blade becomes pinched between the two cutting components.

Furthermore, the downward movement of the blade tends to pull the second cutting component even further in a counter-clockwise direction, thereby increasing the pinching force on the blade.

In the exemplary embodiment, the cutting edges of the two cutting components are constructed of a material which is harder than the material of the blade. Many band saw blades are constructed of steel, so cutting components with cutting edges of tungsten carbide may be used. However, other materials for the blades and/or cutting edges are also possible. Since the cutting edges of the cutting components are harder than the blade, the cutting edges begin to cut into the sides of the blade as the second cutting component continues to pivot. Although the exemplary control circuit is configured to disconnect electrical power to the motor when dangerous contact is detected, the momentum of the spinning wheels will continue to drive the blade until the cutting components cut completely through the blade, thereby releasing the tension in the blade so that it can slip over the spinning wheels. Once the blade is no longer being driven by the wheels, the second cutting component will bind up against the first cutting component, with the upper portion 432 of the now severed blade pinched and held between the two cutting components. The portion of the blade above the table will come to a complete stop, while the lower portion 434 of the blade will fall into the bottom of cabinet 402. Thus, the reaction mechanism is configured to both cut and stop the blade within just a few milliseconds after being triggered by the control circuit. However, as discussed above, alternative reaction mechanisms are possible which take different actions to mitigate injury, including stopping the blade without cutting it.

In the exemplary embodiment where the reaction mechanism includes a single-use component such as a fuse wire, the reaction mechanism may be contained in a replaceable housing or cartridge which the operator can easily remove once the reaction mechanism has been triggered. In such embodiments, either all the components of the reaction mechanism may be contained in the removable housing, or just those components which are not configured for multiple uses. Furthermore, portions of control circuit 422 may be contained in the removable housing, as was the case with the brake cartridge described above in reference to the jobsite table saw. Alternative reaction mechanisms may be configured such that all the components are suitable for multiple uses, in which case, replacement is not necessary after each trigger event.

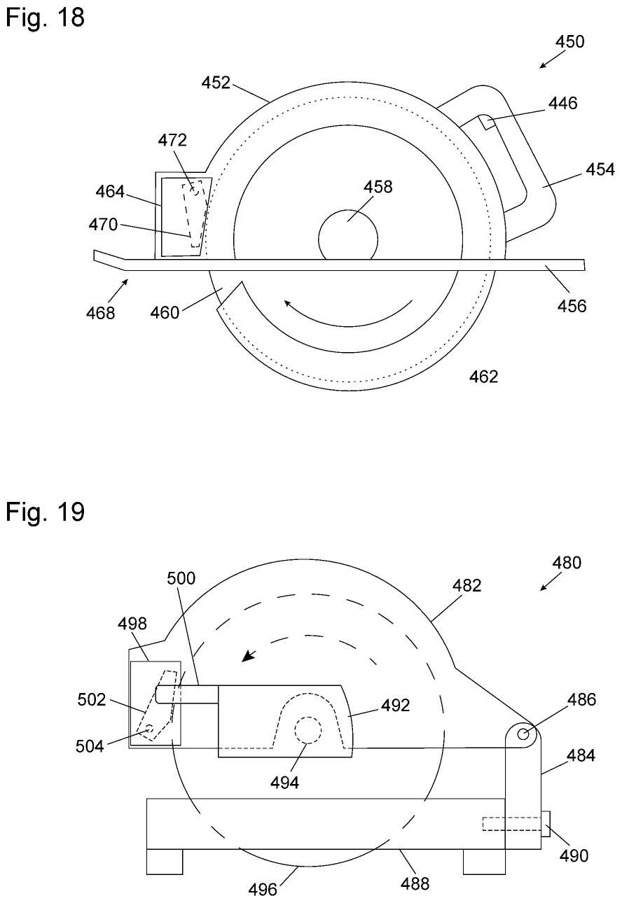

Turning attention now to FIG. 18, an AIM-enabled power tool in the context of a hand-held circular saw is shown, indicated generally at 450. The exemplary hand-held circular saw includes a support structure in the form of a housing 452 with a handle 454 configured to by gripped by an operator. A worksurface or guide plate 456 is mounted to the housing and may optionally be pivotable relative to the housing. A motor (not shown) with a rotatable arbor or output shaft 458 is mounted to the housing so that a cutting tool in the form of a circular saw blade 460 can be mounted onto the arbor and spun by the motor, as indicated by the arrow in FIG. 18. Typically, though not necessarily, circular saw blades for use on hand-held circular saws have a smaller diameter than those commonly used on table saws.

While exemplary hand-held circular saw 450 is shown with the motor generally perpendicular to the plane of the blade (a configuration commonly known in the field as a “side-winder” design), other configurations are also possible, such as a configuration with the body of the motor generally parallel to the plane of the blade (a configuration commonly known in the field as a “worm-drive” design). The support structure also includes a retractable guard 462 which substantially encloses the portion of the blade below guide plate 456. Electrical power to the saw is typically provided by an external power source such as line power, and/or an internal source such as a battery.

At least a portion of the control circuit of hand-held circular saw 450 is contained within a replaceable housing 464. The control circuit is configured to connect and disconnect electrical power to the motor. A user input component in the form of a trigger switch 466 in handle 454 enables an operator to send input signals to the control circuit to start and stop the motor. A user operates saw 450 to cut a workpiece by placing the bottom left surface portion 468 of guide plate 456 on the workpiece, starting the motor, and then sliding the bottom surface of the guide plate along the workpiece until the blade contacts the workpiece and begins to cut. As the operator continues to slide the guide plate over the workpiece, guard 462 will retract out of the way to allow the workpiece to pass along the guide plate.

The control circuit of saw 450 is configured to detect contact between a person and blade 460 when the blade is moving, and then to stop the blade from spinning to mitigate injury. The control circuit is electrically coupled to the blade, either through a coupling to arbor 458 or directly to the blade. The control circuit is configured to transmit, via the coupling, a drive signal onto the blade and then monitor a sense signal from the blade for changes indicative of contact between a person and the blade. The arbor may be electrically insulated from the support structure with a plastic over-mold layer or other mechanism such as described herein. The control circuit is also configured to determine when the blade is moving, such as by a Hall effect sensor positioned to detect the rotation of a magnet embedded in arbor 458. Alternatively, the control circuit may be coupled to detect rotation and/or contact through different mechanisms within the scope of this disclosure.

Replaceable housing 464 also includes a reaction mechanism in the form of a brake pawl 470, which is mounted to pivot about a pin 472. Although omitted for clarity, the reaction mechanism also includes a force generating component such as a spring, and a restraining mechanism such as a fuse wire. The control circuit is configured to trigger the reaction mechanism by melting the fuse wire, causing the spring to push the brake pawl into contact with the teeth of the blade and stop the rotation of the blade. However, it should be understood that the other restraining mechanisms and/or force generating components which have been described above, as well as modifications thereto, may alternatively be used.

Another exemplary AIM-enabled power tool is shown in FIG. 19 in the context of a miter saw, indicated generally at 480. The exemplary miter saw includes a support structure in the form of a housing 482 which is pivotably mounted to a support arm 484 by a pivot connector 486. The support arm is also pivotably mounted to a base or stand 488 by a pivot connector 490. The axis of pivot connector 486 is generally perpendicular to the axis of pivot connector 490 so that housing 482 is configured to pivot in two directions relative to the base. In some common embodiments, housing 482 can also pivot about a third pivot connection (not shown) whose pivot axis is perpendicular to the axes of both connector 486 and connector 490.

Miter saw 480 also includes a motor 492 mounted to housing 482. The motor includes a rotatable output shaft or arbor 494, on which a cutting tool in the form of a circular saw blade 496 is mounted. Blades designed for use on miter saws are commonly 10 inches or 12 inches in diameter, though both larger and smaller sizes are also used. Motor 492 is coupled to spin the blade in the direction indicated by the dashed arrow in FIG. 19. Electrical power to the miter saw may be provided by an external power source and/or an internal source such as a battery.

As with the hand-held circular saw discussed above, at least a portion of the control circuit of miter saw 480 is contained within the replaceable housing 498. The control circuit includes a user input component in the form of a trigger switch (not shown) which is built into a handle 500 attached to the housing. The handle is gripable by an operator to pivot the housing. An operator uses miter saw 480 to cut a workpiece but pivoting the housing upward away from base 488, placing the workpiece on the base, depressing the trigger switch to start the motor, and then pivoting the housing downward until the spinning blade contacts the workpiece.

The control circuit of exemplary miter saw 480 is also configured to detect if a person contacts the blade while the blade is spinning, and to stop the blade to mitigate injury. The control circuit is electrically coupled to the blade, either through a coupling to arbor 494 or directly to the blade. The control circuit is configured to transmit, via the coupling, a drive signal onto the blade and then monitor a sense signal from the blade for changes indicative of contact between a person and the blade. The arbor may be electrically insulated from the support structure with a plastic over-mold layer or other mechanism such as described herein. The control circuit is also configured to determine when the blade is moving, such as by a Hall effect sensor positioned to detect the movement of a magnet embedded in arbor 494. Alternatively, the control circuit may be coupled to detect rotation and/or contact through different mechanisms within the scope of the disclosure.

Replaceable housing 498 also includes a reaction mechanism in the form of a brake pawl 502, which is mounted to pivot about a pin 504. Although omitted for clarity, the reaction mechanism also includes a force generating component such as a spring, and a restraining mechanism such as a fuse wire. The control circuit is configured to trigger the reaction mechanism by melting the fuse wire, causing the spring to push the brake pawl into contact with the teeth of the blade and stop the rotation of the blade. However, it should be understood that the other restraining mechanisms and/or force generating components which have been described above, as well as modifications thereto, may alternatively be used. Furthermore, alternative reaction mechanisms may be used to either stop the blade, and/or retract the blade away from the area of contact. Examples of such alternative reaction mechanisms are described in more detail in the references incorporated above, as well as in U.S. Pat. No. 7,698,976, titled “Miter Saw With Improved Safety System,” U.S. Pat. No. 6,880,440, titled “Miter Saw With Improved Safety System,” U.S. Pat. No. 6,826,988, titled “Miter Saw With Improved Safety System,” U.S. Pat. No. 6,945,148, titled “Miter Saw With Improved Safety System,” and U.S. Pat. No. 6,877,410, titled “Miter Saw With Improved Safety System,” the entire disclosures of which are incorporated herein by reference.

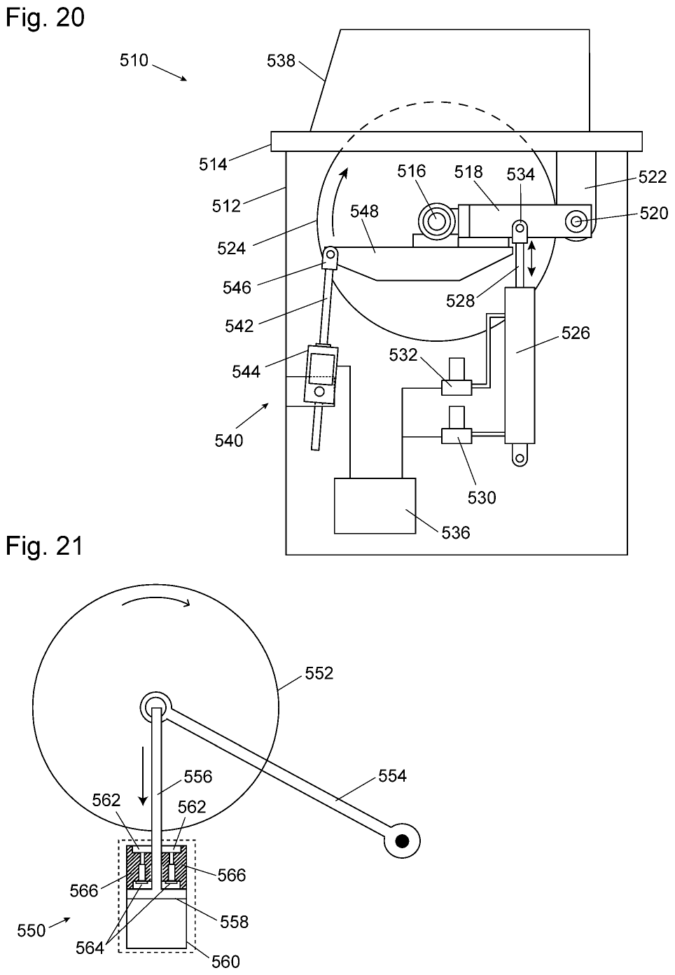

Turning attention now to FIG. 20, an AIM-enabled pneumatic upcut saw is shown, indicated generally at 510. The exemplary upcut saw includes a support structure in the form of a housing or cabinet 512, which supports a worksurface or table 514. Saw 510 also includes a motor (not shown) coupled to drive a rotatable arbor 516 mounted in a pivotable support arm or arbor block 518. The arbor block is mounted on a pivot connector or pin 520 held by a portion 522 of the support structure. A circular saw blade 524 is mounted on arbor 516 so as to spin in the direction shown by the arrow in FIG. 20 when the motor rotates the arbor. Blades with a variety of sizes can be used on saw 510, including relatively large diameter blades of 18 inches or more.

The exemplary upcut saw also includes a pneumatic cylinder 526 having a movable piston rod 528 that moves in and out of the cylinder along the axis of the cylinder. A pair of pneumatic valves 530 and 532 allow compressed air to enter and exit the cylinder, thereby driving the movement of the piston rod. The end of the piston rod outside the cylinder is attached to the arbor block by a pivot connector 534 or other suitable attachment mechanism. As a result, when the piston rod is driven up out of the cylinder, the arbor block and blade are pivoted upward so that a portion of the blade extends above table 514. Conversely, when the piston rod is driven down into the cylinder, the arbor block and blade are pivoted downward until the blade is completely below the table.

Upcut saw 510 also includes a control circuit 536 connected to control valves 530 and 532, as well as the motor. The control circuit includes a user interface module (not shown) which is configured to enable an operator to send signals to the control circuit to start and stop the motor, and to raise and lower the blade. An operator uses the upcut saw to cut workpieces by lifting a movable guard 538 and placing the workpiece on table 514. The operator then lowers the guard and starts the motor. Finally, the operator signals for the spinning blade to be raised. The control circuit controls valves 530 and 532 to raise the blade up through the table and workpiece, and then lower the blade back below the table. At which point, the operator raises the guard and removes the workpiece portions.

Control circuit 536 is configured to detect if a person contacts the blade while it is above the table, and to retract the blade below the table to mitigate injury. A common injury scenario with upcut saws involves an operator positioning the workpiece on the table and then accidentally cycling the blade upward before they have removed their hand. In any case, the control circuit is electrically coupled to the blade, either through a coupling to arbor 516 or directly to the blade. The control circuit is configured to transmit, via the coupling, a drive signal onto the blade and then monitor a sense signal from the blade for changes indicative of contact between a person and the blade. The arbor may be electrically insulated from the support structure with a plastic over-mold layer or other mechanism such as described herein. In some embodiments, the control circuit is configured to react to a dangerous contact by controlling valves 530 and 532 to quickly retract the blade below the table. In such embodiment, the reaction mechanism can be seen as including the pneumatic valves and the pneumatic cylinder. The size and capacity of the valves may be selected to retract the blade below the table as quickly as possible.

In other embodiments, such as the exemplary embodiment of FIG. 20, an additional reaction mechanism, indicated generally at 540, is used to enhance the injury mitigation. Reaction mechanism 540 includes a shaft 542 which is slidably received in a brake mechanism 544. The upper end 546 of the shaft is pivotally coupled to one end of an extension bracket 548. The other end of the extension bracket is attached to arbor block 518. During normal operation, shaft 542 slides back and forth through brake mechanism 544 as the arbor block is pivoted up and down by the pneumatic cylinder. However, the brake mechanism is configured to grip and stop the upward movement of the shaft within just a few milliseconds after the brake mechanism is triggered.

Therefore, control circuit 536 is connected to reaction mechanism 540 to trigger the brake mechanism if contact is detected between a person and the blade. Thus, for embodiments of saw 510 where the pneumatic actuator is not capable of stopping upward movement of the blade as quickly as desired to mitigate injury, the addition of reaction mechanism 540 allows the control circuit to quickly stop further upward movement of the blade until the operation of the pneumatic cylinder can be reversed to retract the blade. Since the blade is not stopped from spinning, it is important to stop further upward movement of the blade to mitigate injury as quickly as possible. Preferably, shaft 542 is connected to bracket 548 at a distance from pivot connector 520 greater than pivot connector 534, thereby giving the stopping force applied by the reaction mechanism a mechanical advantage over the force applied to the arbor block by the cylinder.

In alternative embodiments, the control circuit may also be electrically coupled to guard 538 or other structures surrounding the opening in the table through which the blade rises. In such embodiments, the control circuit is configured to detect if a person contacts the guard or other structures. If such contact is detected, the control circuit is configured to control valves 530 and 532 to lower the blade and/or not to raise the blade even if the operator signals the control circuit to begin a cut cycle. This illustrates an embodiment where the control circuit is configured to detect dangerous proximity by a person to the blade rather than actual contact. Exemplary AIM-enabled upcut saws, as well as brake mechanisms, are described in more detail in U.S. Pat. No. 6,957,601, titled “Translation Stop For Use In Power Equipment,” the entire disclosure of which is incorporated herein by reference.

FIG. 21 shows an alternative reaction mechanism, indicated generally at 550, which is configured to quickly retract a cutting tool. In the embodiment, a cutting tool 552 is mounted on a pivotable support arm 554. It should be understood that such a configuration may be used in a variety of power tools including table saws, miter saws, upcut saws, jointers, and etc. Furthermore, alternative configurations for mounting the cutting tool, such as are described herein and in the incorporated references, are also within the scope of the disclosure.

In any event, reaction mechanism 550 includes a piston arm 556, one end of which is coupled to support arm 554. Thus, when piston arm 556 is pulled downward (as seen in the orientation of FIG. 21), the cutting tool will be retracted. The end of piston arm 556 opposite the support arm is formed as a piston 558 inside of a pneumatic cylinder 560. The piston is driven downward under the force of high pressure air (or other suitable fluid) which is supplied to the cylinder through two channels 562. Under normal operation, the channels are closed by two smaller pistons 564, which are held in the closed position (shown in FIG. 21) by electromagnets 566. When the electromagnets are triggered to release, the compressed air which is contained within the channels by the smaller pistons, is released into the larger chamber of the cylinder. When the air is released into the cylinder chamber, the larger surface area of piston 558 allows the compressed air to apply much more force than was restrained by the smaller pistons. As a result, a large force is generated against piston 558, driving it downward and retracting the blade.

It will be understood that control circuits such as described herein may be connected to reaction mechanism 550 and configured to control and/or trigger the electromagnets. Thus, a control circuit configured to detect dangerous contact between a person and cutting tool 552 may also be configured to trigger reaction mechanism 550 to mitigate injury. Additional details and embodiments are described more fully in U.S. Pat. No. 10,384,281, titled “Actuators for Power Tool Safety Systems,” the entire disclosure of which is incorporated herein by reference.

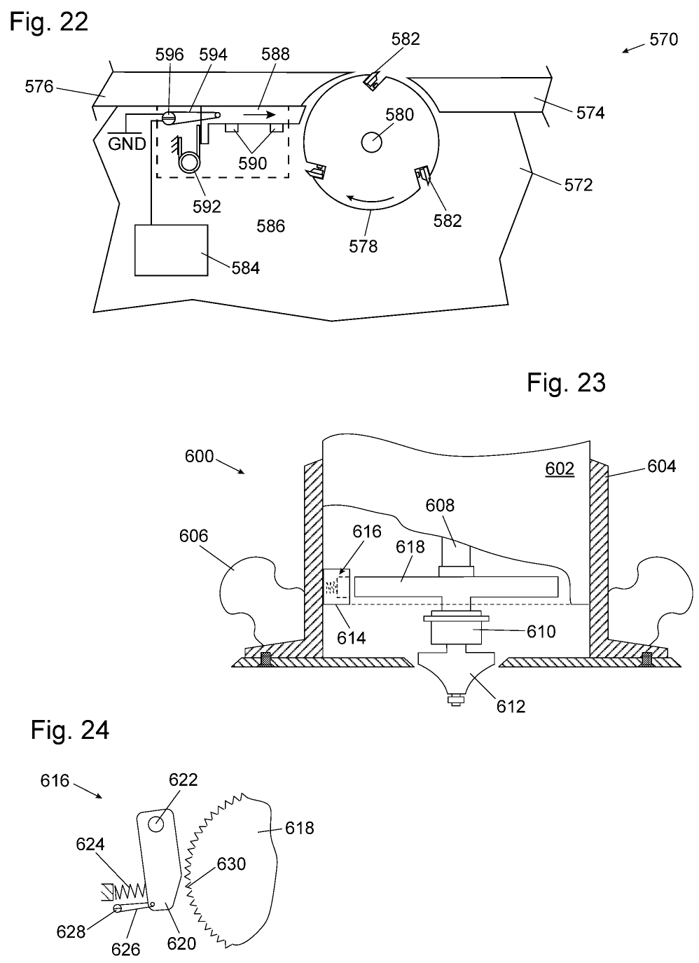

Focusing now on FIG. 22, an AIM-enabled power tool in the form of a jointer is shown, indicated generally at 570. The exemplary jointer includes a support structure in the form of a housing or cabinet 572 which supports a first worksurface or table 574 and a second worksurface or table 576. Jointer 570 also includes a cutting tool in the form of a cylindrical cutter head 578 mounted on a rotatable spindle or arbor 580. In some embodiments, arbor 580 is formed as an integral part of cutter head 578. The jointer also includes a motor (not shown) which is coupled to drive the arbor and, therefore, spin the cutter head in the direction shown by the arrow in FIG. 22. One or more cutting edges or knives 582 are mounted on the cutter head so as to protrude slightly beyond the outer surface of the cutter head. The knives may be mounted in a variety of positions on the cutter head including in straight lines parallel to the axis of the arbor, or in helical arcs about the axis of the arbor. Furthermore, the knives may be elongate to extend over a substantial portion of the entire axial length of the cutter head, or the knives may be relatively short and positioned in rows that extend along a substantial portion of the length of the cutter head. These various configurations of jointer cutter heads and corresponding knives are well-known to those of skill in the art.

Jointer 570 also includes a control circuit 584 coupled to control the transmission of electrical power to the motor from at least one of an external or internal power source. The control circuit also includes a user interface module (not shown) configured to receive inputs from an operator to start and stop the motor. The relative heights of table 574, table 576 and cutter head 578 are adjustable by an operator to set a desired cutting depth. For example, an operator may adjust the height of table 576 and/or cutter head 578 so that the top surface of table 576 is flush with the highest point reached by a knife 582 as the cutter head spins. The operator could then set the height of table 574 to a distance below table 576 that is equal to the desired depth of cut. The operator would then make the cut by starting the motor, placing a workpiece on table 574, and sliding the workpiece over the cutter head and onto table 576, thereby removing a thickness of material from the workpiece equal to the depth of cut that was selected. It will be understood by those of skill in the art that jointers are often used to form a generally smooth, planar surface on a workpiece.

Control circuit 584 is electrically coupled to arbor 580 and/or cutter head 578 to detect contact between a person and the cutter head or knives. As discussed in reference to other types of power tools above, the control circuit transmits a drive signal onto the cutter head and monitors the signal for changes indicative of contact by a person. The cutter head and knives are constructed of electrically conductive materials such as metal, so signals coupled onto the cutter head are also coupled to the knives. Exemplary control circuit 584 is also configured to determine whether the cutter head is moving, such as by sensing a magnet in the arbor or cutter head as described above.

Jointer 570 also includes a reaction mechanism 586 configured to stop the rotation of cutter head 578. The reaction mechanism includes a brake component 588 configured to slide between one or more guide blocks 590 and the underside of one of the tables. The reaction mechanism also includes a force generating mechanism such as torsion spring 592 which is restrained by a restraining mechanism such as fuse wire 594. Spring 592 is configured to push brake component 588 into contact with the cutter head once the fuse wire has been melted. The fuse wire is looped over an electrode assembly 596 where one electrode is connected to ground, and the other electrode is connected to control circuit 584. Thus, the control circuit is configured to detect if a person contacts the cutter head or knives while the cutter head is moving, and to trigger reaction mechanism 586 to stop the cutter head from spinning, thereby mitigating injury.

It should be understood that the exemplary reaction mechanism described above is just one example of a reaction mechanism configured to mitigate injury on a jointer, and that various modifications and alternatives are possible such as have been described herein. As just one example, different force generating mechanisms may be used including a compression spring, a pneumatic cylinder, a pyrotechnic actuator, or etc. All such modifications and alternatives are within the scope of this disclosure. Furthermore, additional embodiments of an AIM-enabled jointer are described in some of the U.S. Patent references incorporated above, and in U.S. Pat. No. 6,920,814, titled “Cutting Tool Safety System,” the entire disclosure of which is incorporated herein by reference.

An AIM-enabled router is shown in FIG. 23, indicated generally at 600.

Exemplary router 600 includes a support structure in the form of a housing 602 attached to a base 604. The base typically includes one or more handles 606 by which an operator can move the router. Housing 602 contains a motor (not shown) with an output shaft or arbor 608. Router 600 may include an internal source of electrical power such as a battery, and/or it may be connectable to an external power source. A connector or collet 610 is mounted to the end of the arbor and configured to retain a cutting tool in the form of a bit 612. Typically, various bits are available with different profiles so that an operator can easily change the bit held by the collet to perform different shaping operations on a workpiece.

Router 600 also includes a control circuit, at least a portion of which is contained within replaceable housing 614. The control circuit is configured to start and stop the motor in response to inputs from an operator via one or more user input components (not shown) such as an ON/OFF switch. An operator shapes an edge of a workpiece by placing the base of the router against one surface of the workpiece and starting the motor. The operator then slides the router along the surface until the bit contacts an edge of the workpiece perpendicular to the surface on which the router is sliding. The operator then continues to slide the router over the surface with the bit in contact with the perpendicular edge. As a result, the edge of the workpiece is cut to match the profile of the bit.

The control circuit is coupled to arbor 608 to determine when the arbor is spinning and to detect if a person contacts the bit. The collet and bit are constructed of electrically conductive material such as metal, so that drive and sense signals can be transmitted between the control circuit and the bit. Rotation of the arbor is detected by the control circuit utilizing mechanisms such as have been described above.

Housing 614 also includes a reaction mechanism 616 configured to stop rotation of the bit. In some embodiments, the reaction mechanism may engage the bit to brake or stop its movements. Alternatively, the reaction mechanism may be configured to engage some other structure coupled to the bit such as brake engagement structure 618. As shown in FIG. 23, the brake engagement structure is connected to arbor 608 between motor and the collet. The brake engagement structure is configured to rotate with the arbor and the bit. Alternatively, the brake engagement structure may be integrally formed with either the arbor, the collet, or the bit.

Turning attention now to FIG. 24, additional details of the brake engagement structure and reaction mechanism can be seen. Similar to some of the reaction mechanisms described above, reaction mechanism 616 includes a brake component 620 configured to pivot about a pin 622, and a force generating component 624. The exemplary force generating component is a compression spring configured to pivot the brake component into contact with the brake engagement structure. The reaction mechanism also includes a restraining member in the form of a fuse wire 626 that is looped over the brake component and an electrode assembly 628. The fuse wire is configured to hold brake component 620 spaced apart from the brake engagement component until the fuse wire is melted. The brake engagement structure includes an edge surface which may include features 630 adapted to grip or dig into the brake component. In any event, when the control circuit triggers the reaction mechanism by melting the fuse wire, the brake component engages the brake engagement structure to stop the arbor and bit from rotating. Thus, the control circuit is configured to stop the bit from cutting if contact between a person and the bit is detected while the bit is moving. In alternative embodiments of router 600, the reaction mechanism is configured to retract the bit into the base instead of, or in addition to, stopping the rotation of the bit. Exemplary AIM-enabled routers, as well as control circuits and reaction mechanisms therefor, are described in more detail in U.S. Pat. No. 7,784,507, titled “Router With Improved Safety System,” the entire disclosure of which is incorporated herein by reference.

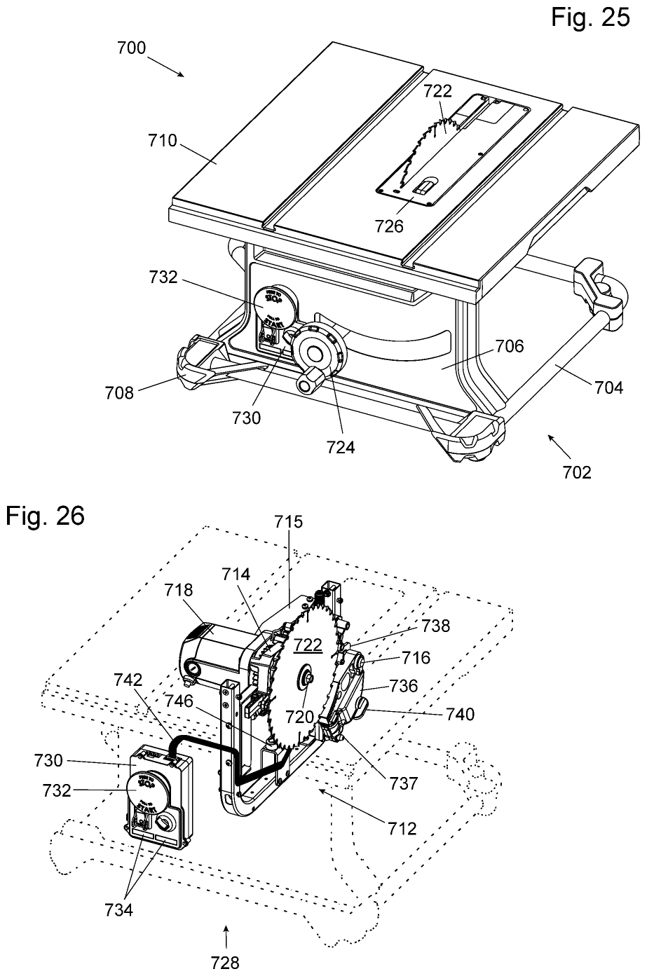

Turning attention now to FIGS. 25 and 26, another exemplary AIM-enabled power tool is shown in the form of a small, portable table saw, indicated generally at 700. Table saw 700 includes a support structure in the form of a relatively open framework 702 constructed of metal tubes 704 and panels 706, connected by various mechanisms including connectors 708, fasteners, and welds. A worksurface or table 710 and an internal trunnion assembly 712 are supported by support structure 702. The table saw also includes an arbor block assembly 714 pivotably mounted to the trunnion assembly by a pivot pin 716 and held in an un-retracted position by a latch mechanism 715. The arbor block assembly includes a motor 718 coupled to drive a rotatable arbor 720. A circular saw blade 722 is mounted on the arbor so that the blade spins with the arbor. The table saw includes one or more mechanical controls 724 through which an operator can raise, lower, and or tilt the blade through a slot formed in a table insert 726 mounted to the table. Table saw 700 is constructed to be generally smaller and lighter than other table saws such as cabinet saws, contractor saws, hybrid table saws, and some jobsite table saws, so that the table saw can be lifted and carried by a single person. Table saw 700 is also referred to herein as a “compact table saw.”

Exemplary table saw 700 includes a control circuit, indicated generally at 728, comprised of multiple components, circuits, and assemblies distributed within the saw. One portion of the control circuit is contained within a switch box 730 mounted to the front of the support structure. The switch box includes at least a part of the user interface module of control circuit 728, including one or more user input components 732 and/or indicator components 734. Another portion of the control circuit is contained within a brake cartridge 736 mounted to pivot pin 716 and a positioning pin 737. The brake cartridge contacts a cartridge bracket 738 and is locked in place by a cartridge key 740. The switch box and brake cartridge are connected to communicate by a cable 742 (also referred to herein as a “cartridge cable”). A motor cable (not shown) connects the switch box to motor 718. The exemplary table saw is powered by line power via a power cord (not shown) connected to the switch box. In alternative embodiments, the table saw may be powered by a different power source or combination of sources.

Control circuit 728 is configured to monitor and/or control one or more conditions and/or functions of table saw 700. One or more software-controlled processors, as well as additional components and circuitry, are contained in brake cartridge 736. Likewise, one or more software-controlled processors, as well as additional components and circuitry, are contained within switch box 730. The processors in the brake cartridge and switch box, executing software instructions stored within memory, communicate back and forth over cartridge cable 742 to perform the various functions of the control circuit. For example, the control circuit connects and disconnects electrical power to the motor. The control circuit operates the motor in response to inputs by an operator via the switch box, as well as additional inputs and/or conditions of the saw, as determined by the software instructions. The software instructions may be stored within memory storage modules on the processors and/or on separate memory storage components within the control circuit.

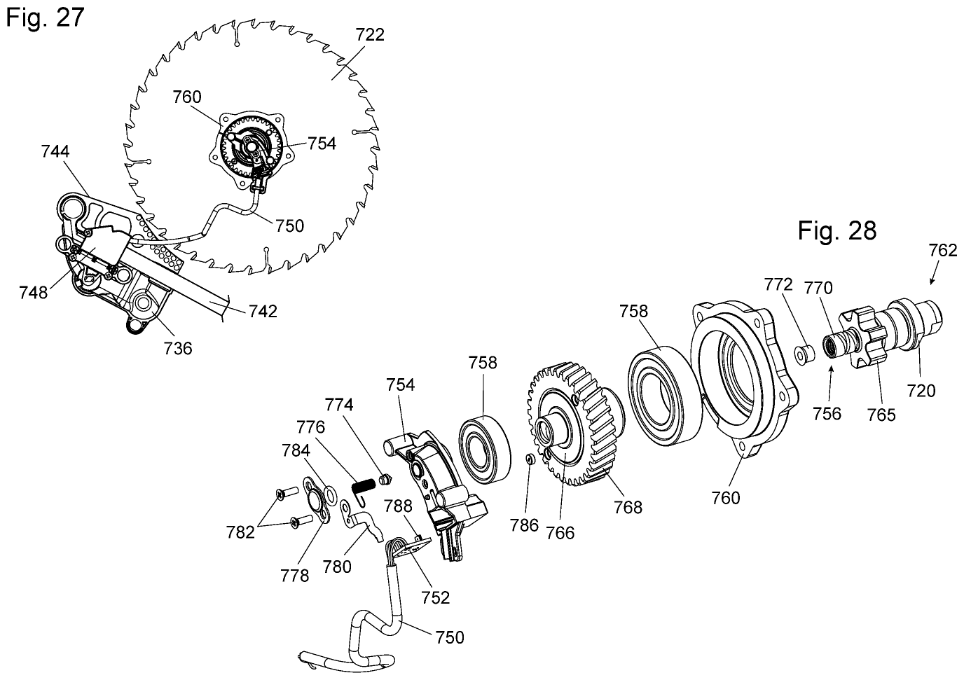

Control circuit 728 is also configured to detect if a person contacts the blade while the blade is spinning, and to react to mitigate injury. As best seen in FIG. 27, brake cartridge 736 includes a reaction mechanism in the form of an aluminum brake pawl 744 positioned near the perimetrical edge of blade 722. Brake cartridge 736 is similar to brake cartridge 234 shown in FIG. 11 and described above in reference to jobsite table saw 200. Indeed, some embodiments of brake cartridge 736 may be used in multiple types of power tools including jobsite table saw 200 and compact table saw 700. In such embodiments, when the brake cartridge is installed on the compact table saw, it forms a portion of the control circuit for the compact table saw. Conversely, when the brake cartridge is installed on the jobsite table saw, it forms a portion of the control circuit of the jobsite table saw.

Similar to brake cartridge 234, brake cartridge 736 includes a force generating component in the form of a compression spring, and a restraining mechanism in the form of a fuse wire. When the fuse wire is melted, the spring pushes brake pawl 744 to pivot about pin 716 until the brake pawl contacts the teeth of blade 722. The moving teeth dig into the soft aluminum of the pawl until the blade locks on the pawl and stops spinning. As mentioned above, arbor block assembly 714 is configured to pivot about pin 716 and held in an un-retracted position by latch mechanism 715. Therefore, if the momentum of the blade is sufficient when the brake pawl contacts the spinning blade, a corresponding downward force will be generated on the arbor block assembly causing the latch mechanism to release. At which point, the arbor block assembly will retract until it contacts a bumper 746 (shown in FIG. 26), thereby retracting the blade completely below table 710.

While one end of cartridge cable 742 is terminated in the switch box, the other end is terminated in a housing 748 which is mounted to the side of cartridge bracket 738 opposite the brake cartridge. Cartridge cable 742 enters housing 748 through an opening in the housing. The cartridge cable is terminated on a small pc board (also referred to herein as a “d-sub board”) contained in the housing. A d-sub connector is also mounted to the d-sub board and protrudes from the housing. When the brake cartridge is fully installed so as to contact the cartridge bracket, a mating d-sub connector in the side of the cartridge (as shown in FIG. 11) connects to the connector on the d-sub board. As a result, signals between the switch box and brake cartridge are transmitted via the cartridge cable, the d-sub board, and the mating connectors. It should be understood that any suitable electrical cables and/or connectors may be used. The switch box, brake cartridge, cartridge cable, d-sub board, housing, and connectors are all portions of the control circuit.

As shown in FIG. 27 and FIG. 28, the control circuit includes another cable 750 (also referred to herein as an “arbor cable”), one end of which is terminated on the d-sub board in housing 748. The opposite end of arbor cable 750 is terminated on another small pc board 752 (also referred to herein as an “arbor board”) mounted on a housing 754. The housing is mounted on the arbor block assembly and positioned adjacent the end 756 of the arbor opposite the blade. As will be described below, the control circuit is coupled to the arbor via arbor cable 750.

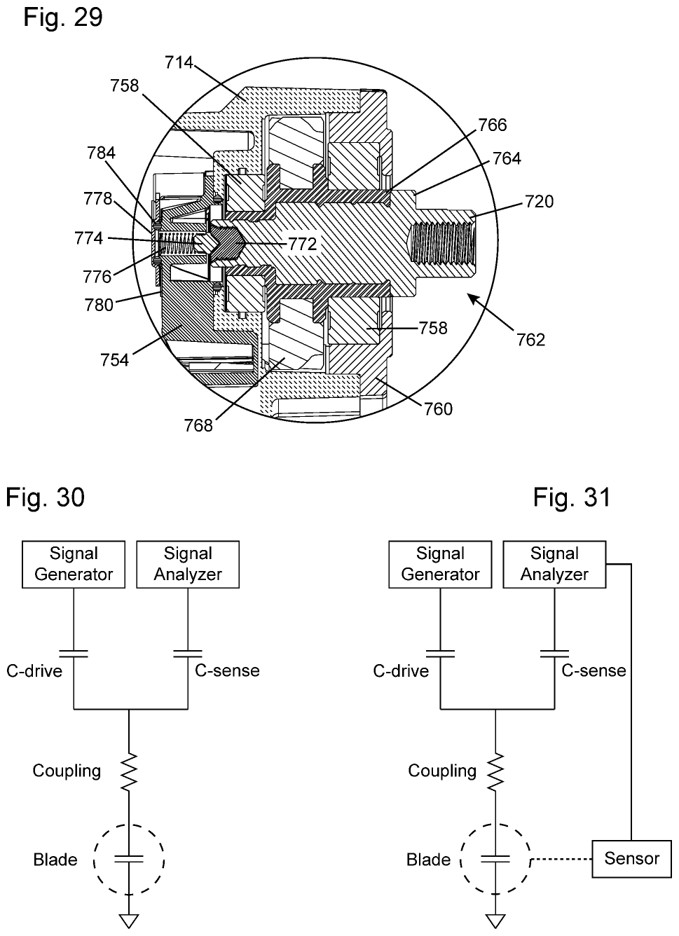

Focusing now on both FIGS. 28 and 29, additional details of the arbor and coupling can be seen. Arbor 720 is held within the arbor block by a pair of bearings 758 and a bearing retainer plate 760. End 762 of the arbor extends out of the arbor block and is configured to receive a saw blade. A flange 764 is formed on the arbor to fix the position of the blade on the arbor. The interior of end 762 is threaded to receive a bolt and washer assembly configured to retain the blade against the flange. In other embodiments, the threaded hole is omitted and the exterior of end 762 is threaded to receive a nut and washer assembly to retain the blade. A central, geared portion 765 of the arbor is surrounded by a sheath 766 of electrically insulating material such as over-molded 40% glass-filed PEI. Although the arbor is shown in FIG. 28 as exploded from the sheath for clarity, the sheath is over-molded between the arbor and a gear component 768 so that the arbor and gear are bound together into a unitary assembly. However, the sheath electrically insulates the arbor from the gear component as well as the rest of the arbor block assembly, which may be connected to electrical ground. Gear component 768 engages a mating gear formed on the output shaft (not shown) of motor 718. As a result, when the output shaft of the motor spins, gear component 768 and arbor 720 also spin.

A socket 770 is formed in end 756 of the arbor. A first conductive brush 772 is press-fit into the socket so that brush 772 spins with the arbor. In some embodiments, the interior wall of socket 770 is grooved or threaded to help retain brush 772 within the socket. A second conductive brush 774 is held in contact with first brush 772 by a compression spring 776. The second brush is formed with a cylindrical body which is press-fit into the interior of compression spring 776. A tapered tip on the second brush extends out of the spring and into a matching tapered cavity in the first brush. The engagement of the second brush with the first brush is best seen in FIG. 29. A loop formed on the end of spring 776 opposite the second brush is clamped between a retainer plate 778 and an electrical connector link 780 by one or more screws 782. The retainer plate is fastened to housing 754 by screws 782. An O-ring 784 is disposed between the retainer plate and housing 754 to prevent debris from entering the housing. Connector link 780 is also electrically connected to arbor board 752.

While first conductive brush 772 is mounted into the arbor so as to rotate with the arbor, the second conductive brush 774 is mounted in spring 776 so as not to rotate. In addition to holding the second brush in general coaxial alignment with the arbor and first brush, the spring also exerts a constant, known force that holds the tapered end of the second brush in contact with the tapered cavity of the first brush. Thus, a moving contact is created between the two brushes. The brushes are constructed so as to be electrically conductive. In the exemplary embodiment, the conductive brushes are formed from a braid of graphite fibers that is pressed into shape, although other materials and/or shapes may be used, including graphite in solid, powder or gel form, brass, and etc. In addition, spring 776, retainer plate 778, and connector link 780 are constructed of metal or some other electrically conductive materials. Therefore, the arbor is electrically coupled to the arbor board via the two conductive brushes, the spring, the retainer plate, and the connector link. As a result, the control circuit is coupled to the arbor via a conductive coupling where there is physical contact between elements of the coupling, rather than a capacitive coupling where there is a gap or space between elements of the coupling. Furthermore, one or more of the conductive brushes, the spring, the retainer plate, the connector link and/or the arbor board may be considered to be portions of the control circuit.

In alternative embodiments, the first conductive brush may be placed on a different portion of the arbor, or even on the blade itself. As a further embodiment, the first conductive brush may be eliminated and the second brush may be held in direct contact with either the arbor or the blade, or some other component electrically coupled thereto. In still other alternative embodiments such as described above, the control circuit may be coupled to the arbor by a capacitive coupling. As a further alternative, both a capacitive and a conductive coupling may be used. Additional examples of conductive brushes and couplings are described in more detail in WIPO International Patent Application Publication No. WO 2017/210091 A1, published Dec. 7, 2017, and titled “Detection Systems For Power Tools With Active Injury Mitigation Technology,” the entire disclosure of which is incorporated herein by reference.

The control circuit of table saw 700 is also configured to determine whether the blade is moving. At least one magnet 786 is mounted in gear component 768, so that the magnet moves in an orbit around the axis of the arbor when the arbor is spinning. A Hall effect sensor 788 is mounted to arbor board 752 and positioned to sense the magnetic field of the magnet each time it rotates by the sensor. The Hall effect sensor is connected as a part of the control circuit via the arbor board and arbor cable, etc. Signals from the Hall effect sensor are transmitted to a rotation sense module within the control circuit.

To summarize, control circuit 728 is coupled to drive a detection signal onto arbor 720, and thereby blade 722 by a conductive coupling from the control circuit to the arbor. Likewise, the control circuit is configured to monitor the signal on the blade via the same conductive coupling, and to analyze the sense signal for changes indicative of a person contacting the blade. If such a contact is detected at a time when the control circuit determines that the blade is moving (or moving faster than a selected threshold speed), the control circuit is configured to trigger the reaction mechanism which reacts to push the brake pawl into the teeth of the spinning blade. This causes the blade to stop spinning and therefore stop cutting. Moreover, depending on the momentum of the blade when it is stopped, the arbor block may drop down causing the blade to retract below the table. Furthermore, when the control circuit triggers the reaction mechanism, the control circuit may be configured to also stop the motor by disconnecting electrical power to the motor. In some embodiments, the control circuit is also configured to display an indication of the detection and/or reaction event to the operator via an indicator component of the user interface module.

It will be appreciated that the conductive coupling of control circuit 728 offers certain advantages over capacitive couplings such as those depicted in FIGS. 12-13 and described above. For example, the conductive coupling of control circuit 728 is much smaller and more compact than the capacitive couplings described above. As a result, the conductive coupling can more easily be incorporated into smaller power tools such as the compact table saw, hand-held circular saw, miter saw, router, and etc. The conductive coupling may also be less susceptible to electrical noise in some circumstances. However, one advantage of the capacitive couplings is that, since the coupling does not entail physical contact with the spinning arbor, there is little chance the capacitive electrodes will degrade or fail over time due to wear. Conversely, the conductive coupling does entail physical contact between a stationary electrode or conductive brush and a moving electrode or conductive brush. As a result, it is possible that one or both of the conductive brushes may experience wear that degrades or prevents the transmission of the drive and/or sense signals by the brush(es). Therefore, some embodiments of AIM-enabled power tools are configured to test the functioning of the conductive coupling to detect any degradation or failure that might impede the detection of dangerous contact by the control circuit.

One characteristic of the conductive coupling may be thought of as continuity of signal. In other words, does the conductive coupling transmit electrical signals continuously and without interruption? It should be appreciated that interruption in the sense signal will impede the detection of contact between a person and the blade. Moreover, an interruption of the drive signal will necessarily cause an interruption in the sense signal. Therefore, exemplary control circuits are commonly configured so that loss of the sense signal, for more than a selected period of time which is typically relatively short, will result in an error condition and/or recognition of a contact event.

In some embodiments, the control circuit is configured to trigger the reaction mechanism if the sense signal is lost to ensure safety. In any event, discontinuity in the conductivity of the conductive coupling may be detected by the control circuit during the process of analyzing the sense signal for changes indicative of contact between a person and the blade. In which case, additional steps or mechanisms may not be necessary to detect this type of failure of the conductive coupling.

In contrast, another characteristic of the conductive coupling is its electrical impedance. Depending on how the conductive coupling is constructed and configured within the power tool, the coupling will have a measurable, non-zero impedance which will include a non-zero electrical resistance. Turning attention to FIG. 30, an approximate equivalent circuit is shown representing the coupling between the blade of table saw 700 and control circuit 728. The circuit between the signal generator and the coupling includes a drive capacitor labeled as “C-drive.” Likewise, the circuit between the signal analyzer and the coupling includes a sense capacitor labeled as “C-sense.” The signal generator circuit and the signal analyzer circuit are connected to the coupling which is represented by a resistor labeled “Coupling.” The coupling connects to the blade via the arbor. The combination of arbor and blade have a non-zero electrical capacitance to ground. For the exemplary table saw shown in FIGS. 25-29, the capacitance of the arbor/blade assembly has been experimentally measured at approximately 150 pF, but can vary by 25% or more depending the position of workpieces, accessories, and etc. It will be appreciated that the capacitance of the arbor and blade will depend on many factors including the size of each component and how the assembly is insulated from nearby structures of the table saw which are grounded. In FIG. 30, the arbor and blade are represented by a single capacitor labeled “Blade.”

As discussed above, when a continuous drive signal is transmitted via the coupling onto the arbor and blade, a continuous sense signal will be transmitted to the signal analyzer. However, the sense signal received at the signal analyzer will be different than the drive signal generated at the signal generator, due to the combined impedance of the intervening circuitry, the coupling, and the arbor/blade assembly.

When a person contacts the blade, an additional capacitance corresponding to the person's body will be coupled to the existing capacitance of the arbor and blade. This change in the apparent capacitance of the blade will cause the sense signal to change. The amount of additional capacitance added to the capacitance of the blade will vary depending on many factors such as the person's body mass and whether they are in direct contact with an electrically grounded conductor. As previously mentioned, some exemplary embodiments of control circuit 728 are configured to recognize changes in the sense signal that correspond to an additional capacitance of approximately 30 pF as being indicative of contact between a person and the blade. Alternatively, other thresholds may be selected to recognize contact between a person and the blade.

It will be appreciated that the magnitude of the change in the sense signal caused by the addition of 30 pF to the blade, will depend on the impedance of the coupling between the signal analyzer and the blade. In other words, as the impedance of the coupling increases, the magnitude of the change in the sense signal due to a person contacting the blade will decrease. Furthermore, as the impedance of the coupling increases, the magnitude of the sense signal will also increase, which diminishes the affect that an addition of 30 pF to the apparent capacitance of the blade will have on the sense signal. At some point, the impedance of the coupling may become so high that the change caused by adding 30 pF to the capacitance of the blade becomes too small to detect reliably, especially as distinguished from changes in the sense signal due to background electrical noise. Therefore, it may be desirable to evaluate or measure the impedance of the coupling to ensure the impedance is within a nominal range that allows the control circuit to reliably detect contact between a person and the blade.

Various mechanisms and techniques may be utilized to measure the impedance of the blade. One simple technique involves directly measuring the impedance with a multimeter or similar device. However, requiring an operator to have the equipment and experience needed to accurately measure impedance is impractical in most cases. Therefore, it would be preferable to configure the control circuit so as to measure the impedance. Thus, in one embodiment, the blade could be electrically grounded temporarily, thereby removing it from the equivalent circuit of FIG. 30. In such case, the resistance of the coupling could be calculated by the control circuit given known circuit impedances prior to the coupling. The blade can be temporarily grounded by an operator during a test sequence initiated by the control circuit. Where operator involvement is not desirable, a mechanical mechanism can be configured to ground the blade. As just one example, a solenoid may be installed which moves a grounding terminal into contact with the blade. If the solenoid is configured to be controlled by the control circuit, then the impedance of the coupling may be measured automatically without the intervention or involvement of an operator. Alternatively, a second conductive coupling could be used to selectively ground the blade. It will be appreciated that various other mechanisms are possible for temporarily grounding the blade, and all such alternatives are within the scope of this disclosure.

While directly measuring the coupling impedance or grounding the blade to measure the impedance may be suitable for some embodiments, alternative mechanisms and/or techniques may be desirable in other embodiments to increase reliability, automation, and/or cost savings. Thus, some alternative embodiments may employ mechanisms and techniques that do not involve mechanical operations of measuring and/or grounding. An equivalent circuit representation of one such alternative embodiment is shown in FIG. 31. As can be seen, the embodiment of FIG. 31 is identical to the embodiment of FIG. 30, except for the addition of a sensor which is positioned on the opposite side of the blade and coupling relative to the signal generator and signal analyzer. The sensor is a part of the control circuit and allows the control circuit to measure signals at the blade. When viewed from the position of the sensor shown in FIG. 31, the coupling and arbor/blade assembly form an RC network that is driven by the signal generator and which can be monitored at the sensor. The output of the sensor is connected to the signal analyzer. Alternatively, the output of the sensor may be connected to a separate signal analyzer. In any event, the sensor enables the control circuit to measure the response of this RC circuit, and thereby evaluate the combined impedance of the coupling and arbor/blade assembly.

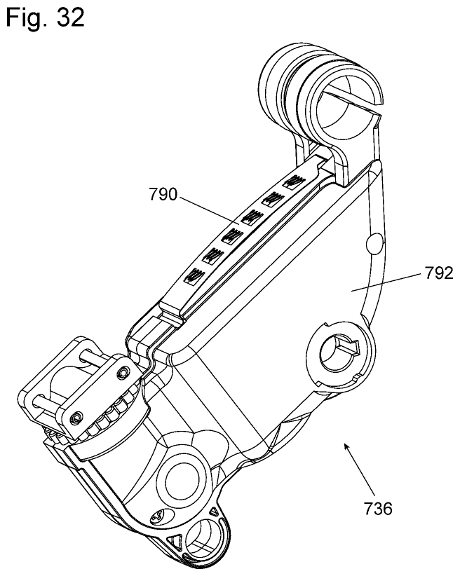

A sensor configured to sense the signal on a cutting tool may take various forms and be positioned in various locations around the cutting tool. In exemplary table saw 700, the portion of control circuit 728 contained in brake cartridge 736 is configured to include such a sensor. Turning attention to FIG. 32, brake cartridge 736 is shown with brake pawl 744 omitted. As can be seen, the brake cartridge includes a brass electrode 790 positioned between the brake pawl and housing 792 of the brake cartridge. One end of electrode 790 (also referred to herein as the “pawl electrode”) extends into the housing and is connected to the pc board in the brake cartridge (also referred to herein as the “cartridge board”) that forms a portion of the control circuit. As previously mentioned, the brake pawl is constructed of aluminum, and is therefore electrically conductive. Since the brake pawl is positioned close to, but spaced apart from, the blade, the brake pawl is capacitively coupled to the blade. As a result, an electrical signal on the blade will be capacitively coupled to the brake pawl. Thus, the brake pawl may be thought of as the sensor of FIG. 31 and the pawl electrode may be thought of as the connection between the sensor and the signal analyzer portion of the control circuit.

Since the control circuit is electrically connected to the brake pawl via the pawl electrode, the control circuit is configured to sense or detect the signal on the blade. This enables the control circuit to evaluate, through measurement and/or calculation, the impedance of the coupling and arbor/blade assembly without intervention by the operator or a mechanical grounding mechanism. Furthermore, the control circuit can evaluate the impedance while the blade is stationary, or while the blade is moving, or both.

It will be appreciated by those of skill in the art that there are various methods and techniques for evaluating the performance of an RC network. In the exemplary embodiment of table saw 700, control circuit 728 evaluates the RC network formed by the coupling and the arbor/blade assembly by measuring the response of the RC network to a voltage step injected into the drive signal circuit, and also by measuring the phase difference in signals transiting the RC circuit. Each evaluation technique will be described in more detail below. Nevertheless, these exemplary techniques are intended to serve only as examples of the various alternative mechanisms and methods for evaluating the impedance of the coupling, all of which are within the scope of this disclosure.

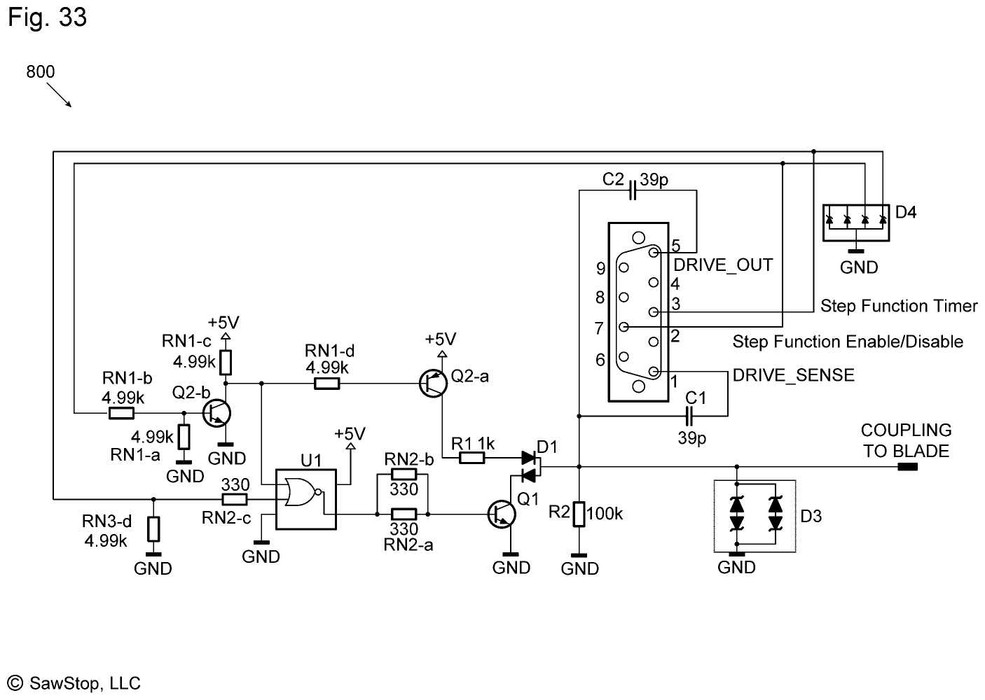

Exemplary control circuit 728 includes a signal generator module configured to generate a step waveform test signal, which the control circuit transmits to the blade via the conductive coupling. The signal generator module for generating the step signal may be the same signal generator module that generates the drive signal for detecting contact between a person and the blade. Alternatively, a separate signal generator module, formed of additional components and/or circuitry, may be used which may be connected to a suitable drive signal generator module such as described above in reference to FIGS. 6A-6B. It should be understood that, even if a separate signal generator module is utilized for evaluating the conductive coupling, the combination of the drive signal generator and the step signal generator may still be thought of as a single signal generator module within the control circuit, where the combined module is configured to generate different types of signals. In exemplary control circuit 728, a drive signal generator is located on the cartridge board. An example of such a drive signal generator was described above in reference to FIGS. 6A-6B. Additionally, the control circuit includes an additional step signal generator module located on the d-sub board within housing 748. An exemplary embodiment of this step generator module is shown by the circuit diagram of FIG. 33.

As shown in FIG. 33, the step signal generator, indicated generally at 800, is connected to the drive signal generator via the d-sub connection between the cartridge pc board and the d-sub board. The DRIVE_OUT and DRIVE_SENSE signal lines indicated on the d-sub connector correspond to the same signal lines in FIGS. 6A-6C and are connected to the conductive coupling through the capacitors C2 and C1, respectively. Thus, the signal generator and signal analyzer on the cartridge board are connected to the conductive coupling as has been described above. The resistor labeled R2 functions to drain accumulated charge from the blade, while the diode array D3 protects against electrostatic discharges to the blade.

As discussed above, the drive signal generator is configured to generate a continuous AC sinusoidal signal of approximately 500 kHz. In contrast, the step signal generator is configured to generate an essentially square wave, high-to-low step voltage signal of approximately 4V to approximately 1V. It will be appreciated that attempting to drive both signals onto the blade simultaneously and analyzing the results for both dangerous contact and coupling impedance can be complex.

Therefore, control circuit 728 is configured to drive only one of the signals onto the blade at any given time. In other words, the drive signal is disabled while the step signal is being driven onto the blade, and vice versa. While the exemplary step signal generator is configured to generate a high-to-low step signal from approximately 4 VDC to 1 VDC, different step signals may alternatively be used, including different voltages and/or low-to-high signals.

Since the control circuit is unable to detect contact between a person and the blade while the drive signal is disabled, the control circuit is configured to only evaluate the impedance of the conductive coupling using the step signal when the blade is stopped. Furthermore, the control circuit is configured to prevent startup of the motor while the impedance of the conductive coupling is being evaluated with the step signal. Typically, the control circuit is configured to run a step signal test of the conductive coupling impedance when the control circuit boots and initializes upon connection to electrical power. Alternatively, or additionally, the control circuit may be configured to repeat the step signal test during each period the blade is stopped or at selected intervals. As a further alternative, the control circuit may be configured to turn off the motor and run the test if a selected time period has passed since the prior test. In any event, once the step signal test of the coupling impedance has been completed, the control circuit disables the step signal and enables the drive signal so that normal operation of the power tool can proceed.

As can be seen in FIG. 33, step generator module 800 biases the blade at a nominal level of about 4 VDC via transistor Q2-a and the pull up resistor R1. This bias is the nominal voltage to which the RC circuit will be charged between the step waveform excitations or signals. Transistor Q2-a is switched on and off through the operation of transistor Q2-b. When the base/emitter junction of transistor Q2-b is forward biased, the transistor begins to conduct and current from the 5V supply and the base of transistor Q2-a is sourced through the collector of transistor Q2-b, thereby forward biasing the base/emitter junction of transistor Q2-a. Once transistor Q2-a is switched on, the blade is pulled up to approximately 4 VDC via the pullup resistor R1. Conversely, when the base/emitter junction of Q2-b is reverse biased, the base/emitter junction of transistor Q2-a is pulled up by the 5 VDC supply, thereby removing the forward bias of the base/emitter junction of Q2-a and disconnecting the 5V source from the blade, which then discharges through R2. The operation of transistor Q2-b is controlled by the input signal labeled “Step Function Enable/Disable” which is software-controlled by the one or more processors on the cartridge board. When the signal is high, Q2-b is switched on, thereby switching on transistor Q2-a and “enabling” the step signal test by biasing the blade to approximately 4 VDC.

Once the blade has been biased to the nominal test level, a high-to-low step edge waveform is generated by the operation of transistor Q1. When transistor Q1 is switched on, the charge on the arbor/blade assembly is quickly discharged to ground, thus providing the high-to-low step signal to the blade. When transistor Q1 is switched off, the weak biasing current supplied by Q2-a to the blade will raise the voltage on the blade back to approximately 4 VDC. Dual diode D1 blocks conduction of the parasitic base/collector PN junctions of transistor Q2-a and transistor Q1 that would normally form when the circuit is enabled. This keeps these transistors from impacting the drive and sense circuits and creating distortion in the drive and sense signals during normal operation. The base/emitter junction of Q1 is tied to the output of a logic gate U1. When the output of U1 is high, the base/emitter junction of Q1 is forward biased so that the transistor begins to conduct and pull the signal on the blade down. Conversely, when the output is low, the base/emitter junction is no longer forward biased, and the output collector of transistor Q1 no longer drains current from the blade. Logic gate U1 provides a buffered and very fast rise/fall edge to rapidly switch transistor Q1 and generate the high-to-low signal. The output of Q1 is controlled by the input signal labeled “Step Function Enable/Disable,” and the input signal labeled “Step Function Timer.”

As with the nominal 4 VDC bias signal or “high” signal, the “low” signal is enabled by the “Step Function Enable/Disable” signal from the processor on the cartridge board. When that signal is high, causing transistor Q2-b to begin conducting, a first input of the NOR logic gate is pulled low, thereby enabling the output of the logic gate to be controlled by the second input to the logic gate. Conversely, when the “Step Function Enable/Disable” signal is low, transistor Q2-b stops conducting and the first input to the logic gate is pulled high. As a result, the output of the logic gate is held low regardless of the other input to U1 and transistor Q1 will not conduct. Thus, the “Step Function Enable/Disable” enables both the 4 VDC nominal bias signal as well as the discharge of that signal by Q1.

When logic gate U1 is enabled by the “Step Function Enable/Disable” signal, the output of the logic gate is controlled by the “Step Function Timer” signal. When the “Step Function Timer” signal is high, the output of the logic gate is low and transistor Q1 does not conduct. However, when the “Step Function Timer” signal goes low, the output of the logic gate goes high, thereby switching on transistor Q1 to discharge the blade. In other words, when the “Step Function Timer” signal transitions from high to low, the signal coupled to the blade is stepped from a high of about 4 VDC to a low of about 1V depending on the voltage drops across Q1 and D1. Transistor Q1, when driven by the output of logic gate U1 is configured to pull the signal being transmitted to the blade low quickly enough to constitute a step signal as seen by the RC circuit formed by the conductive coupling and the blade. In other words, the switching time of transistor Q1 is much faster than the time constant of the RC circuit formed by the conductive coupling and blade. This step signal is also referred to herein as a “step-test signal,” as it is a signal generated by the control circuit to test the impedance of the conductive coupling. In the exemplary embodiment, the “Step Function Timer” signal is cycled repeatedly to produce multiple repeating high-to-low step-test signals to the blade.

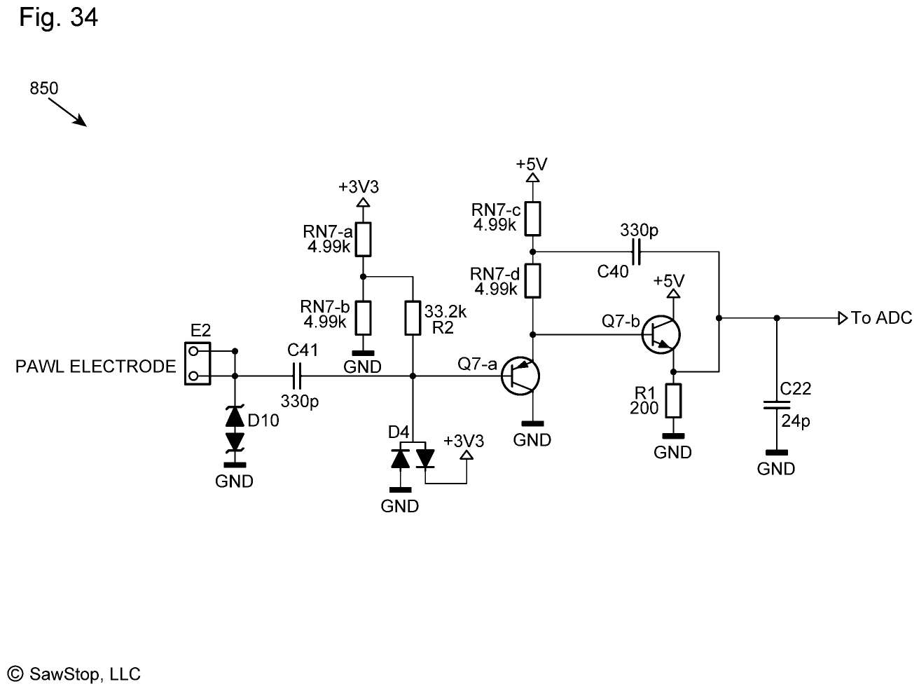

As mentioned above, the step-test signal which is transmitted to the blade is capacitively coupled onto the aluminum brake pawl due to the small air gap between the blade and the brake pawl. In other words, the brake pawl detects the signal on the blade due to the capacitive coupling between the aluminum brake pawl and the blade. The signal detected by the brake pawl is connected to the control circuit via pawl electrode 790. The signal analyzer module within exemplary control circuit 728 includes pawl electrode circuitry, indicated generally at 850 in FIG. 34, connecting the pawl electrode to an ADC input on the processor on the cartridge board. Pawl electrode circuitry 850 functions as a transistor buffering circuit to drive the ADC input with sufficient bandwidth to resolve the response or voltage decay in the signal on the blade. Nominal values for the arbor/blade assembly capacitance and the impedance of the conductive coupling have been experimentally determined for table saw 700 to be approximately 150 pF and 10-20 ohms, respectively. As a result, response times in the range of 10's of nanoseconds are expected. Thus, a bandwidth of at least approximately 10-15 MHz is required to detect significant changes in the coupling impedance. However, it should be appreciated that different bandwidths, including lower bandwidths, may be selected depending on the particular characteristics of the blade, conductive coupling, and control circuit.

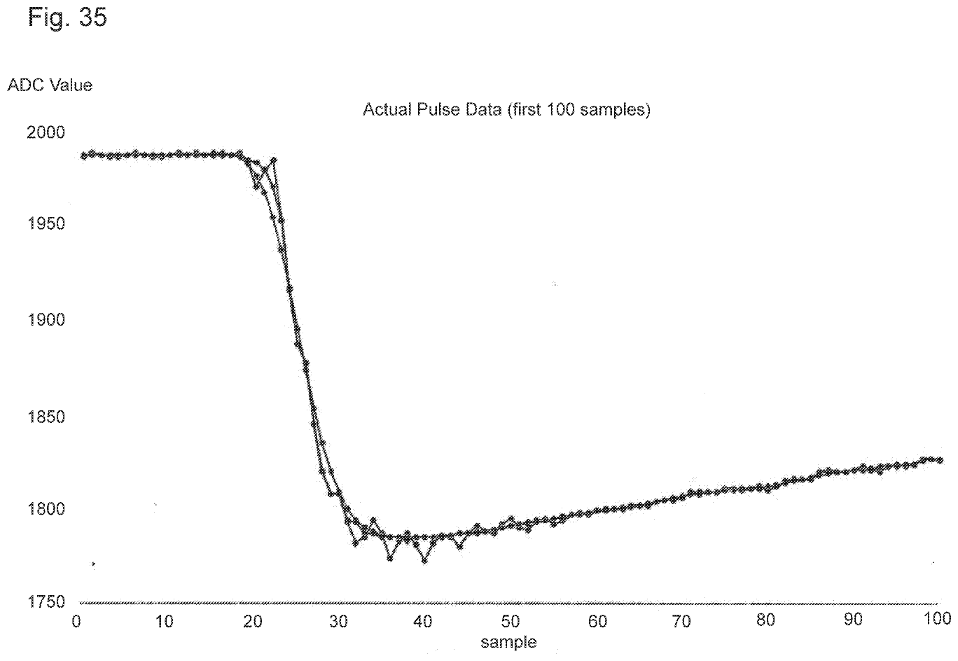

In the exemplary embodiment, the control circuit is configured to utilize under-sampling with the ADC to reconstruct the signal response on the blade. The “Step Function Timer” signal is triggered repeatedly while the ADC repeatedly samples a window of the detected signal so that the analyzer can construct an average value for that window. Next, the “Step Function Timer” signal is shifted forward by one clock cycle, where it repeats to allow the ADC to capture the next window average of the signal. This process is repeated until the entire analog signal response on the blade, as detected on the brake pawl, is reconstructed in digital form. This under-sampling technique allows the control circuit to resolve the detected signal at the time resolution of the timer rather than the typically slower time resolution of the ADC. While averaging the signal helps to filter some noise, the reconstructed digital signal can also be passed through software filters to remove additional noise. The particular filter(s) utilized will depend on the desired resolution and the signal characteristic being measured. A graph of the reconstructed step signal response from exemplary table saw 700 as well as median and low-pass filtered versions of the signal is shown in FIG. 35, where the measured resistance of the conductive coupling was approximately 22 ohms.

Once the detected step signal response is reconstructed, the result is analyzed by a signal analyzer module within the control circuit to determine a response time from a selected high point to a selected low point. In the exemplary embodiment, the voltage drop is measured from a point on the signal at 90% of maximum, to a point at 10% of maximum. The response time is determined as the number of sample steps between the 90% and 10% points. The signal analyzer uses interpolation to determine values for fractional portions of a sample period to improve resolution.

To evaluate the impedance of the conductive coupling using the response time of the detected step-test signal, the response time is compared to one or more threshold response times stored within the processor memory. To establish these thresholds, measurements are made of the impedances of multiple samples of the conductive coupling, and high and low threshold impedances are selected. A corresponding range of nominal response times is likewise selected to indicate whether the impedance of the conductive coupling exceeds the selected impedance thresholds. This nominal range of response times establish high and low threshold response times, which are expressed as a number of sample steps between the 90% and 10% points on the reconstructed signal. These thresholds are stored within the memory for comparison during operation of the test. If the actual measured response time falls above or below the thresholds, then an error is declared.

It should be noted that the resolution with which the impedance of the conductive coupling can be evaluated is limited because factors other than the impedance of the conductive coupling can affect the response time. For example, a higher capacitance of the arbor/blade assembly or additional capacitive loading on the blade can increase the response time. Similarly, ambient temperature and temperature of various components of the control circuit can affect the response time. As a result, the number of samples over which the voltage of the detected signal falls will correspond to a range of possible conductive coupling impedances since the impedance of the conductive coupling is just one factor in the response time. Thus, in the exemplary embodiment, a threshold of approximately 10.5 samples was selected so that measurements of the response time in excess of 10.5 samples is considered an error. But the 10.5 sample threshold will correspond to a range of conductive coupling impedances, which were experimentally determined to be approximately 133 ohms to 267 ohms in exemplary table saw 700. In other words, a conductive coupling impedance below 133 ohms will never result in a response time of more than 10.5 samples, while a conductive coupling impedance above 267 ohms will always result in a response time of more than 10.5 samples. For conductive couplings having an impedance between 133 ohms and 267 ohms, the response time may, or may not, exceed 10.5 samples depending on the other factors mentioned above. Nevertheless, the evaluation of the impedance based on the response time of the detected step-test signal is effective to enable the control circuit to detect degraded or failed conductive couplings.

To summarize, the control circuit is configured to generate a step-test signal using a step signal generator module within the control circuit. The control circuit transmits the step-test signal to the blade via the conductive coupling which connects the control circuit to the arbor/blade assembly. The control circuit is also configured to sense or detect the step-test signal via a sensor in the form of the brake pawl which is capacitively coupled to the blade and conductively coupled to the signal analyzer module by the pawl electrode. The signal analyzer module is configured to analyze the step-test signal detected on the blade by the brake pawl sensor, and to evaluate the impedance of the conductive coupling based on the response time of the detected step-test signal. If the response time exceeds a threshold response time, which corresponds to a selected threshold range of nominal impedances, the control circuit is configured to evaluate this as an error indicative of a degraded or failed conductive coupling, which may impair the ability of the control circuit to detect dangerous contact between a person and the blade. In which case, the control circuit is configured to disable operation of the power tool by preventing startup of the motor. Additionally, the control circuit may be configured to indicate the error condition to the user via one or more indicator components on the user interface module. In alternative embodiments, the control circuit may be configured to disable the power tool differently, such as by preventing the blade of an upcut saw from rising above the table, and etc.

In the exemplary embodiment described above, the signal generator module utilized by the control circuit to generate the step-test signal was separate from the signal generator module utilized by the control circuit to generate the AC detection signal. Indeed, the control circuit was configured to disable one of the signal generator modules while the other signal module was in operation. However, alternative configurations of the control circuit are possible within the scope of the disclosure in which a single signal generator module is utilized to generator both signals. Likewise, the signal analyzer module within the control circuit which analyzes the detected step signal may be the same signal analyzer module that analyzes the detection sense signal, or different signal analyzer modules within the control circuit may be used to analyze the two signals.

It should be noted that since the sensor utilized by the control circuit to detect the signal on the blade is the brake pawl, the brake pawl can be seen as a part of the control circuit for this function. Nevertheless, the brake pawl also remains a part of the reaction mechanism. Thus, the brake pawl can be thought of as a sensor component of the control circuit during the impedance test, and also as a brake component of the reaction mechanism if dangerous contact is detected and the reaction mechanism is triggered.

As discussed above, it is difficult or impossible to perform the step signal test to evaluate the impedance of the conductive coupling while simultaneously monitoring the blade for possible contact by a person. As a result, the control circuit is configured to perform the step signal test only when the blade is stopped, and to prevent the blade from starting while the step signal test is occurring. Therefore, while the step signal test provides one useful mechanism and technique for evaluating the impedance of the conductive coupling, it may be desirable in some embodiments of an AIM-enabled power tool to also evaluate the impedance of the conductive coupling while the power tool is in operation and the cutting tool is moving. This would enable the control circuit to detect a failure or degradation of the conductive coupling during operation of the power tool, and to shut off the motor and/or otherwise disable the power tool.

Thus, exemplary control circuit 728 is also configured to evaluate the impedance of the conductive coupling while the blade is moving by analyzing the AC drive signal that is driven onto the blade for detecting contact between a person and the blade. As with the step signal test described above, the control circuit is configured to analyze the signal on the blade as it is detected by the brake pawl, which acts as a sensor. Since the conductive coupling and the arbor/blade assembly form an equivalent RC network between the drive signal generated by the control circuit and the signal detected by the brake pawl, the impedance of that RC network will cause a slight time delay that will appear as a phase difference between the drive signal and the signal detected at the brake pawl. This phase difference will depend on both the impedance of the conductive coupling and the apparent capacitance of the arbor/blade assembly. Nevertheless, an initial threshold phase difference range can be selected to indicate a degraded or failed conductive coupling. Thereafter, continuous measurement of the phase difference allows the control circuit to detect changes in the phase difference which may indicate a concurrent degradation or failure of the conductive coupling. For exemplary table saw 700, an increase in the impedance of the conductive coupling will cause a decrease in the phase difference between the drive signal and the detected signal.

As described above in reference to the step-test signal, the drive signal on the blade is detected by the brake pawl and connected to the pawl circuitry by the pawl electrode. The pawl circuitry receives the detected signal and drives one or more inputs to the ADC which samples the detected signal so that it can be reconstructed by the signal analyzer module. The reconstructed signal is filtered to remove noise and then compared to the drive signal generated by the drive signal generator. The phase difference between the two signals is determined by comparing the zero-crossing points of the signals. The number of samples between the two zero-crossings reflects a time lag, which can be converted into degrees of phase for ease of analysis. Again, interpolation can be used to increase resolution. Thus, the phase difference between the drive signal and detected signal on the blade is determined. It should be appreciated that comparing the zero-crossing points of the two signals is just one exemplary technique for determining the phase difference, and various alternative techniques, such as are well known to those of skill in the art, are possible within the scope of this disclosure.

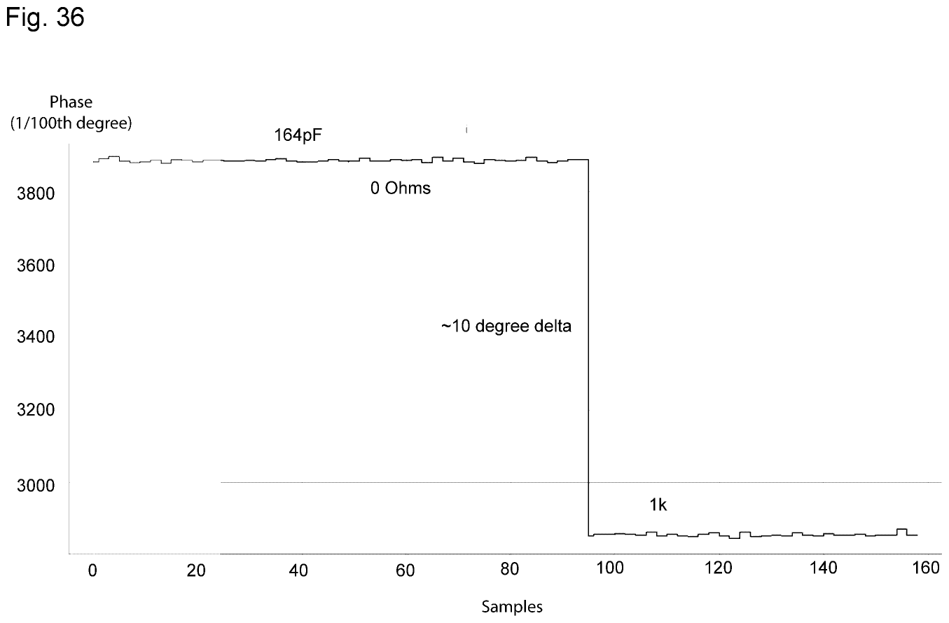

The graph shown in FIG. 36 illustrates experimentally measured data of the phase difference between the drive signal and the detected signal for an arbor/blade assembly with an apparent capacitance of approximately 164 pF. To understand the impact of changing impedance on the phase difference, the impedance of the conductive coupling was experimentally changed from 0 ohms to 1,000 ohms to determine the magnitude of the resulting phase change, which was approximately 10 degrees. In actual operation, the apparent capacitance of the blade can vary, including while the operator is cutting various types of materials which can add a capacitive load to the blade. Since this temporary variance to the apparent capacitance of the blade can also cause a change in the phase difference between the drive signal and the detected signal, it may be desirable to account for such changes, as will be described below.

In the exemplary embodiment, the control circuit is configured to take the initial phase difference measurements after the step signal test is successfully completed at system startup. Once the step signal generator is disabled, the drive signal generator is enabled and the AC drive signal is transmitted to the blade via the conductive coupling. At which point, the control circuit is able to detect the AC signal on the blade via the brake pawl. For exemplary table saw 700, an initial threshold phase difference range of 12 degrees to 24 degrees was selected based on experimental data using different physical samples and operating at different temperatures. Thus, an initial phase difference measurement outside this range, i.e., below 12 degrees or above 24 degrees, corresponds to a conductive coupling impedance outside the selected thresholds of nominal impedances. If the initial phase difference measured is outside the thresholds, then an error is declared and the motor is disabled.

If the initial phase difference measurement is not outside the selected thresholds, no error is declared and the control circuit continues to take periodic measurements of the phase difference to detect changes in the phase difference which may be due to degradation or failure of the conductive coupling. Since factors other than the conductive coupling impedance can cause a change in the phase difference, any measured change in the phase difference will necessarily correspond to a range of possible changes to the conductive coupling impedance. Therefore, a range of acceptable impedances is selected to determine upper and lower impedance thresholds. For exemplary table saw 700 this range of acceptable impedances was experimentally determined to be approximately 190 ohms to 384 ohms, corresponding to a maximum change in the phase difference of approximately 2 degrees. In other words, a conductive coupling impedance below 190 ohms will never cause a 2 degree Change in the phase difference, while a conductive coupling above 384 ohms will always cause a change of 2 degrees or more. Thus, an exemplary threshold of 2 degrees was selected for a maximum allowable change in the phase difference. In other words, a phase difference measurement that is more than 2 degrees higher or lower than the initial phase difference measurement is interpreted as indicating a degraded or failed conductive coupling, at which point an error is declared and the motor is stopped and disabled. Exemplary control circuit 728 is also configured to indicate the error via one or more indicator components on the user interface module.

As mentioned above, other factors can cause temporary changes to the phase difference. For example, when an operator is cutting certain materials such as wet wood, a change in the phase difference that exceeds the threshold may occur. However, as cutting operations are limited in time, the control circuit is configured so that an error is not declared unless the change in the phase difference persists longer than a threshold time period. One example is to allow a change in the measured phase difference up to three times the normal threshold for a period up to 10 seconds. If the change persists beyond the 10 second period, an error is declared. Conversely, if the change in the phase difference drops to a level below the threshold, the 10 second timer is reset.

Another factor that can cause a change in the phase difference is temperature. This may be especially evident when the control circuit is powered up while the ambient temperature, and thus the temperature of the control circuit components, is relatively low. As the control circuit and power tool generate operational heat, the phase difference can decrease. This change to the phase difference has been experimentally determined to be as high as approximately 1.2 degrees F. or exemplary table saw 700 for a starting temperature below freezing. The time period over which this thermal drift occurs will depend on the starting temperature and the final operating temperature, but can last for periods of 10-20 minutes in some circumstances. To reduce the uncertainty of this time period, the control circuit may include a temperature sensor to determine the starting temperature. Thus, an expected thermal drift period can be calculated. Furthermore, the rate at which the temperature is rising will also indicate the final operating temperature, thereby allowing the control circuit to calculate an expected end to the period of thermal drift. Once the period of expected thermal drift is determined, the control circuit may be configured to retake an initial phase difference measurement after the period of thermal drift to establish a new baseline. Alternatively, the baseline phase difference may be reset to the post-thermal drift value. In any event, after the thermal drift period has elapsed, no additional allowance for changes due to thermal drift are made.

It should be understood that the particular experimental values and selected thresholds described above are intended only to illustrate one exemplary embodiment. Different embodiments will likely produce different measurements and require correspondingly different ranges and thresholds. Nevertheless, the necessary modifications will be apparent to those of skill in the art. Therefore, all such alternatives and modifications are within the scope of this disclosure. In any event, the exemplary control circuit is configured to evaluate the impedance of the conductive coupling through multiple mechanisms, and to disable the exemplary power tool if the impedance of the conductive coupling is determined to exceed thresholds defined by one or more selected ranges of nominal impedances. The control circuit utilizes various components and circuitry, interconnected with one or more processors executing software instructions stored within the processor(s) and/or separate memory storage modules, to perform the evaluation of the conductive coupling impedance and to disable the saw if a degraded or failed conductive coupling is detected.

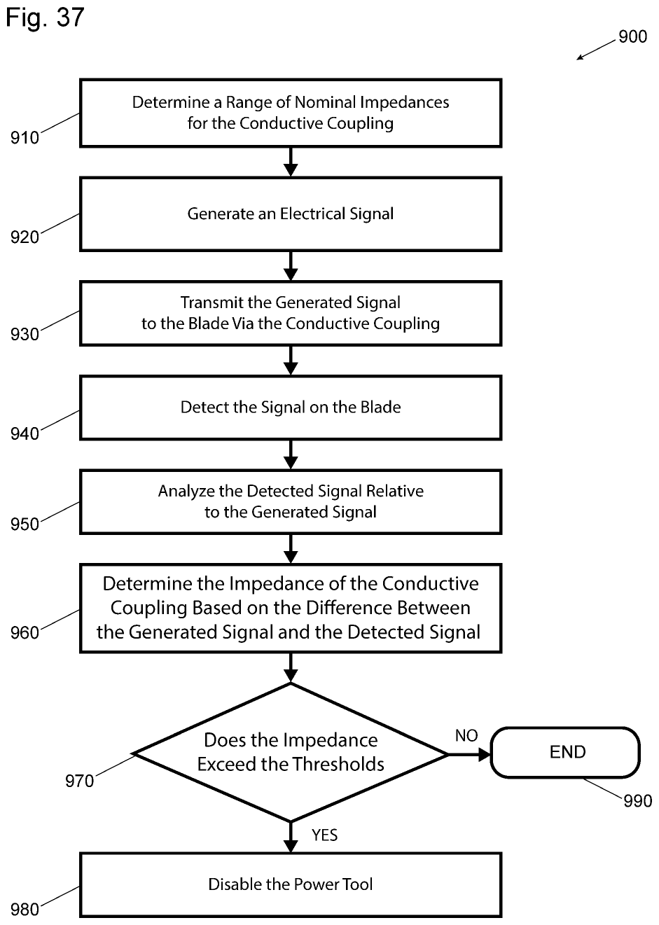

One exemplary method for evaluating the impedance of a conductive coupling is shown in FIG. 37 and indicated generally at 900. The method begins with the step of determining a range of nominal impedances for the conductive coupling, indicated at 910. This determination may be made empirically by experiment and measurement, or it may be made based on theory or other methods. Furthermore, the range may be bounded by minimum and maximum values, or may bounded by a single value such as “lower than X” or “higher than X.” Next, an electrical signal is generated, at 920, suitable for evaluating the impedance of the conductive coupling. The signal may be a step signal, an AC signal, or any other signal adapted to be affected by the impedance of the conductive coupling. The signal may be generated by one or more signal generator modules within the control circuit. Next, the generated signal is sent or transmitted to the blade via the conductive coupling. The conductive coupling may connect the signal generator to the blade directly, or to an arbor or some other component electrically coupled to the blade. Once the generated signal is transmitted to the blade, the signal on the blade is detected, as indicated at 940. The control circuit may have one or more sensors configured to detect the signal on the blade, such as an aluminum brake pawl capacitively coupled to the blade.

Next, the detected signal is analyzed relative to the generated signal, as indicated at 950. This analysis may be performed by a signal analyzer module within the control circuit, and the type of analysis may depend on the characteristics of the generated signal. In one exemplary embodiment, the detected analog signal is reconstructed from multiple samples into a digital representation of the detected signal. In some embodiments of method 900, the reconstructed signal is digitally filtered to reduce noise in the signal. Next, the impedance of the conductive coupling is determined based on the difference between the generated signal and the detected signal. In an embodiment where the generated signal is a step-test signal, the determination may be made based on the step response of the detected signal. Alternatively, in an embodiment where the generated signal is an AC signal, the determination may be made based on the phase change between the generated signal and the detected signal. Next, the impedance is evaluated, at 970, relative to the range of nominal impedances selected at 910. There may be multiple ranges based on different evaluation methods and/or signal types. Moreover, the ranges may depend on various other factors which may affect the signal. In any event, if the impedance is determined to be within the selected nominal range, then the method may end as indicated at 990. Alternatively, the method may return to a prior step, such as step 920, and repeat. Conversely, if the impedance is outside the selected range of nominal impedances, an error is declared and the power tool is disabled, indicated at 980. In the exemplary embodiment, the control circuit is configured to disconnect electrical power to the motor and to indicate an error to the operator via one or more indicator components within the user interface module.

While one exemplary method has been described, it should be understood that many modifications and alternatives are possible within the scope of this disclosure. For example, as has been described above, the control circuit may perform an initial evaluation of the impedance at startup, and then one or more subsequent evaluations either while the blade is moving or while it is stopped. Furthermore, the subsequent evaluations may be the same as, or different than, the initial evaluation. Additionally, the control circuit may include multiple conductive couplings and be configured to perform similar or different evaluations on all the conductive couplings to ensure reliable operation of the AIM functionality. Therefore, all such alternatives, modifications, and combinations are within the scope of this disclosure.

### INDUSTRIAL APPLICABILITY

The detection systems and methods disclosed herein are applicable to power tools equipped with active injury mitigation technology, and specifically to AIM-enabled power tools with conductive couplings. The disclosure herein is particularly applicable to systems and situations where it is beneficial or necessary to detect degradation or failure of a conductive coupling in an AIM-enabled power tool.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application.

Such amended or new claims, whether they are directed to a different invention or directed to the same invention, whether different, broader, narrower or equal in scope to the original claims, are also regarded as included within the subject matter of the inventions of the present disclosure.

1. An AIM-enabled power tool, comprising:
a support structure;
a cutting tool movably supported by the support structure and adapted to cut a workpiece when moving;
a motor supported by the support structure and coupled to the cutting tool to move the cutting tool relative to the support structure;
an electrical circuit supported by the support structure; and
a signal coupler connected between the electrical circuit and the cutting tool, where the signal coupler provides an electrically conductive connection between the electrical circuit and the cutting tool, and where the electrically conductive connection has an electrical impedance;
where the electrical circuit includes:
a signal generator configured to generate a signal and to transmit the signal to the cutting tool via the signal coupler, such signal being an output signal,
a signal sensor positioned to detect a signal on the cutting tool, such signal being a detected signal, and
a signal analyzer connected to receive the detected signal from the signal sensor and configured to evaluate the electrical impedance of the signal coupler by analyzing the detected signal relative to the output signal.

2. The AIM-enabled power tool of claim 1, where the cutting tool has an electrical capacitance such that the signal coupler and the cutting tool form an RC circuit connected to the electrical circuit, where the output signal is a voltage step signal, and where the signal analyzer is configured to analyze the detected signal by at least measuring a change in voltage of the detected signal over time.

3. The AIM-enabled power tool of claim 1, where the cutting tool has an electrical capacitance such that the signal coupler and the cutting tool form an RC circuit connected to the electrical circuit, where the output signal is an AC signal, and where the signal analyzer is configured to analyze the detected signal by at least measuring a phase difference in the detected signal relative to the output signal.

4. The AIM-enabled power tool of claim 1, where the signal analyzer is configured to evaluate the electrical impedance of the signal coupler when the cutting tool is moving relative to the support structure.

5. The AIM-enabled power tool of claim 1, where the signal analyzer is configured to evaluate the electrical impedance of the signal coupler when the cutting tool is not moving relative to the support structure.

6. The AIM-enabled power tool of claim 1, where the motor moves the cutting tool when the motor is connected to electrical power, where the electrical circuit is configured to control when the motor is connected to electrical power, and where the electrical circuit is configured to disconnect electrical power from the motor or prevent the motor from being connected to electrical power, if the electrical impedance of the signal coupler evaluated by the signal analyzer is outside a selected range of impedances.

7. The AIM-enabled power tool of claim 1, further comprising an arbor rotatably supported by the support structure, where the cutting tool is mounted on the arbor, and where at least a portion of the signal coupler contacts the arbor.

8. The AIM-enabled power tool of claim 1, further comprising means for detecting contact between a person and the cutting tool when the cutting tool is moving, and means for stopping the cutting tool from cutting within 10 msec after contact between a person and the cutting tool is detected.

9. A method of controlling an AIM-enabled power tool having a support structure, a cutting tool adapted to cut workpieces when the cutting tool is moving relative to the support structure, and a motor configured to move the cutting tool, comprising:
generating an electrical signal;
sending the generated electrical signal to the cutting tool via a conductive coupling, where the conductive coupling has an electrical impedance;
sensing an electrical signal on the cutting tool;
analyzing the sensed electrical signal on the cutting tool to determine if the impedance of the conductive coupling is within a selected range of impedances; and
preventing the motor from moving the cutting tool if the impedance of the conductive coupling is determined to be outside the selected range of impedances.

10. The method of claim 9, where the generated electrical signal is a voltage step signal, and where the step of analyzing includes measuring a change in the voltage of the sensed electrical signal over time.

11. The method of claim 9, where the generated electrical signal is an AC electrical signal, and where the step of analyzing includes measuring a phase difference between the sensed electrical signal and the generated electrical signal.

12. The method of claim 9, further comprising electrically grounding the cutting tool, and where the step of sensing is performed while the cutting tool is grounded.

13. The method of claim 9, where the step of sending is performed while the cutting tool is moving relative to the support structure.

14. The method of claim 9, where the step of analyzing is performed while the cutting tool is not moving relative to the support structure.

15. The method of claim 9, where the AIM-enabled power tool includes an electrical circuit having a signal generator portion, a signal analyzer portion, a signal sensor, and a motor control portion, and where
the step of generating is performed by the signal generator portion of the electrical circuit,
the step of sending includes sending the generated signal from the signal generator portion of the electrical circuit to the cutting tool, the step of sensing is performed by the signal sensor,
the step of analyzing is performed by the signal analyzer portion of the electrical circuit, and
the step of preventing is performed by the motor control portion of the electrical circuit.

16. A method of controlling an AIM-enabled power tool having a support structure, an electrical circuit supported by the support structure, and a cutting tool configured to move relative to the support structure when driven by a motor, comprising:
generating, by a signal generator portion of the electrical circuit, an electrical signal;
transmitting the generated electrical signal to the cutting tool via a conductive coupling between the electrical circuit and the cutting tool, where the conductive coupling has an electrical impedance;
detecting, by a sensing portion of the electrical circuit, an electrical signal on the cutting tool;
analyzing, by a signal analyzer portion of the electrical circuit, the sensed electrical signal to determine if the impedance of the conductive coupling is within a selected range of impedances; and
preventing, by a motor control portion of the electrical circuit, the motor from driving the cutting tool if the impedance of the conductive coupling is determined to be outside the selected range of impedances.

17. A power tool for processing workpieces, comprising:
a cutting tool configured to cut workpieces when moving;
a motor configured to move the cutting tool;
an electrical circuit including a signal generator;
a conductive coupling configured to transmit signals from the signal generator to the cutting tool; and
means for evaluating the electrical impedance of the conductive coupling.

18. The power tool of claim 17, further comprising means for detecting contact between a person and the cutting tool when the cutting tool is moving.

19. The power tool of claim 18, further comprising means for stopping the cutting tool from cutting within 10 milliseconds after contact is detected between a person and the cutting tool when the cutting tool is moving.

20. A power tool comprising:
a blade, where the blade moves to cut a workpiece;
a motor coupled to move the blade;
an electrical circuit; and
a conductive coupling electrically connecting the blade with the electrical circuit, where the conductive coupling has an electrical impedance;
where at least one portion of the electrical circuit is configured to evaluate the electrical impedance of the conductive coupling.

21. The power tool of claim 20, where the electrical circuit is connected to the motor to selectively enable and disable the motor, and where the electrical circuit is configured to disable the motor if the evaluated electrical impedance is outside a predetermined range of impedances.

22. The power tool of claim 20, further comprising a support structure, where the blade is supported by the support structure and moves relative to the support structure, and where the electrical circuit is supported by the support structure and does not move relative to the support structure.

23. The power tool of claim 22, where the at least one portion of the electrical circuit is configured to evaluate the electrical impedance of the conductive coupling while the blade is moving.

24. An AIM-enabled power tool, comprising:
a support structure;
an arbor rotatably supported by the support structure;
a cutting tool mounted on the arbor and adapted to cut a workpiece when rotating, where the cutting tool is electrically coupled to the arbor;
a motor supported by the support structure and coupled to rotate the arbor and the cutting tool relative to the support structure;
an electrical circuit supported by the support structure;
a conductive coupling connected to both the electrical circuit and the arbor, and configured to transmit electrical signals between the electrical circuit and the arbor when the arbor is rotating and when the arbor is not rotating; and
a sensor connected to the electrical circuit and configured to sense electrical signals on the cutting tool;
where the electrical circuit includes
a signal generator configured to generate an electrical signal for transmission to the arbor via the conductive coupling, and
a signal analyzer configured to receive sensed signals from the sensor, and to analyze the sensed signal to determine if the conductive coupling has an electrical impedance that is within a selected range of impedances.

25. The AIM-enabled power tool of claim 24, where the signal generator is configured to generate a voltage step signal.

26. The AIM-enabled power tool of claim 24, where the signal generator is configured to generate an AC signal.

27. An AIM-enabled power tool, comprising:
a support structure;
a cutting tool movably supported by the support structure and adapted to cut a workpiece when moving;
a motor supported by the support structure and coupled to the cutting tool to move the cutting tool relative to the support structure;
an electrical circuit supported by the support structure and including one or more electrical signal generators, one or more electrical signal analyzers, and at least one sensor configured to sense electrical signals on the cutting tool; and
a signal coupler connected between the electrical circuit and the cutting tool, where the signal coupler provides an electrically conductive connection between the electrical circuit and the cutting tool, and where the electrically conductive connection has an electrical impedance;
where the electrical circuit is configured to;
generate, with at least one of the one or more electrical signal generators, an electrical test signal suitable for evaluating the impedance of the signal coupler,
transmit the electrical test signal to the cutting tool via the signal coupler,
receive a sensed test signal on the cutting tool via the sensor and analyze, with at least one of the one or more signal analyzers, the sensed test signal to determine if the impedance of the signal coupler is within a selected range of impedances,
generate, with at least one of the one or more electrical signal generators, an electrical detection drive signal suitable for detecting contact between a person and the cutting tool,
transmit the electrical detection drive signal to the cutting tool via the signal coupler, and
receive an electrical detection sense signal from the cutting tool and analyze, with at least one of the one or more signal analyzers, the detection sense signal to determine if contact between a person and the cutting tool occurs.

28. The AIM-enabled power tool of claim 27, where the electrical test signal is different than the electrical drive signal.

29. The AIM-enabled power tool of claim 27, where the electrical test signal is the same as the electrical drive signal.
